(19) United States
(12) Patent Application Publication
(10) Pub. No.: US 2008/0136982 A1
(43) Pub. Date: Jun. 12, 2008

(54) Liquid crystal display device and electronic apparatus

(75) Inventors: Makoto Watanabe, Kanagawa (JP); Tomohiko Sato, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/984,260

(22) Filed: Nov. 15, 2007

(30) Foreign Application Priority Data
Nov. 20, 2006 (JP) P2006-313423

(51) Int. Cl. G02F 1/13; G09G 3/36

(52) U.S. Cl. 349/37; 349/38

(57) ABSTRACT

A semi-transmission liquid crystal display device of an in-plane switching mode includes M scanning signal lines, N video signal lines, switching elements, and a unit display area. The unit display area includes a first pixel electrode and a first counter electrode, a first storage capacitor, a second pixel electrode and a second counter electrode, and a second storage capacitor. A first voltage V1 is applied to the first counter electrode. A second voltage V2 is applied to the second counter electrode. When a higher one of the voltages V1 and V2 is represented as Hi (V1,V2) and a lower one of the voltages V1 and V2 is represented as Low (V1,V2), a third voltage equal to or lower than Hi (V1,V2) and equal to or higher than Low (V1,V2) is applied to the first pixel electrode and the second pixel electrode on the basis of an operation of the switching elements.

### CROSS REFERENCES TO RELATED APPLICATIONS

The present invention contains subject matter related to Japanese Patent Application JP 2006-313423 filed in the Japanese Patent Office on Nov. 20, 2006, the entire contents of which being incorporated herein by reference.

### BACKGROUND OF THE INVENTION

1. Field of the Invention

The invention relates to a liquid crystal display device, and, more particularly to a semi-transmission liquid crystal display device including a reflection display area that reflects external light to display an image and a transmission display area that transmits light from a rear surface thereof to display an image. The invention also relates to an electronic apparatus incorporating such a semi-transmission liquid crystal display device.

2. Description of the Related Art

There is known a reflection liquid crystal display device that reflects external light with reflectors provided in pixels and does not need to include a lighting device. There is also known a transmission liquid crystal display device that includes a backlight as a lighting device.

Since the reflection liquid crystal display device can display an image using external light, a reduction in power consumption, a reduction in thickness, and a reduction in weight can be attained. Therefore, the reflection liquid crystal display device is used as, for example, a liquid crystal display device for a cellular phone. On the other hand, since the transmission liquid crystal display device includes the backlight, the transmission liquid crystal display device has a characteristic that viewability is high even in a dark environment.

As a liquid crystal display device having advantages of both the reflection liquid crystal display device and the transmission liquid crystal display device, there is proposed a semi-transmission liquid crystal display device that has both a reflection display area (hereinafter simply referred to as reflection area) and a transmission display area (hereinafter simply referred to as transmission area) in one pixel (in a color display liquid crystal display device, one sub-pixel). In the semi-transmission liquid crystal display device, light travels back and forth in a liquid crystal layer in the reflection area and light from a lighting device passes trough the liquid crystal layer in the transmission area. Therefore, it is also proposed to eliminate a difference in retardation (phase difference) due to a difference in a path length of light in the liquid crystal layer by providing a difference in the thickness of the liquid crystal layer between the reflection area and the transmission area (see, for example, Japanese Patent No. 2955277 (Patent Document 1)).

As a liquid crystal display device, besides a liquid crystal display device of an up/down switching mode that rotates a direction of molecule axes of oriented liquid crystal molecules (also referred to as “director”) in a plane orthogonal to substrates to display an image, a liquid crystal display device of an in-plane switching mode that rotates the direction in a plane parallel to the substrates to display an image is well known. In the liquid crystal display device of the in-plane switching mode such as an in-plane switching (IPS) system, an electric field is applied to a liquid crystal layer held between opposed substrates and liquid crystal molecules are rotated in a plane parallel to the substrates to display an image.

In the liquid crystal display device of the in-plane switching mode, for example, a liquid crystal display device of a transmission IPS system, a liquid crystal layer is arranged between two sheet polarizers arranged in cross-nicol. In the case of so-called normally black, a direction of a polarization axis and a director of one sheet polarizer substantially coincide with each other in a state in which an electric field is not applied to the liquid crystal layer. The direction and the director form an angle of about 45 degrees in a state in which an electric field is applied to the liquid crystal layer. In the state in which an electric field is not applied to the liquid crystal layer, light made incident on the sheet polarizer on an incidence side reaches the sheet polarizer on an emission side with little retardation due to the liquid crystal layer and is absorbed in the sheet polarizer on the emission side (a black display state). Therefore, as the black display state, a state almost equivalent to an ideal cross-nicol state in which the liquid crystal layer is not held between the sheet polarizers can be obtained. On the other hand, in the state in which an electric field is applied to the liquid crystal layer, the director forms an angle of about 45 degrees with respect to a linear polarized light transmitted through the sheet polarizer on the incidence side. At this point, the liquid crystal layer acts as a half-wave plate and rotates an oscillation direction of the linear polarized light by 90 degrees. Consequently, the light that has passed through the liquid crystal layer is transmitted through the sheet polarizer on the emission side (a white display state).

It is known that the liquid crystal display device of the IPS system has a wide view angle characteristic. As described above, the black display state is almost equivalent to an ideal cross-nicol state in which the liquid crystal layer is not held between the sheet polarizers. Therefore, it is possible to perform image display with a high contrast.

However, when the semi-transmission liquid crystal display device is simply formed in the in-plane switching mode, the transmission area is in normally black and the reflection area is in normally white. Therefore, operation modes in both the areas do not coincide with each other. This problem is explained below with reference to the drawings.

FIGS. 29A to 29D are schematic diagrams for explaining the semi-transmission liquid crystal display device in which both the reflection area and the transmission area are formed in the in-plane switching mode. FIG. 29A shows an arrangement of respective members. FIG. 29B shows an arrangement of a polarization axis of an upper sheet polarizer 51, a molecule axis of a liquid crystal molecule 31 forming a liquid crystal layer 30, and a polarization axis of a lower sheet polarizer 50 viewed from an upper substrate 40 side. FIGS. 29C and 29D show operations of the semi-transmission liquid crystal display device, respectively.

As shown in FIG. 29A, the semi-transmission liquid crystal display device includes a lower substrate 10, an upper substrate 40, the liquid crystal layer 30 held between both the substrates, the lower sheet polarizer 50 arranged on an outer side (on a side of a backlight 60 described later) of a lower substrate 10, and the upper sheet polarizer 51 arranged on an outer side of the upper substrate 40. A lower orientation film 23 is formed on the lower substrate 10 and an upper orientation film 43 is formed on the upper substrate 40. The liquid crystal layer 30 is in contact with the lower orientation film 23 and the upper orientation film 43. A direction of the molecule axis of the liquid crystal molecule 31 in a state in which an electric field is not applied thereto (an initial orientation direction) is defined by these orientation films. Reference numeral 60 denotes a backlight that lights the semi-transmission liquid crystal display device from a rear surface thereof, reference numeral 41 denotes a so-called black matrix, and reference numeral 42 denotes a color filter. Depending on a form of the semi-transmission liquid crystal display device, the black matrix and the color filter are not provided.

A first insulating film 13A and a second insulating film 13B are stacked to be formed on the liquid crystal layer 30 side of the lower substrate 10. A not-shown transistor 14 is formed between the first insulating film 13A and the second insulating film 13B. A video signal line 15 is formed on the second insulating film 13B. Specifically, the video signal line 15 is connected to one source/drain electrode of the transistor 14. A first pixel electrode (a pixel electrode for the reflection area) 20A and a second pixel electrode (a pixel electrode for the transmission area) 20B described later are connected to the other source/drain electrode. The transistor 14 operates in accordance with a signal of a not-shown scanning signal line 11. When the transistor 14 is turned on, a predetermined voltage is applied to the first pixel electrode 20A and the second pixel electrode 20B from a not-shown video signal driving circuit via the video signal line 15.

First inter-layer insulating layers 16 (16A and 16B) are formed on the second insulating film 13B. Irregularities are formed on the surface of the first inter-layer insulating layer 16A in the reflection area. A reflector 17 is formed on the surface of the irregularities. A second inter-layer insulating layer 18 is formed on the reflector 17. The first pixel electrode 20A and a first counter electrode 21 that extend in a Y direction and are parallel to each other are formed on the second inter-layer insulating layer 18. The liquid crystal layer 30 in the reflection area is driven by an electric field in an X direction formed between the first pixel electrode 20A and the first counter electrode 21. On the other hand, the second pixel electrode 20B and a second counter electrode 22 that extend in the Y direction and are parallel to each other are formed on the first inter-layer insulating layer 16B in the transmission area. The liquid crystal layer 30 in the transmission area is driven by an electric field in the X direction formed between the second pixel electrode 20B and the second counter electrode 22.

The first pixel electrode 20A and the second pixel electrode 20B are electrically connected to each other and the same voltage is applied thereto. The first counter electrode 21 and the second counter electrode 22 are electrically connected to each other and the same voltage is applied thereto. The second inter-layer insulating layer 18 is set to thickness such that thickness DB of the liquid crystal layer 30 in the transmission area is about twice as large as thickness DA of the liquid crystal layer 30 in the reflection area. The liquid crystal layer 30 functions as a half-wave plate in the transmission area and functions as a quarter-wave plate in the reflection area.

As shown in FIG. 29B, it is assumed that the polarization axis of the lower sheet polarizer 50 is set at an angle of 45 degrees with respect to the X axis, the polarization axis of the upper sheet polarizer 51 is set at an angle of 135 degrees with respect to the X axis, and the molecule axis of the liquid crystal molecule 31 forming the liquid crystal layer 30 is set at an angle of 45 degrees with respect to the X axis in a state in which an electric field is not formed between the first counter electrode 21 and the first pixel electrode 20A and between the second counter electrode 22 and the second pixel electrode 20B. The liquid crystal molecule 31 is rotated along the X direction by an electric field in the X direction formed between the pixel electrode 20A and the counter electrode 21 and an electric field in the X direction formed between the pixel electrode 20B and the counter electrode 22. A degree of the rotation of the liquid crystal molecule 31 changes according to the intensity of the electric fields (i.e., absolute values of potential differences between the pixel electrodes and the counter electrodes).

Operations in a state in which there is no potential difference between the first pixel electrode 20A and the first counter electrode 21 and between the second pixel electrode 20B and the second counter electrode 22 (in other words, a state in which an electric field is not applied to the liquid crystal layer) are explained with reference to FIG. 29C. In the reflection area, external light passes through the upper sheet polarizer 51 and changes to linear polarized light that forms an angle of 135 degrees with respect to the X axis (1→2→3). The light passes through the liquid crystal layer 30 and, then, reflects on the reflector 17 (4→5→6→7). The light passes through the liquid crystal layer 30 and is made incident on the upper sheet polarizer 51 while keeping a state of the linear polarized light, which forms an angle of 135 degrees with respect to the X axis, and comes into a state of white display (8→9→10→11). Therefore, the reflection area is in so-called normally white. On the other hand, in the transmission area, light irradiated from the rear surface is transmitted through the lower sheet polarizer 50 and changes to linear polarized light that forms an angle of 45 degrees (1→2→3). The light passes through the liquid crystal layer 30, is made incident on the upper sheet polarizer 51 while keeping a state of the linear polarized light, which forms an angle of 45 degrees, and comes into a state of black display (4→5→6→7). Therefore, the transmission area is in so-called normally black.

Operations in a state in which there are potential differences between the first pixel electrode 20A and the first counter electrode 21 and between the second pixel electrode 20B and the second counter electrode 22 (in other words, an electric field is applied to the liquid crystal layer) are explained with reference to FIG. 29D. In the reflection area, external light passes through the upper sheet polarizer 51 and changes to linear polarized light that forms an angle of 135 degrees with respect to the X axis (1→2→3). The light passes through the liquid crystal layer 30 and changes to a right-handed circularly polarized light (4→5). The light reflects on the reflector 17 and changes to a left-handed circularly polarized light (6→7). The light passes through the liquid crystal layer 30 and changes to linear polarized light that forms an angle of 45 degrees (8→9). The light is made incident on the upper sheet polarizer 51 and comes into a state of black display (10→11). On the other hand, in the transmission area, light irradiated from the rear surface is transmitted through the lower sheet polarizer 50 and changes to linear polarized light that forms an angle of 45 degrees (1→2→3). The light passes through the liquid crystal layer 30 and changes to linear polarized light that forms an angle of 135 degrees (4→5). The light is made incident on the upper sheet polarizer 51 and comes into a state of white display (6→7).

In order to solve the problem, it is proposed to provide a half-wave plate between the lower sheet polarizer and the liquid crystal layer, cause the liquid crystal layer in the transmission area to function as the half-wave in a state in which a voltage is not applied thereto, and set both the transmission area and the reflection area in normally black (see JP-A-2003-344837 (Patent Document 2)). It is also proposed to give different initial orientation directions to liquid crystal molecules in the reflection area and the transmission area (JP-A-2005-338264 (Patent Document 3)). It is also proposed to set a phase difference plate only in the reflection area (JP-A-2006-171376 (Patent Document 4)). It is also proposed to provide two transistors in one pixel and give different voltages to the liquid crystal layer in the transmission area and the reflection area (JP-A-2003-295159 (Patent Document 5)). Patent Document 5 does not refer to the problem.

### SUMMARY OF THE INVENTION

In the liquid crystal display device disclosed in Patent Document 1, a state of black display in the transmission area is obtained using a phase difference of the liquid crystal layer. Therefore, the state of black display is not close to the ideal cross-nicol state in which the liquid crystal layer is not held between the sheet polarizers. Contrast performance falls. According to the disclosure in Patent Document 2 and Patent Document 4, the state of black display in the transmission area can be set closer to the ideal cross-nicol state. However, in both the patent documents, the structure and a manufacturing process of the liquid crystal display devices are complicated and problems still remain in mass productivity and reliability. In the discloser of Patent Document 5, an aperture ratio inevitably falls because of the expansion of a transistor area in the liquid crystal display device and an increase in video signal lines and scanning signal lines and problems still remain in mass productivity and reliability.

Therefore, it is desirable to provide a semi-transmission liquid crystal display device that can electrically compensate for a difference in operation modes in a transmission area and a reflection area with a simple structure. It is also desirable to provide a semi-transmission liquid crystal display device that can obtain a satisfactory state of black display in a transmission area and display an image with a high contrast and is excellent in a display quality.

According to an embodiment of the invention, there is provided a semi-transmission liquid crystal display device of an in-plane switching mode including:

(a) M scanning signal lines that extend in a first direction and one ends of which are connected to a scanning signal driving circuit;

(b) N video signal lines that extend in a second direction and one ends of which are connected to a video signal driving circuit;

(c) switching elements that are arranged in crossing portions of the scanning signal lines and the video signal lines and operate according to scanning signals of the scanning signal lines; and

(d) a unit display area that is provided in association with each of the switching elements and has a reflection display area and a transmission display area.

The unit display area includes:

(A) a first pixel electrode and a first counter electrode that form the reflection display area;

(B) a first storage capacitor for storing a potential difference between the first pixel electrode and the first counter electrode;

(C) a second pixel electrode and a second counter electrode that form the transmission display area; and

(D) a second storage capacitor for storing a potential difference between the second pixel electrode and the second counter electrode.

A first voltage is applied to the first counter electrode. A second voltage different from the first voltage is applied to the second counter electrode. The first voltage is represented as V1, the second voltage is represented as V2, a higher one of the voltages V1 and V2 is represented as Hi(V1,V2), and a lower one of the voltages V1 and V2 is represented as Low(V1,V2). A third voltage equal to or lower than Hi(V1,V2) and equal to or higher than Low(V1,V2) is applied to the first pixel electrode and the second pixel electrode from the video signal driving circuit via the video signal lines on the basis of an operation of the switching elements corresponding to a scanning signal of the scanning signal lines.

In the semi-transmission liquid crystal display device of the in-plane switching mode (which may be hereinafter simply referred to as liquid crystal display device according to the embodiment of the invention), the first voltage is applied to the first counter electrode and the second voltage different from the first voltage is applied to the second counter electrode. The first voltage is represented as V1, the second voltage is represented as V2, a higher one of the voltages V1 and V2 is represented as Hi(V1,V2), and a lower one of the voltages V1 and V2 is represented as Low(V1,V2). The third voltage equal to or lower than Hi (V1,V2) and equal to or higher than Low(V1,V2) is applied to the first pixel electrode and the second pixel electrode from the video signal driving circuit via the video signal lines on the basis of an operation of the switching elements corresponding to a scanning signal of the scanning signal lines. In the semi-transmission liquid crystal display device, an absolute value of the potential difference between the first counter electrode and the first pixel electrode and an absolute value of the potential difference between the second counter electrode and the second pixel electrode are in a relation in which, when one of the absolute values increases, the other decreases. Consequently, even if the reflection display area (which may be hereinafter simply referred to as reflection area) is in normally white and the transmission display area (which may be hereinafter simply referred to as transmission area) is in normally black, a difference in the operation modes in the transmission area and the reflection area is electrically compensated and an image can be displayed without any trouble.

In the liquid crystal display device according to the embodiment of the invention, when scanning by first to Mth scanning signal lines for forming even number frames is completed, in a certain unit display area, the first voltage applied to the first counter electrode is represented as V1_evenF and the second voltage applied to the second counter electrode is represented as V2_evenF. When scanning by first to Mth scanning signal lines for forming odd number frames is completed, in the unit display area, the first voltage applied to the first counter electrode is represented as V1_oddF and the second voltage applied to the second counter electrode is represented as V2_oddF. In this case, preferably, a relation represented by the following equation is satisfied:

V1_evenF−V2_evenF=−(V1_oddF−V2_oddF)

Consequently, an electric field applied to the liquid crystal layer changes for each of the frames. It is possible to prevent liquid crystals from being deteriorated when an electric field is applied in one direction for a long time.

In this case, preferably, any one of the following conditions (1) to (3) is satisfied.

V1_evenF=V1_oddF (1)

V2_evenF=V2_oddF (2)

V1_evenF=V2_oddF and V1_oddF=V2_evenF (3)

When (1) or (2) above is satisfied, a voltage at the first counter electrode or a voltage at the second counter electrode can be set to a fixed value regardless of a frame and the structure of a circuit that applies voltages to the counter electrodes can be simplified. When (3) is satisfied, since fluctuation in the first voltage, the second voltage, and the third voltage can be reduced, it is possible to realize a reduction in power consumption of the liquid crystal display device.

In the liquid crystal display device according to the embodiment of the invention including the preferred structures described above, when scanning by first to Mth scanning signal lines for forming certain one frame is completed, in each of the unit display areas corresponding to an mth (m=1, 2, . . . , M) scanning signal line, a first voltage V1_m is applied to the first counter electrode and a second voltage V2_m is applied to the second counter electrode.

Preferably, the liquid crystal display includes P (P=2M) common electrode lines, any one of the first counter electrode and the second counter electrode in each of the unit display areas corresponding to the mth scanning signal line and a pth (p=2m−1) common electrode line are connected, the other counter electrode and a (p+1)th common electrode line are connected, the first voltage is applied to the first counter electrode via the common electrode line connected to the first counter electrode, and the second voltage is applied to the second counter electrode via the common electrode line connected to the second counter electrode. In unit display areas forming adjacent rows, the reflection area and the transmission area can be arranged to be opposed to each other or same kinds of areas can be arranged to be opposed to each other. Alternatively, these arrangements can be combined.

In this case, preferably, the voltage V2_m is a fixed value V2_const. The voltage V1_m is a fixed value V1_odd when a value of m is an odd number and is a fixed value V1_even different from V1_odd when a value of m is an even number. Preferably, V1_odd−V2_const=−(V1_even−V2_const). In the liquid crystal display device described above, a polarity of an applied voltage is inverted in each of the unit display areas corresponding to an odd number scanning signal line and each of the unit display areas corresponding to an even number scanning signal line and flicker is reduced. For example, when V2_const is 0 volt, V1_odd is 10 volts, and V1_even if −10 volts, an absolute value of the third voltage applied to the respective pixel electrodes according to an image that should be displayed takes a value in a range of 0 volt to 10 volts. In the example described above, a range of values that the absolute value of the potential difference between the first counter electrode and the first pixel electrode and the absolute value of the potential difference between the second counter electrode and the second pixel electrode can take is 0 volt to 10 volts.

Preferably, the voltage V1_m is a fixed value V1_const. The voltage V2_m is a fixed value V2_odd when a value of m is an odd number and is a fixed value V2_even different from V2_odd when a value of m is an even number. In addition, preferably, V1_const−V2_odd=−(V1_const−V2_even). For example, when V1_const is 0 volt, V2_odd is +10 volts, and V2_even is −10 volts, the absolute value of the third voltage applied to the respective pixel electrodes according to an image that should be displayed takes a value in a range of 0 volt to 10 volts. In the example described above, a range of values that the absolute value of the potential difference between the first counter electrode and the first pixel electrode and the absolute value of the potential difference between the second counter electrode and the second pixel electrode can take is 0 volt to 10 volts. In the liquid crystal display device described above, since a voltage of the first counter electrode or a voltage of the second counter electrode can be set to a fixed value, the structure of the circuit that applies voltages to the counter electrodes can be simplified.

Preferably, the voltage V1_m is a fixed value V1_odd when a value of m is an odd number and is a fixed value V1_even different from V1_odd when a value of m is an even number. The voltage V2_m is a fixed value V2_odd when a value of m is an odd number and is V2_even different from V2_odd when a value of m is an even number. In addition, preferably, V1_odd=V2_even and V1_even=V2_odd. For example, when V1_odd=V2_even=−5 volts and V1_even=V2_odd=5 volts, the absolute value of the third voltage applied to the respective pixel electrodes according to an image that should be displayed takes a value in a range of 0 volt to 5 volts. In the example described above, a range of values that the absolute value of the potential difference between the first counter electrode and the first pixel electrode and the absolute value of the potential difference between the second counter electrode and the second pixel electrode can take is 0 volt to 10 volts. In the liquid crystal display device described above, since fluctuation in the first voltage, the second voltage, and the third voltage can be reduced, it is possible to realize a reduction in power consumption of the liquid crystal display device.

Preferably, the liquid crystal display device includes P (P=M+1) common electrode lines. Any one of the first counter electrode and the second counter electrode in each of the unit display areas corresponding to an m'th (m′=p−1) scanning signal line and the other of the first counter electrode and the second counter electrode in each of the unit display areas corresponding to an (m′+1)th scanning signal line are connected to a pth (p is a natural number equal to or larger than 2 and equal to or smaller than M−1). The electrode not connected to a second common electrode line of the first counter electrode and the second counter electrode in each of the unit display areas corresponding to a first scanning signal line and a first common electrode line are connected. The electrode not connected to a (P−1)th common electrode line of the first counter electrode and the second counter electrode in each of the unit display areas corresponding to an Mth scanning signal line and a Pth common electrode line are connected. The first voltage is applied to the first counter electrode via the common electrode line connected to the first counter electrode. The second voltage is applied to the second counter electrode via the common electrode line connected to the second counter electrode. In the liquid crystal display device described above, since the number of common electrode lines is reduced, a margin of a layout space or the like of the respective components constituting the liquid crystal display device is increased. In other words, a margin in the structure of the liquid crystal display device is improved. Consequently, it is possible to realize improvement of yield and improvement of reliability of the liquid crystal display device.

In this case, preferably, the voltage V1_m is a fixed value V1_odd when a value of m is an odd number and is a fixed value V1_even different from V1_odd when a value of m is an even number. The voltage V2_m is a fixed value V2_odd when a value of m is an odd number and is a fixed value V2_even different from V2_odd when a value of m is an even number. In addition, preferably, V1_odd=V2_even and V1_even=V2_odd. For example, when V1_odd=V2_even=−5 volts and V1_even=V2_odd=5 volts, the absolute value of the third voltage applied to the respective pixel electrodes according to an image that should be displayed takes a value in a range of 0 volt to 5 volts. In the example described above, a range of values that the absolute value of the potential difference between the first counter electrode and the first pixel electrode and the absolute value of the potential difference between the second counter electrode and the second pixel electrode can take is 0 volt to 10 volt.

Preferably, the liquid crystal display device includes P (P=M+1) common electrode lines. Any one of the first counter electrode and the second counter electrode in each of the unit display areas corresponding to an m′th (m′=p−1) and an (m′+1)th scanning signal lines is connected to a pth (p is a natural number equal to or larger than 2 and equal to or smaller than M). The electrode not connected to a second common electrode line of the first counter electrode and the second counter electrode in each of the unit display areas corresponding to a first scanning signal line and a first common electrode line are connected. The electrode not connected to a (P−1)th common electrode line of the first counter electrode and the second counter electrode in each of the unit display areas corresponding to an Mth scanning signal line and a Pth common electrode line are connected. The first voltage is applied to the first counter electrode via the common electrode line connected to the first counter electrode. The second voltage is applied to the second counter electrode via the common electrode line connected to the second counter electrode.

In the liquid crystal display device described above, the number of common electrode lines is reduced. Only the first counter electrode or the second counter electrode is connected to a common electrode line. Consequently, it is possible to arrange unit display areas opposed to each other across the common electrode line such that reflection areas are opposed to each other (reflexively, transmission areas are also opposed to each other). For example, when the reflection areas are opposed to each other, reflectors and the like provided in the reflection areas can be continuously formed over plural unit display areas. The same holds true for various components provided in the transmission areas. In the liquid crystal display device described above, since it is possible to simplify a process for dividing the reflectors and the like, it is possible to further increase the margin in the structure of the liquid crystal display device. A video signal inverted for each of frames is applied to the video signal lines.

In this case, preferably, the voltage V2_m is a fixed value V2_const and the voltage V1_m is a fixed value V1_const different from V2_const.

Preferably, the liquid crystal display device includes P (P=M+2) common electrode lines. In each of the unit display areas corresponding to an m′th (m′ is a natural number equal to or smaller than M) scanning signal line, one of the first counter electrode and the second counter electrode in a unit display area corresponding to an odd number video signal line and the other of the first counter electrode and the second counter electrode in a unit display area corresponding to an even number video signal line are connected to a pth (p=m′+1) common electrode line. One of a (p−1)th common electrode line and a (p+1)th common electrode line and the electrode not connected to the pth common electrode line of the first counter electrode and the second counter electrode in the unit display area corresponding to the odd number video signal line are connected. The other of the (p−1)th common electrode line and the (p+1)th common electrode line and the electrode not connected to the pth common electrode line of the first counter electrode and the second counter electrode in the unit display area corresponding to the even number video signal line are connected. The first voltage is applied to the first counter electrode via the common electrode line connected to the first counterelectrode. The second voltage is applied to the second counter electrode via the common electrode line connected to the second counter electrode. In the liquid crystal display device, the video signal applied to the odd number video signal line and the video signal applied to the even number video signal line are inverted from each other.

In the liquid crystal display device described above, a polarity of an applied voltage changes for each of the unit display areas. More specifically, since the polarity is inverted in a checkered pattern, flicker is reduced and a suitable display image can be formed.

The conditions indicated by the various equations in this specification are satisfied not only when the equations strictly hold mathematically but also when the equations substantially hold. In other words, various kinds of fluctuation in design or manufacturing of the liquid crystal display device are allowed concerning whether the equation hold.

In the liquid crystal display device according to the embodiment of the invention including the preferred structures described above, the liquid crystal display device includes a front panel, a rear panel, and a liquid crystal layer arranged between the front panel and the rear panel. The liquid crystal display device may be a monochrome liquid crystal display device or may be a color liquid crystal display device. The liquid crystal display device includes:

(a) M scanning signal lines that extend in a first direction (e.g., X direction) and one ends of which are connected to a scanning signal driving circuit;

(b) N video signal lines that extend in a second direction (e.g., Y direction) and one ends of which are connected to a video signal driving circuit;

(c) switching elements that are arranged in crossing portions of the scanning signal lines and the video signal lines and operate according to scanning signals of the scanning signal lines; and

(d) a unit display area that is provided in association with each of the switching elements and has a reflection display area and a transmission display area.

The front panel includes an upper substrate made of, for example, a glass substrate or a plastic substrate and an upper sheet polarizer provided on an outer surface of the upper substrate. In the case of the color liquid crystal display device, color filters are provided on an inner surface of the upper substrate. Examples of an arrangement pattern of the unit display areas or the color filters include a delta array, a stripe array, a diagonal array, and a rectangle array.

On the other hand, the rear panel includes a lower substrate made of, for example, a glass substrate or a plastic substrate, a switching element formed on an inner surface of the lower substrate, a first pixel electrode and a second pixel electrode, conduction and non-conduction to the video signal lines are controlled by the switching element, a first counter electrode and a second counter electrode, and a lower sheet polarizer provided on, for example, an outer surface of the lower substrate. In the unit display area, the first counter electrode and the second counter electrode are divided to be formed. A first voltage is applied to the first counter electrode and a second voltage different from the first voltage is applied to the second counter electrode. A reflector made of, for example, aluminum is formed in a portion corresponding to the reflection area on the lower substrate.

A direction of molecule axes of liquid crystal molecules when an electric field is not applied thereto (an initial orientation direction) can be set by, for example, forming an upper orientation film on a surface on which the upper substrate and the liquid crystal layer are in contact with each other, forming a lower orientation film on a surface on which the lower substrate and the liquid crystal layer are in contact with each other, and applying rubbing treatment to the upper orientation film and the lower orientation film.

The thickness of the liquid crystal layer is set such that the liquid crystal layer functions as a half-wave plate in the transmission area and functions as a quarter-wave plate in the reflection area. For example, the liquid crystal layer can be set to a suitable thickness by forming an inter-layer insulating layer formed on the lower substrate with different thicknesses in the reflection area and the transmission area. However, a method of setting the thickness of the liquid crystal layer is not limited to this.

Various members and liquid crystal materials forming the liquid crystal display device can be formed of well-known members and materials. Examples of the switching element include a three-terminal element such as a transistor element like a MOSFET and a thin film transistor (TFT), an MIM element, a varistor element, and a two-terminal element such as a diode.

An area including a liquid crystal cell in which the first pixel electrode/the second pixel electrode and the first counter electrode/the second counter electrode are formed corresponds to one pixel or one sub-pixel. In the color liquid crystal display device, in each pixel, a red-light-emitting sub-pixel (which may be referred to as sub-pixel [R]) is formed by a combination of such an area and a color filter that transmits red, a green-light-emitting sub-pixel (which may be referred to as sub-pixel [G]) is formed by a combination of such an area and a color filter that transmits green, and a blue-light-emitting sub-pixel (which may be referred to as sub-pixel [B]) is formed by a combination of such an area and a color filter that transmits blue. An arrangement pattern of the sub-pixel [R], the sub-pixel [G], and the sub-pixel [B] coincides with an arrangement pattern of color filters. The pixel is not limited to the structure including the three kinds of sub-pixels [R, G, B], i.e., the sub-pixel [R], the sub-pixel [G], and the sub-pixel [B] as a set. For example, the arrangement pattern may be a set further including one or plural kinds of sub-pixels in addition to the three kinds of sub-pixels [R, G, B] (e.g., a set further including a sub-pixel that emits white light for improvement of luminance, a set further including a sub-pixel that emits complementary color light in order to expand a color reproduction range, a set further including a sub-pixel that emits yellow light in order to expand a color reproduction range, and a set further including a sub-pixel that emits yellow and cyan light in order to expand a color reproduction range).

Examples of values of pixels arrayed in a two-dimensional matrix shape include, besides VGA (640, 480), S-VGA (800, 600), XGA (1024, 768), APRC (1152, 900), S-XGA (1280, 1024), U-XGA (1600, 1200), HD-TV (1920, 1080), and Q-XGA (2048, 1536), several resolutions for image display such as (1920, 1035), (720, 480), and (1280, 960). However, the values of pixels are not limited to these values.

In the explanation of the example described above, the first pixel electrode/the second pixel electrode and the first counter electrode/the second counter electrode are provided in the lower substrate. However, the arrangement of the electrodes is not limited to this. The arrangement of the electrodes can be arbitrarily set as long as it is possible to apply an electric field to the liquid crystal layer in a lateral direction (a direction along an imaginary surface orthogonal to a thickness direction of the liquid crystal layer and a direction substantially along the upper substrate surface and the lower substrate surface). For example, it is also possible to form the first pixel electrode/the second pixel electrode on the lower substrate side and form the first counter electrode/the second counter electrode on the upper substrate side such that spaces are formed between a projected image of the first counter electrode and a projected image of the first pixel electrode and between a projected image of the second counter electrode and a projected image of the second pixel electrode.

A shape of the first counter electrode and the second counter electrode only has to be appropriately set according to the specification and the design of the liquid crystal display device. For example, these electrodes may be formed in a substantially linear shape or may be a comb-tooth shape in which branch electrode portions extend from a trunk electrode portion. For example, it is possible that the first counter electrode and the second counter electrode extend substantially linearly in the X direction and an electric field in the Y direction is formed between the first counter electrode/the second counter electrode and the pixel electrodes opposed thereto.

Alternatively, it is also possible that trunk electrode portions of the first counter electrode and the second counter electrode extend in the X direction, branch electrode portions extend in the Y direction from the trunk electrode portions, and an electric field in the X direction is formed between the branch electrode portions and the pixel electrodes opposed thereto. The number of branch electrode portions formed in the unit display areas only has to be appropriately set according to the specification and the like of the liquid crystal display device.

The first pixel electrode and the second pixel electrode are formed as electrodes of an island shape for each of the unit display areas. Basically, this needs to be a shape in which spaces are formed between a projected image of a first counter electrode and a projected image of the first pixel electrode and between a projected image of the second counter electrode and a projected image of the second pixel electrode. In general, it is convenient to form edges of the first pixel electrode/the second pixel electrode in a shape along edges of the first counter electrode/the second counter electrode. For example, when the first counter electrode/the second counter electrode extend linearly, the first pixel electrode/the second pixel electrode only have to be formed in a simple rectangle. When the first counter electrode/the second counter electrode is the comb-tooth shape in which branch electrode portions extend from a trunk electrode portion, the first pixel electrode/the second pixel electrode only have to be formed in a rectangle having projected portions between the adjacent branch electrode portions. The first pixel electrode and the second pixel electrode may be provided as island-shaped electrodes independent from each other. It is also possible that one island-shaped electrode extending over the reflection area and the transmission area is provided and a portion corresponding to the reflection area forms the first pixel electrode and a portion corresponding to the transmission area forms the second pixel electrode.

In the liquid crystal display device of the in-plane switching mode, it is known that chromaticity of an image changes when the liquid crystal molecules are viewed from a major axis direction and when the liquid crystal molecules are viewed from a minor axis direction (color shift). As measures against the color shift, it has been proposed to form the pixel electrodes and the counter electrodes in a “V” shape and rotate the liquid crystal molecules in two directions in the unit display areas. In the invention, the pixel electrodes and the counter electrodes may be formed in a “V” shape. For example, it is also possible that the counter electrodes include trunk electrode portions and branch electrode portions extending from the trunk electrode portions and the branch electrode portions are formed in a “V” shape. The same holds true for the pixel electrodes.

The first storage capacitor for storing a potential difference between the first pixel electrode and the first counter electrode can be constituted by forming an auxiliary electrode conductive to the first pixel electrode and an auxiliary electrode conductive to the first counter electrode to be opposed to each other (more specifically, an electrostatic capacitor formed by these auxiliary electrodes and an electrostatic capacitor between the first pixel electrode and the first counter electrode are connected in parallel and a potential difference is stored by these electrostatic capacitors). The auxiliary electrodes only have to be appropriately provided according to a well-known method. For example, the auxiliary electrodes are formed between stacked inter-layer insulating layers in the lower substrate. The same holds true for the second storage capacitors for storing a potential difference between the second pixel electrode and the second counter electrode.

In the invention, the polarization axis of the lower sheet polarizer can be substantially parallel or substantially perpendicular to a direction of the molecule axes of the liquid crystal molecules at the time when a voltage is not applied thereto. The polarization axis of the upper sheet polarizer can be substantially perpendicular to the polarization axis of the lower sheet polarizer. Consequently, it is possible to obtain a satisfactory state of black display in the transmission area. When the polarization axis of the lower sheet polarizer forms an angle of about 45 degrees with the molecule axes of the liquid crystal molecules at the time when a voltage is not applied thereto and the polarization axis of the upper sheet polarizer is substantially perpendicular to the polarization axis of the lower sheet polarizer, the transmission area is in normally white and the reflection area is in normally black. However, even in this case, a difference in operation modes in the transmission area and the reflection area is electrically compensated by applying the invention and an image can be displayed without any trouble (However, when the transmission area is in normally black, since black display in the transmission area is performed using a phase difference in the liquid crystal layer, contrast performance falls). An initial orientation direction of the liquid crystal molecules forming the liquid crystal layer can be appropriately set according to the design of the liquid crystal display device. For example, the initial orientation direction can be set to form a predetermined angle in a range of 0 degree to 45 degrees with respect to the direction in which the pixel electrodes extend.

As the backlight that lights the transmission area from the rear surface, a well-known backlight can be used. As an example of a light source for the backlight, there is a light emitting diode (LED). Other examples of the light source for the backlight include a cold-cathode fluorescent lamp, an electroluminescent (EL) device, a cold-cathode field electron emission device (FED), a plasma display device, and a normal lamp. A well-known optical sheet such as a light diffuser may be arranged between the backlight and the liquid crystal display device.

Various circuits for driving the liquid crystal display device may include well-known circuit such as a driving circuit, an arithmetic circuit, and a storage device (a memory). The number of images transmitted to the driving circuit as an electric signal in one second is a frame frequency (a frame rate). An inverse number of the frame frequency is a frame time (unit: second). A method of driving the liquid crystal display device may be a line-sequential driving system or may be a dot-sequential driving system.

According to the embodiments of the invention, a difference in operation modes in the transmission area and the reflection area is electrically compensated with a simple structure. It is possible to obtain the semi-transmission liquid crystal display device that can obtain a satisfactory state of black display in the transmission area, has a high contrast, and is excellent in a display quality.

### BRIEF DESCRIPTION OF THE DRAWINGS

FIG. 1 is a schematic plan view for explaining an arrangement of various components near a certain unit display area in a liquid crystal display device according to an embodiment of the invention;

FIG. 2A is a schematic end view of the liquid crystal display device taken along line A-A in FIG. 1;

FIG. 2B is a schematic end view of the liquid crystal display device taken along line B-B in FIG. 1;

FIG. 2C is a schematic end view of the liquid crystal display device taken along line C-C in FIG. 1;

FIG. 3A is a diagram schematically showing the structure of a unit display area in the liquid crystal display device;

FIG. 3B is a simplified diagram showing the structure in FIG. 3A;

FIGS. 4A and 4B are diagrams schematically showing a potential relation of respective electrodes at the time when a first voltage V1 is larger than a second voltage V2 in a certain unit display area;

FIG. 5A is a diagram schematically showing a relation between transmittances of light in a reflection area and a transmission area and an absolute value of a potential difference between a pixel electrode and a counter electrode;

FIG. 5B is a schematic diagram representing the relation shown in FIG. 5A from a viewpoint of display gradation in a unit display area;

FIG. 6 is a diagram of an example of operations at the time when V2_evenF=V2_oddF;

FIG. 7 is a diagram of an example of operations at the time when V1_evenF=V2_oddF and V1_oddF=V2_evenF;

FIG. 8 is a schematic diagram of a liquid crystal display device according to the first embodiment of the invention;

FIG. 9 is a schematic timing chart of operation in a white display state of the liquid crystal display device according to the first embodiment;

FIG. 10 is a schematic timing chart of operations in a black display state of the liquid crystal display device according to the first embodiment;

FIG. 11A is a diagram showing polarities of voltages at pixel electrodes with respect to counter electrodes in respective unit display areas in an even number frame;

FIG. 11B is a diagram showing polarities of voltages at pixel electrodes with respect to counter electrodes in respective unit display areas in an odd number frame;

FIG. 12 is a diagram schematically showing a relation among a first voltage V1, a second voltage V2, and a third voltage V3 in respective unit display areas in an odd number row and an even number row;

FIG. 13 is a schematic diagram showing a modification of the liquid crystal display device according to the first embodiment;

FIG. 14 is a schematic timing chart of operations in the modification corresponding to the operations shown in FIG. 9;

FIG. 15 is a schematic timing chart of operations in the modification corresponding to the operations shown in FIG. 10;

FIG. 16A is a diagram showing polarities of voltages at pixel electrodes with respect to counter electrodes in respective unit display areas in an even number frame in the modification;

FIG. 16B is a diagram showing polarities of voltages at pixel electrodes with respect to counter electrodes in respective unit display areas in an odd number frame in the modification;

FIG. 17 is a schematic timing chart of operations in a white display state of a liquid crystal display device according to a second embodiment of the invention;

FIG. 18 is a diagram schematically showing a relation among a first voltage V1, a second voltage V2, and a third voltage V3 in respective unit display areas UA in an odd number row and an even number of row;

FIG. 19 is a schematic timing chart of operations in a modification of the second embodiment corresponding to the operations shown in FIG. 17;

FIG. 20 is a schematic diagram of a liquid crystal display device according to a third embodiment of the invention;

FIG. 21 is a schematic timing chart of operations in a white display state of the liquid crystal display device according to the third embodiment;

FIG. 22 is a schematic diagram of a liquid crystal display device according to a fourth embodiment of the invention;

FIG. 23 is a schematic timing chart of operations in a white display state of the liquid crystal display device according to the fourth embodiment;

FIG. 24A is a diagram showing polarities of voltages at pixel electrodes with respect to counter electrodes in respective unit display areas in an even number of frame;

FIG. 24B is a diagram showing polarities of voltages at pixel electrodes with respect to counter electrodes in respective unit display areas in an odd number frame;

FIG. 25 is a schematic diagram of a liquid crystal display device according to a fifth embodiment of the invention;

FIG. 26 is a schematic timing chart of operations in a white display state of the liquid crystal display device according to the fifth embodiment;

FIG. 27 is a schematic timing chart of operations in the white display state of the liquid crystal display device according to the fifth embodiment;

FIG. 28A is a diagram showing polarities of voltages at pixel electrodes with respect to counter electrodes in respective unit display areas in an even number frame;

FIG. 28B is a diagram showing polarities of voltages at pixel electrodes with respect to counter electrodes in respective unit display areas UA in an odd number frame;

FIG. 29A is a schematic diagram showing an arrangement of respective components in a reflection area and a transmission area of an in-plane switching mode in a semi-transmission liquid crystal display device;

FIG. 29B is a schematic diagram showing an arrangement of a polarization axis of an upper sheet polarizer, a molecule axis of a liquid crystal molecule forming a liquid crystal layer, and a polarization axis of a lower sheet polarizer viewed from an upper substrate side;

FIGS. 29C and 29D are schematic diagrams showing operations of the semi-transparent liquid crystal display device;

FIG. 30 is a perspective view showing a television set including a liquid crystal display device according to an embodiment of the invention;

FIG. 31 is a perspective view showing a digital still camera including the liquid crystal display device according to the embodiment;

FIG. 32 is a perspective view showing a notebook personal computer including the liquid crystal display device according to the embodiment;

FIG. 33 is a schematic diagram showing a portable terminal apparatus including the liquid crystal display device according to the embodiment; and

FIG. 34 is a perspective view showing a video camera including the liquid crystal display device according to the embodiment.

### DESCRIPTION OF THE PREFERRED EMBODIMENTS

First, an overview of a liquid crystal display device according to an embodiment of the invention is explained to facilitate understanding of the invention.

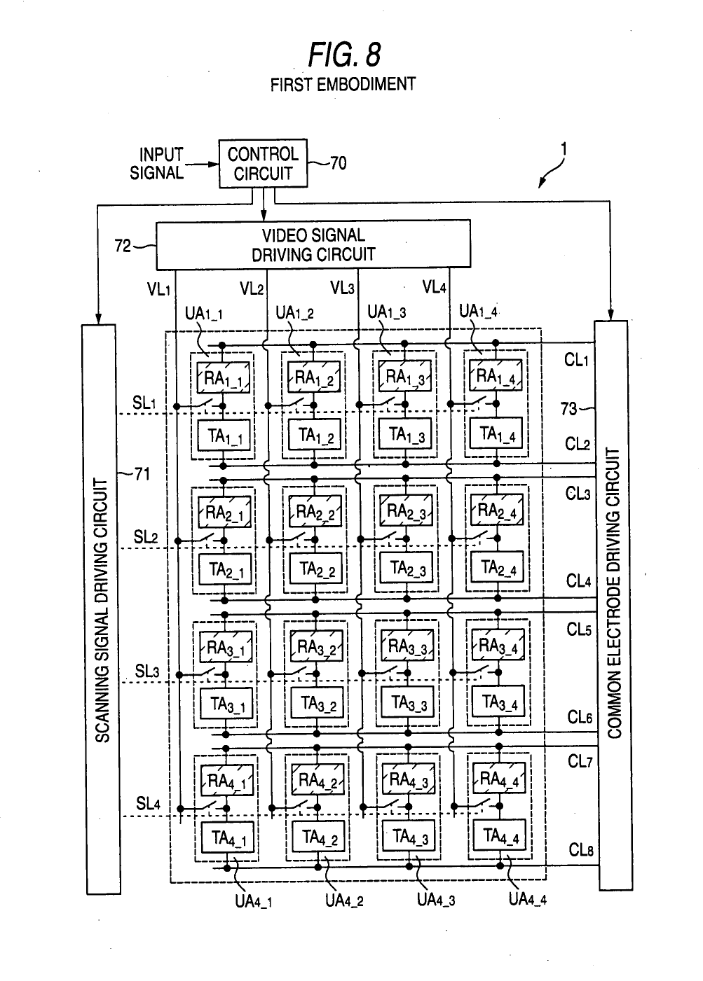

As shown in FIG. 8, a liquid crystal display device 1 according to a first embodiment of the invention is a semi-transmission liquid crystal display device of an in-plane switching mode including (a) M scanning signal lines SL that extend in a first direction and one ends of which are connected to a scanning signal driving circuit 71, (b) N video signal lines VL that extend in a second direction and one ends of which are connected to a video signal driving circuit 72, (c) transistors 14 that are arranged at crossing portions of the scanning signal lines SL and the video signal lines VL and operate according to scanning signals of the scanning signal lines SL (the transistors 14 are described later), and (d) unit display areas UA that are provided in association with the respective transistors 14 and have reflection areas RA and transmission areas TA. This structure is the same in liquid crystal display devices according to other embodiments described later.

Each of the unit display areas UA includes (A) a first pixel electrode 20A and a first counter electrode 21 that form the reflection area RA, (B) a first storage capacitor 24 for storing a potential difference between the first pixel electrode 20A and the first counter electrode 21, (C) a second pixel electrode 20B and a second counter electrode 22 that form the transmission area TA, and (D) a second storage capacitor 25 for storing a potential difference between the second pixel electrode 20B and the second counter electrode 22. This structure is the same in the liquid crystal display devices according to the other embodiments described later. The first storage capacitor 24, the second storage capacitor 25, the first pixel electrode 20A, the second pixel electrode 20B, the first counter electrode 21, and the second counter electrode 22 are described later. The liquid crystal display device 1 is explained in detail in explanation of the first embodiment.

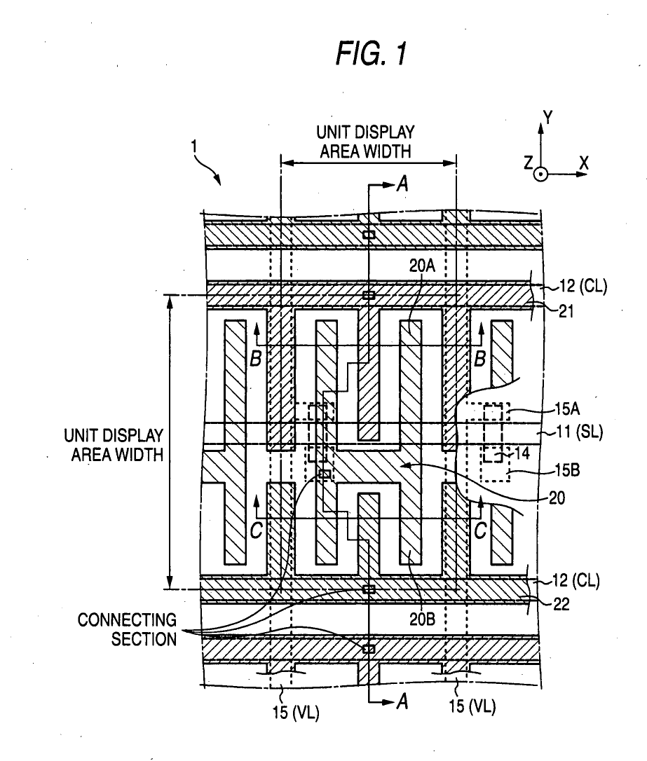

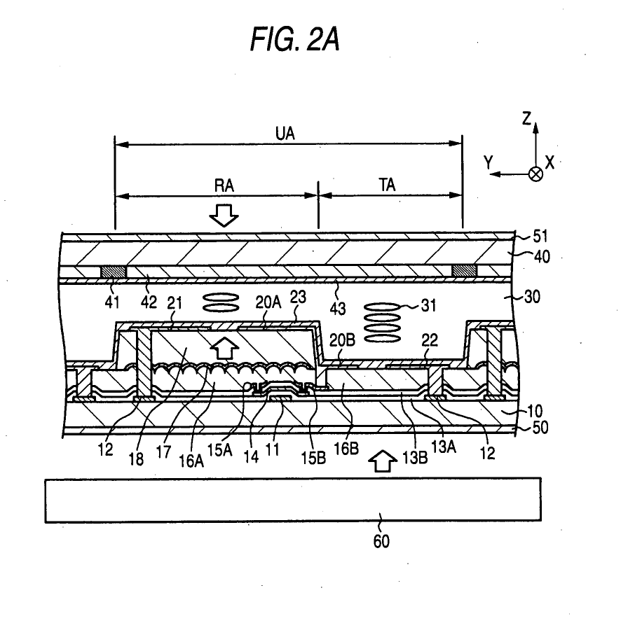

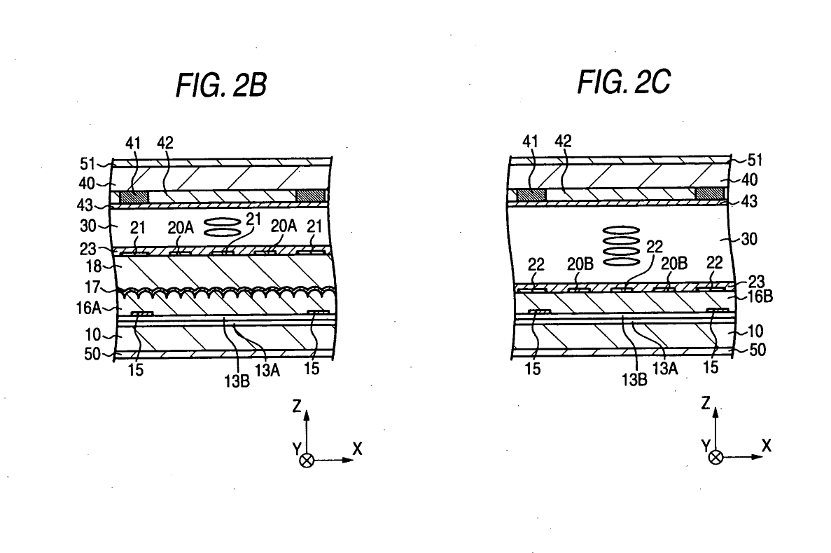

FIG. 1 is a schematic plan view for explaining an arrangement of various components near a certain unit display area UA in the liquid crystal display device 1 according to the first embodiment. FIG. 2A is a schematic end view of the liquid crystal display device 1 taken along line A-A in FIG. 1. FIG. 2B is a schematic end view of the liquid crystal display device 1 taken along line B-B in FIG. 1. FIG. 2C is a schematic end view of the liquid crystal display device 1 taken along line C-C in FIG. 1. These figures apply in the liquid crystal display devices according to the other embodiments described later.

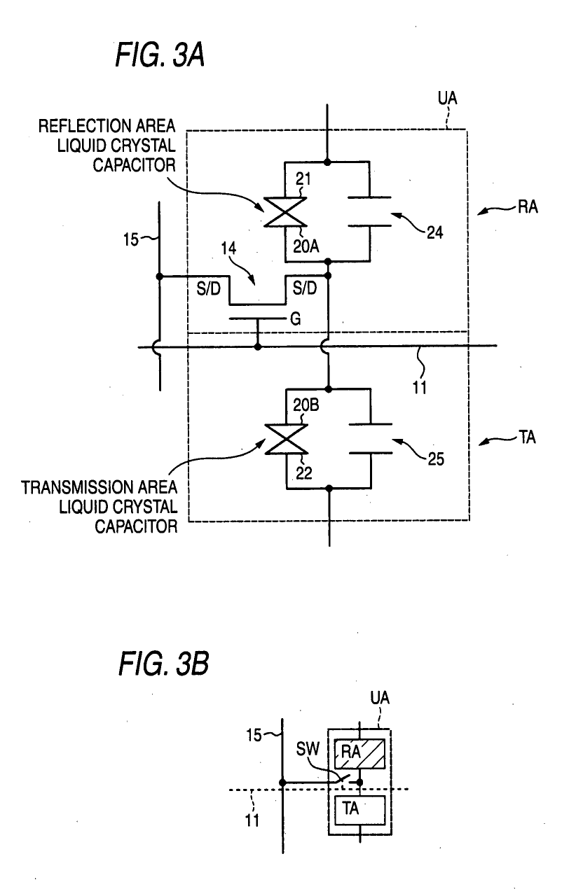

The first storage capacitor 24 and the second storage capacitor 25 shown in FIG. 3A described later are formed by auxiliary electrodes conductive to the first pixel electrode 20A, the first counter electrode 21, the second pixel electrode 20B, and the second counter electrode 22. In FIGS. 1 and 2, for convenience of illustration, the auxiliary electrodes forming the first storage capacitor 24 and the second storage capacitor 25 are not shown.

In FIGS. 1 to 3 and the following explanation to be made with reference to these figures, for convenience of illustration and explanation, the scanning signal line SL is represented as a scanning signal line 11, the video signal line VL is represented as a video signal line 15, and a common electrode line CL, one end of which is connected to a common electrode driving circuit 73 shown in FIG. 8, is represented as a common electrode line 12.

AS shown in FIG. 1 and FIGS. 2A to 2C, the liquid crystal display device 1 includes a lower substrate 10 and an upper substrate 40, a liquid crystal layer 30 held between both the substrates, a lower sheet polarizer 50 arranged on an outer side (a side of a backlight 60 described later) of the lower substrate 10, and an upper sheet polarizer 51 arranged on an outer side of the upper substrate 40. A lower orientation film 23 is formed on the lower substrate 10 and an upper orientation film 43 is formed on the upper substrate 40. The liquid crystal layer 30 is in contact with the lower orientation film 23 and the upper orientation film 43. A direction of molecule axes of liquid crystal molecules 31 forming the liquid crystal layer 30 in a state in which an electric field is not applied thereto is defined by these orientation films 23 and 43. Reference numeral 60 denotes a backlight that lights the liquid crystal display device 1 from a rear surface thereof, reference numeral 41 denotes a so-called black matrix, and reference numeral 42 denotes a color filter.

A first insulating film 13A and a second insulating film 13B are stacked to be formed on the liquid crystal layer 30 side of the lower substrate 10. The transistor 14 is formed between the first insulating film 13A and the second insulating film 13B. The video signal line 15 is formed on the second insulating film 13B. A tongue portion 15A of the video signal line 15 is connected to one source/drain electrode of the transistor 14. The first pixel electrode 20A and the second pixel electrode 20B described later are connected to the other source/drain electrode via a conductive portion 15B. For example, the conductive portion 15B is formed simultaneously with the formation of the video signal line 15 by patterning.

The transistor 14 functions as a switching element that operates in accordance with a scanning signal of the scanning signal line 11. A predetermined voltage (a third voltage described later) is applied to the first pixel electrode 20A and the second pixel electrode 20B from the video signal driving circuit 72 via the video signal line 15 on the basis of the operation of the transistor 14 corresponding to the scanning signal of the scanning signal line 11. First inter-layer insulating layers 16 (16A and 16B) are formed on the second insulating film 13B.

Irregularities are formed on the surface of the first inter-layer insulating layer 16A in the reflection area RA. A reflector 17 formed by vapor-depositing, for example, aluminum is formed on the surface of the irregularities. A second inter-layer insulating layer 18 is formed on the reflector 17. The first pixel electrode 20A and the first counter electrode 21 are formed on the second inter-layer insulating layer 18. On the other hand, the second pixel electrode 20B and the second counter electrode 22 that extend in a Y direction and are parallel to each other are formed on the first inter-layer insulating layer 16B in the transmission area TA.

As shown in FIG. 1, the first counter electrode 21 and the second counter electrode 22 are formed in a comb-tooth shape. Specifically, the first counter electrode 21 includes a trunk electrode portion extending in an X direction in the figure and branch electrode portions extending in a −Y direction in the figure from the trunk electrode portion. Similarly, the second counter electrode 22 includes a trunk electrode portion extending in the X direction in the figure and branch electrode portions extending in a +Y direction in the figure from the trunk electrode portion.

As shown in FIGS. 1 and 2A, the first pixel electrode 20A is a portion corresponding to the reflection area RA of one island-shaped electrode 20 extending over the reflection area RA and the transmission area TA. The second pixel electrode 20B is a portion corresponding to the transmission area TA of the island-shaped electrode 20. The first pixel electrode 20A is located between adjacent branch electrode portions of the first counter electrode 21. The second pixel electrode 20B is located between adjacent branch electrode portions of the second counter electrode 22. In this way, the first pixel electrode 20A and the second pixel electrode 20B are formed along the Y direction.

The liquid crystal layer 30 in the reflection area RA is driven by an electric field formed between the first pixel electrode 20A and the first counter electrode 21 (more specifically, an electric field in the X direction formed between the branch electrode portions of the first pixel electrode 20A ad the first counter electrode 21). Similarly, the liquid crystal layer 30 in the transmission area TA is driven by an electric field formed between the second pixel electrode 20B and the second counter electrode 22 (more specifically, an electric field in the X direction formed between the branch electrode portions of the second pixel electrode 20B and the second counter electrode 22).

The first pixel electrode 20A and the second pixel electrode 20B are conductive to each other. The third voltage described later is applied to both the first pixel electrode 20A and the second pixel electrode 20B. More specifically, the third voltage is applied to the first pixel electrode 20A and the second pixel electrode 20B from the video signal driving circuit 72 via the video signal line 15 on the basis of an operation of the transistor 14 corresponding to a scanning signal of the scanning signal line 11.

On the other hand, the first counter electrode 21 and the second counter electrode 22 are separately formed. The first counter electrode 21 is connected to the common electrode line 12. The first voltage is applied to the first counter electrode 21 from the common electrode driving circuit 73 via the common electrode line 12. Similarly, the second counter electrode 22 is connected to another common electrode line 12. The second voltage different from the first voltage is applied to the second counter electrode 22 from the common electrode driving circuit 73 via the another common electrode line 12.

The second inter-layer insulating layer 18 is set to thickness such that the thickness of the liquid crystal layer 30 in the transmission area TA is about twice as large as the thickness of the liquid crystal layer 30 in the reflection area RA. The liquid crystal layer 30 functions as a half-wave plate in the transmission area TA and functions as a quarter-wave plate in the reflection area RA.

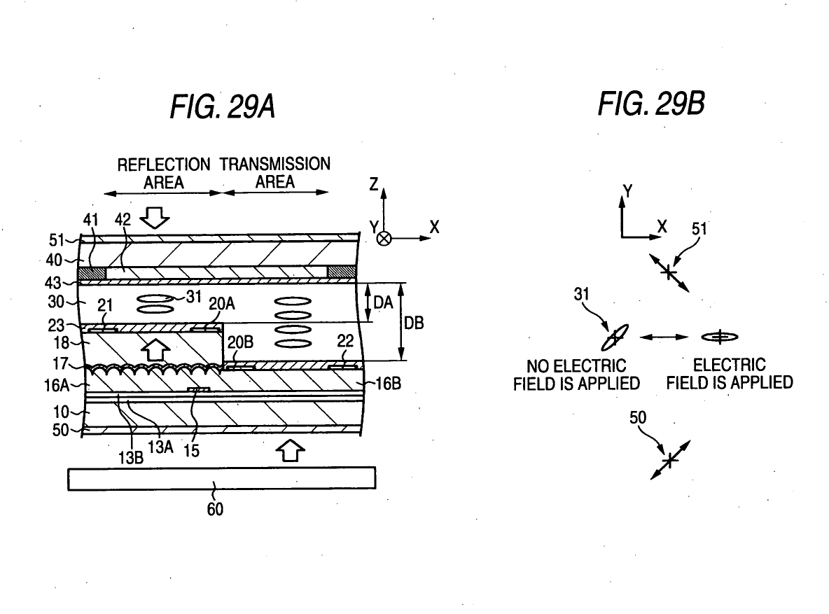

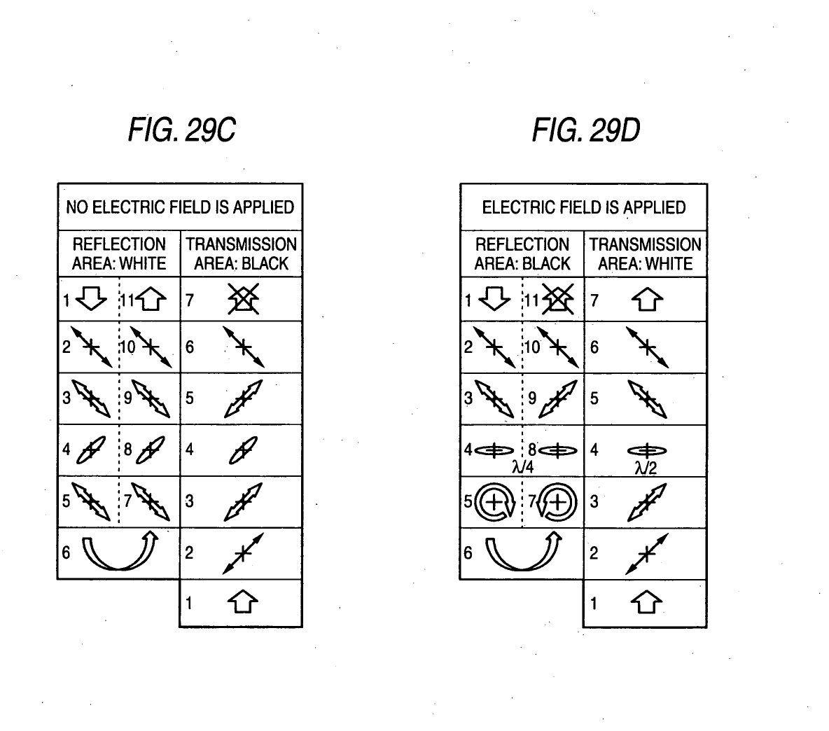

In a state in which electric fields are formed between the first counter electrode 21 and the first pixel electrode 20A and between the second counter electrode 22 and the second pixel electrode 20B, the molecule axes of the liquid crystal molecules 31 forming the liquid crystal layer 30 form an angle of about 45 degrees with respect to the X axis. The molecule axes of the liquid crystal molecules 31 forming the liquid crystal layer 30 of the reflection region RA are changed along the X axis by the electric field between the first counter electrode 21 and the first pixel electrode 20A. Similarly, the molecule axes of the liquid crystal molecules 31 forming the liquid crystal layer 30 in the transmission area TA are changed along the X axis by the electric field between the second counter electrode 22 and the second pixel electrode 20B. The polarization axis of the lower sheet polarizer 50 is set in a direction that forms an angle of about 45 degrees with respect to the X axis. The polarization axis of the upper sheet polarizer 51 is set in a direction substantially orthogonal to the polarization axis of the lower sheet polarizer 50 (specifically, the polarization axis is set in a direction that forms an angle of about 135 degrees with respect to the X axis). The structure is the same as the structure explained with reference to FIGS. 29B to 29D in the background art. The transmission area TA is in normally black and the reflection area RA is in normally white.

The structure of the unit display area UA in the liquid crystal display device 1 explained above is schematically shown in FIG. 3A. As described above, the third voltage is applied to the first pixel electrode 20A and the second pixel electrode 20B from the video signal driving circuit 72 via the video signal line 15 on the basis of an operation of the transistor 14 corresponding to a scanning signal of the scanning signal line 11. In a connection diagram concerning the embodiment described later, for convenience of illustration, the structure shown in FIG. 3A is simplified as shown in FIG. 3B.

A method of manufacturing the liquid crystal display device is briefly explained. First, the scanning signal line 11 and the common electrode line 12 are formed in the same layer on the lower substrate 10. Subsequently, the first insulating film 13A is formed over the entire surface of the lower substrate 10. Thereafter, the transistor 14 formed by a semiconductor layer is formed in a predetermined place. Thereafter, the second insulating film 13B is formed over the entire surface of the lower substrate 10.

Subsequently, an opening is formed in the second insulating film 13B such that both the source/drain electrode portions of the transistor 14 are exposed. Thereafter, the video signal line 15 (including the tongue portion 15A) connected to one source/drain electrode via the opening is formed on the insulating film 13B to cover the opening. Simultaneously with the formation of the video signal line 15, the conductive portion 15B connected to the other source/drain electrode is formed.

Subsequently, the first inter-layer insulating layers 16 (16A and 16B) formed of polyimide or the like are formed over the entire surface. Thereafter, irregularities are formed on the surface of the first inter-layer insulating layer 16A corresponding to the reflection area RA. Specifically, a step shape is formed by applying halftone exposure or the like to the irregularities and, then, irregularities obtained by rounding the step shape are formed by applying reflow treatment to the irregularities. However, a method of forming irregularities is not limited to this method.

Thereafter, the reflector 17 is formed by vapor-depositing, for example, aluminum on the surface of the irregularities of the first inter-layer insulating layer 16A. Subsequently, after forming the second inter-layer insulating layer 18 over the entire surface, the second inter-layer insulating layer 18 in the portion of the transmission area TA is selectively removed.

Thereafter, an opening is formed in the first inter-layer insulating layer 16 and the like such that the conductive portion 15B connected to the source/drain electrode of the transistor 14 is exposed. Subsequently, the island-shaped electrode 20 is formed over the first inter-layer insulating layer 16B and the second inter-layer insulating layer 18 to cover the opening. Similarly, an opening is formed in the first inter-layer insulating layer 16 and the like such that a predetermined portion of the common electrode line 12 is exposed. Subsequently, the first counter electrode 21 connected to a predetermined common electrode line 12 via the opening is formed on the second inter-layer insulating layer 18. The second counter electrode 22 connected to another predetermined common electrode line 12 via the opening is formed on the first inter-layer insulating layer 16B. For convenience of explanation, processes for forming the respective electrodes are separately explained. However, actually, the formation of the respective openings and the formation of the respective electrode can be performed by common processes, respectively.

Thereafter, after forming the lower orientation film 23 over the entire surface, rubbing treatment is applied to the surface of the lower orientation film 23. Then, a series of processes concerning the lower substrate 10 is completed.

Subsequently, the upper substrate 40 on which the black matrix 41, the color filter 42, the upper orientation film 43, and the like are formed is prepared. The upper substrate 40 and the lower substrate 10 subjected to the above-mentioned process are opposed to each other. A liquid crystal material is filled in between the upper substrate 40 and the lower substrate 10 and, then, the upper substrate 40 and the lower substrate 10 are sealed. Thereafter, the lower sheet polarizer 50 is attached to the surface of the lower substrate 10 and the upper sheet polarizer 51 is attached to the surface of the upper substrate 40. Subsequently, connection with external circuits, attachment of a backlight, and the like are performed to complete the liquid crystal display device.

The overview including the manufacturing method of the liquid crystal display device has been explained. Next, a basic operation principle of the liquid crystal display device according to the embodiment is explained. The explanation applies in liquid crystal display devices according to embodiments of the invention described later.

In the liquid crystal display device according to the embodiment, the first voltage is applied to the first counter electrode 21 and the second voltage different from the first voltage is applied to the second counter electrode 22. The first voltage is represented as V1, the second voltage is represented as V2, higher one of V1 and V2 is represented as Hi(V1,V2), and lower one of V1 and V2 is represented as Low (V1,V2). The third voltage equal to or lower than Hi (V1,V2) and equal to or higher than Low(V1,V2) is applied to the first pixel electrode 20A and the second pixel electrode 20B from the video signal driving circuit 72 via the video signal line 15 on the basis of an operation of the transistor 14 corresponding to a scanning signal of the scanning signal line 11.

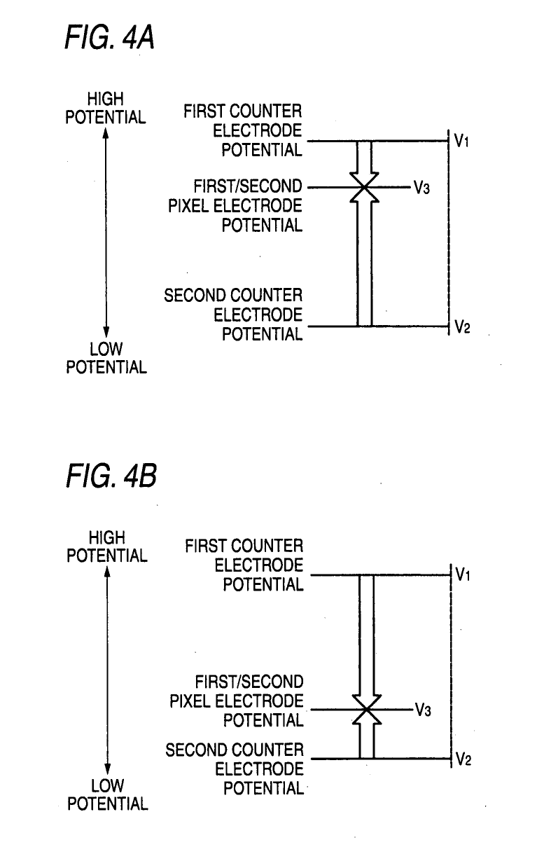

FIGS. 4A and 4B are diagrams schematically showing a potential relation of the respective electrodes at the time when the first voltage V1 is larger than the second voltage V2 in a certain unit display area UA. In this case, Low(V1,V2)=V2 and Hi(V1,V2)=V1. Therefore, when a value of the third voltage applied to the first pixel electrode 20A and the second pixel electrode 20B is represented as V3, the third voltage is applied in a range of V2≦V3≦V1.

FIG. 4A schematically shows a state in which V3 is relatively closer to V1 (e.g., a state in which V2 is 0 volt, V1 is 10 volts, and V3 is 8 volts). FIG. 4B schematically shows a state in which V3 is relatively closer to V2 (e.g., a state in which V2 is 0 volt, V1 is 10 volts, and V3 is 2 volts).

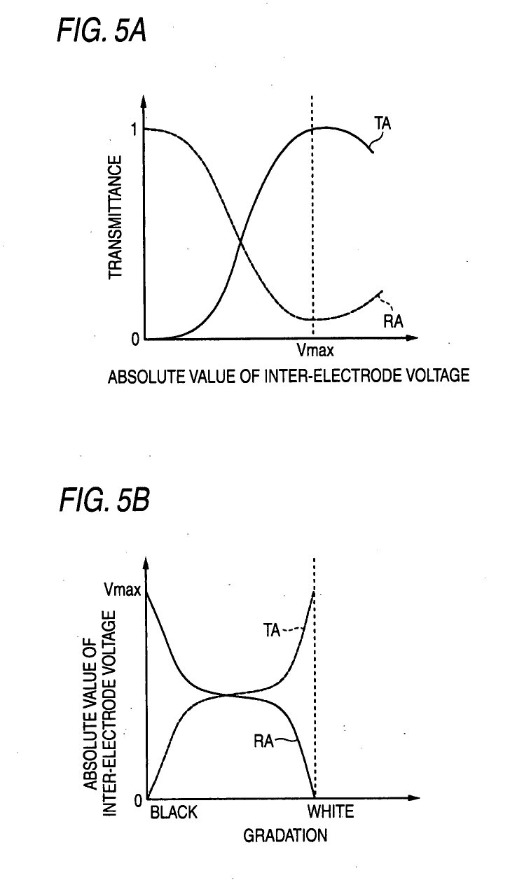

As it is evident from FIGS. 4A and 4B, it is seen that when |V3−V1| increases, |V3−V2| decreases and, when |V3−V1| decreases, |V3−V2| increases. In other words, when an electric field applied to the liquid crystal layer 30 in the reflection area RA increases, an electric field applied to the liquid crystal layer 30 in the transmission area TA decreases and, when the electric field applied to the liquid crystal layer 30 in the reflection area RA decreases, the electric field applied to the liquid crystal layer 30 in the transmission area TA increases. Therefore, a difference in operation modes of the transmission area TA and the reflection area RA is electrically compensated and an image can be displayed without any trouble. This is explained below with reference to FIGS. 5A and 5B.

FIG. 5A is a diagram schematically showing a relation between transmittances of light in the reflection area RA and the transmission area TA and an absolute value of a potential difference between a pixel electrode and a counter electrode. The transmittance on the ordinate is normalized. As described above, the transmission area TA of the liquid crystal display device is in normally black and the reflection area RA is in normally white. Therefore, as an absolute value of a potential difference between the second pixel electrode 20B and the second counter electrode 22 increases, the transmittance of light in the transmission area TA increases. On the other hand, when an absolute value of a potential difference between the first pixel electrode 20A and the first counter electrode 21 increases, the transmittance of light in the reflection area RA decreases. In FIG. 5A, in order to sufficiently invert the transmittances of light in the transmission area TA and the reflection area RA, an absolute value of a maximum potential difference applied between the pixel electrode and the counter electrode in design is represented as Vmax.

FIG. 5B is a schematic diagram showing the relation in FIG. 5A from a viewpoint of display gradation in the unit display area UA. It is seen that, to set the unit display area UA in a maximum black display state in design, an absolute value of a potential difference between the first pixel electrode 20A and the first counter electrode 21 provided in the reflection area RA only has to be set to Vmax and a potential difference between the second pixel electrode 20B and the second counter electrode 22 provided in the transmission area TA only has to be set to 0 volt. It is also seen that, to set the unit display area UA in a maximum white display state in design, a potential difference between the first pixel electrode 20A and the first counter electrode 21 provided in the reflection area RA only has to be set to 0 volt and an absolute value of a potential difference between the second pixel electrode 20B and the second counter electrode 22 provided in the transmission area TA only has to be set to Vmax. In other words, in this case as well as a case in which a halftone is displayed, an absolute value of a voltage that should be applied between the first pixel electrode 20A and the first counter electrode 21 and an absolute value of a voltage that should be applied between the second pixel electrode 20B and the second counter electrode 22 are in a tradeoff relation.

In the liquid crystal display device according to the embodiment, as described above, when |V3−V1| increases, |V3−V2| decreases and, when |V3−V1| decreases, |V3−V2| increases. Therefore, since |V3−V1| and |V3−V2| are in a tradeoff relation, an image can be displayed without any trouble. Values of Vmax shown in FIGS. 5A and 5B substantially correspond to a value of |V1−V2|. Therefore, values of V1 and V2 only have to be set in association with a maximum potential difference applied between the pixel electrode and the counter electrode in design.

The basic operation principle of the liquid crystal display device according to the embodiment has been explained. As described above, according to the embodiment, a difference in operation modes of the transmission area TA and the reflection area RA can be electrically compensated with a simple structure. When an electric field is applied to the liquid crystal layer 30 in one direction for a long time, the liquid crystal layer 30 is deteriorated. Therefore, it is desirable to apply an electric field to the liquid crystal layer 30 while appropriately inverted a direction. A structure for applying an electric field to the liquid crystal layer 30 while inverting a direction is explained below.

Basically, in a certain unit display area UA, a state of V1>V2 and a state of V2>V1 only have to be appropriately switched. Consequently, an electric field can be applied to the liquid crystal layer 30 while inverting a direction.

For example, when first to Mth scanning signal lines for forming even number frames is completed, in a certain unit display area UA, the first voltage applied to the first counter electrode 21 is represented as V1_evenF and the second voltage applied to the second counter electrode 22 is represented as V2_evenF. When scanning by first to Mth scanning signal lines for forming odd number frames is completed, in the unit display area UA, the first voltage applied to the first counter electrode 21 is represented as V1_oddF and the second voltage applied to the second counter electrode 22 is represented as V2_oddF. For example, by satisfying a relation V1_evenF−V2_evenF=−(V1_oddF−V2_oddF), an electric field can be applied to the liquid crystal layer 30 while inverting a direction for each of frames.

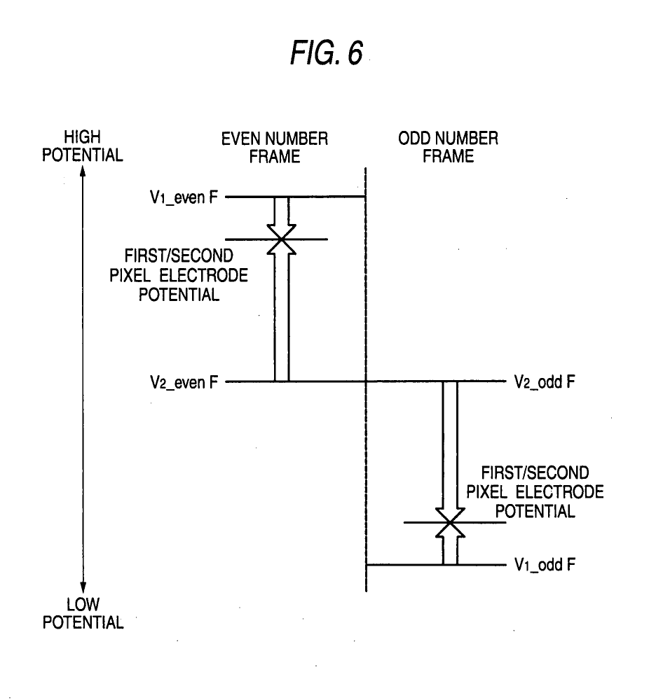

In this case, for example, it is also possible that V1_evenF=V1_oddF or V2_evenF=V2_oddF is satisfied. Then, an identical voltage is applied to any one of the first counter electrode 21 and the second counter electrode 22 regardless of a frame. Therefore, the structure of a circuit that applies voltages to the counter electrodes can be simplified. An example of operations at the time when V2_evenF=V2_oddF is shown in FIG. 6. For operations at the time when V1_evenF=V1_oddF, voltages shown in FIG. 6 are interchanged. Thus, the operations are not shown in the figure.

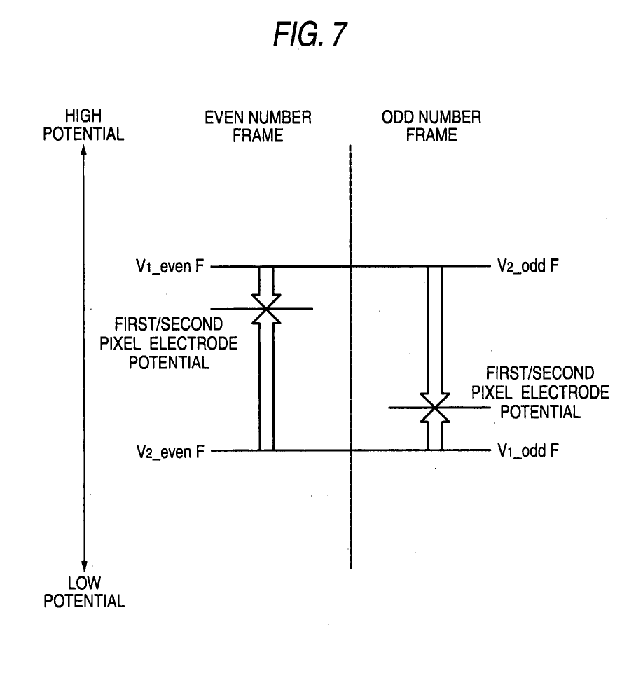

It is also possible that V1_evenF=V2_oddF and V1_oddF=V2_evenF are satisfied. An example of operations at the time when V1_evenF=V2_oddF and V1_oddF=V2_evenF is shown in FIG. 7. In this case, compared with FIG. 6, fluctuation in the respective voltages can be reduced. Thus, it is possible to realize a reduction in power consumption of the liquid crystal display device.

The structure for applying an electric field to the liquid crystal layer 30 while inverting a direction has been explained. Embodiments of the invention are explained below with reference to the drawings.

### First Embodiment

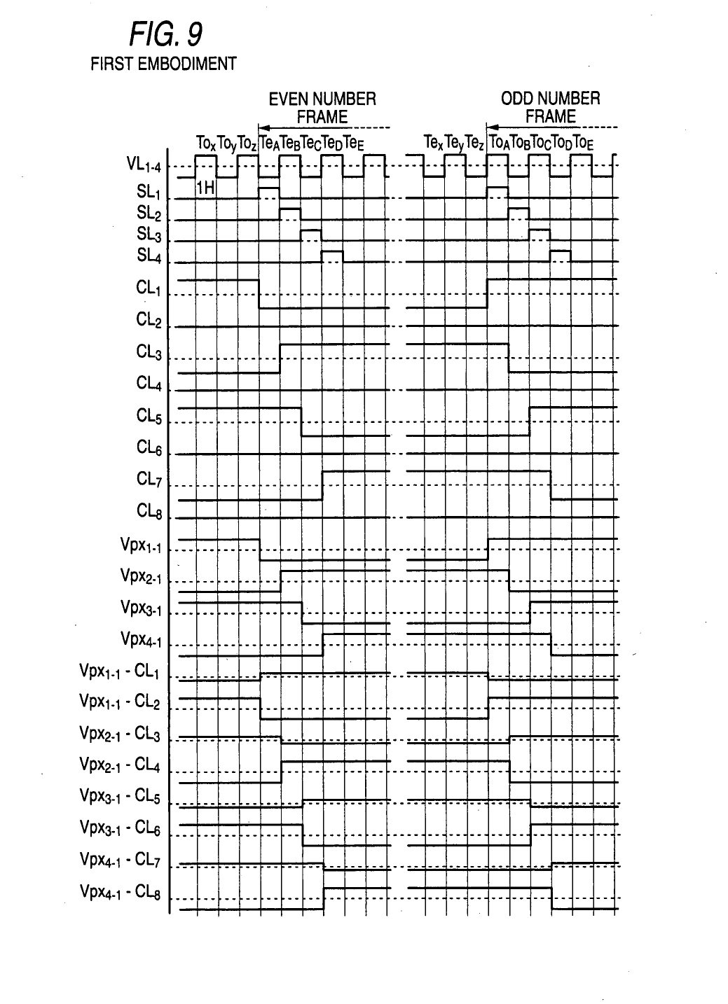

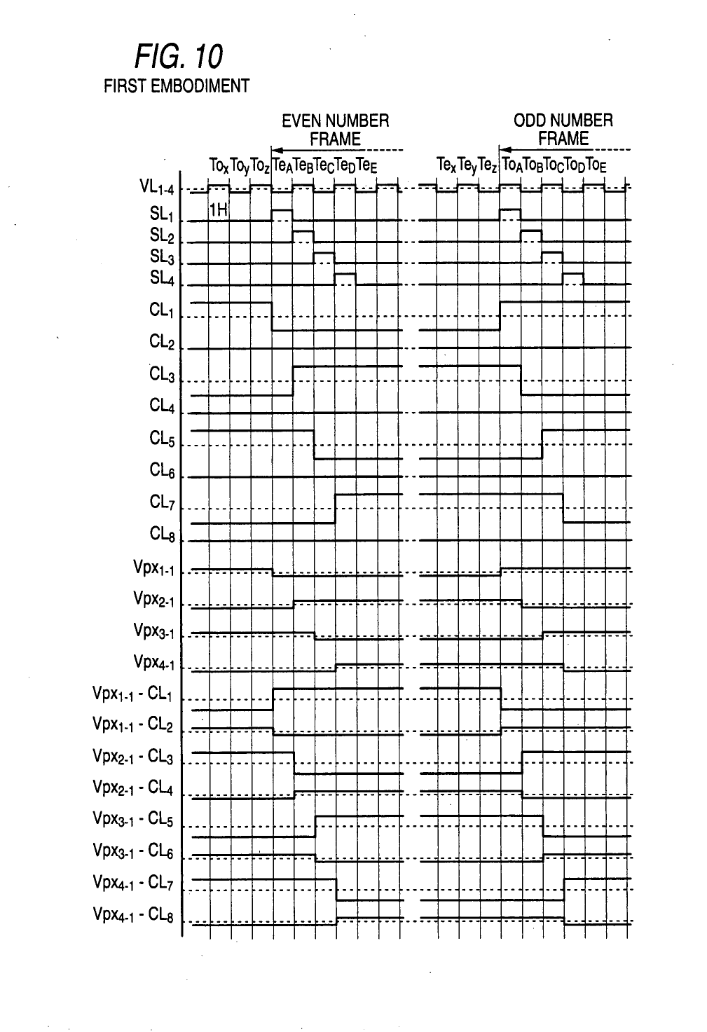

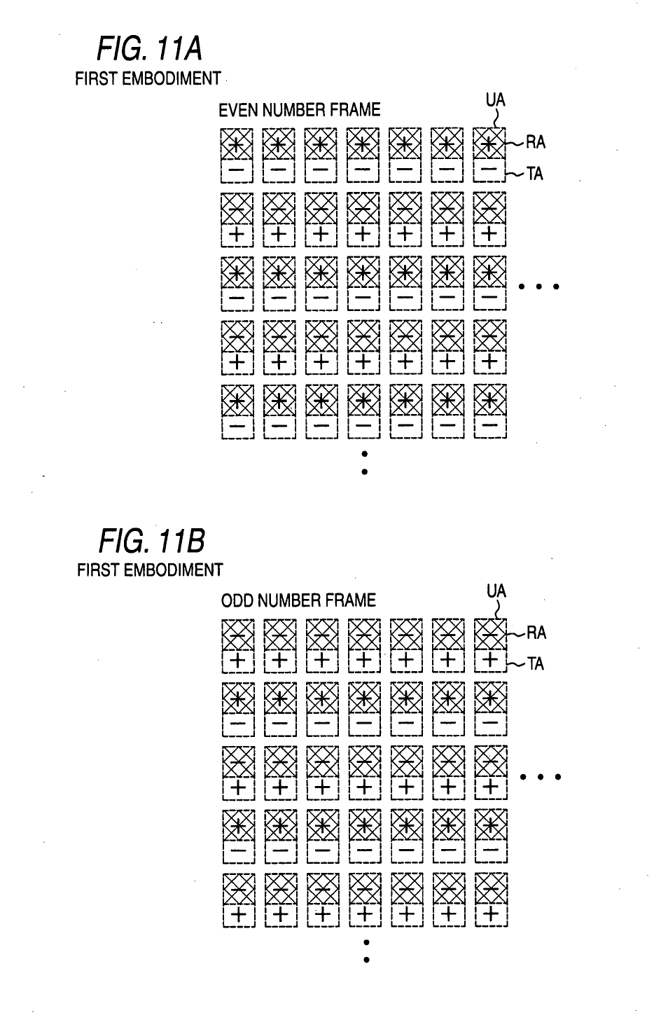

A first embodiment of the invention is directed to a liquid crystal display device. FIG. 8 is a schematic diagram of the liquid crystal display device 1 according to the first embodiment of the invention. FIG. 9 is a schematic timing chart of operations in a white display state of the liquid crystal display device 1 according to the first embodiment. FIG. 10 is a schematic timing chart of operations in a black display state of the liquid crystal display device 1 according to the first embodiment. For convenience of explanation, it is assumed that the unit display areas UA are arranged in a 4×4 matrix shape. However, an arrangement of the unit display areas UA is not limited to this. The same holds true for other embodiments described later.

For convenience of explanation, in this embodiment and the other embodiments described later, it is assumed that an absolute value of a potential difference in design between the first counter electrode 21 and the second counter electrode 22 is 10 volts in each of the unit display areas UA. The white display state in the embodiments indicates a state in which an absolute value of a potential difference between the first counter electrode 21 and the first pixel electrode 20A provided in the reflection area RA is 2 volts and an absolute value of a potential difference between the second counter electrode 22 and the second pixel electrode 20B provided in the transmission area TA is 8 volts (i.e., a state slightly darker than the maximum white display state in design). The black display state in the embodiments indicates a state in which an absolute value of a potential difference between the first counter electrode 21 and the first pixel electrode 20A provided in the reflection area RA is 8 volts and an absolute value of a potential difference between the second counter electrode 22 and the second pixel electrode 20B provided in the transmission area TA is 2 volts (i.e., a state slightly brighter than the maximum black display state in design).

As shown in FIG. 8, a first row corresponding to a signal line SL1 described later is formed by unit display areas UA1_1 to UA1_4. A fourth row corresponding to a signal line SL4 is formed by unit display areas UA4_1 to UA4_4. Similarly, a second row corresponding to a signal line SL2 is formed by unit display areas UA2_1 to UA2_4. A third row corresponding to a signal line SL3 is formed by unit display areas UA3_1 to US3_4. However, in FIG. 8, representation of these rows is omitted. The reflection area RA and the transmission area TA forming the unit display area UA1_1 are represented as a reflection area RA1_1 and a transmission area TA1_1, respectively. The same holds true for the other unit display areas UA and the other embodiments described later.

As shown in FIG. 8, an input signal of an image that should be displayed is inputted to a control circuit 70. According to a command of the control circuit 70, the scanning signal driving circuit 71, the video signal driving circuit 72, and the common electrode driving circuit 73 operate at predetermined timing.

In the liquid crystal display device 1 according to the first embodiment, when scanning by first to Mth (in the example shown in FIG. 8, M=4) scanning signal lines SL for forming a certain frame is completed, in each of the unit display areas UA corresponding to an mth (m=1, 2, . . . , M) scanning signal line SLm, a first voltage V1_m is applied to the first counter electrode 21 and a second voltage V2_m is applied to the second counter electrode 22. In other words, a common first voltage is applied to the respective first counter electrodes 21 in the unit display areas UA1_1 to UA1_4 in the first row and a common second voltage is applied to the respective second counter electrodes 22. The same holds true for the respective unit display areas UA in the second and subsequent rows and in second to fourth embodiments described later.

More specifically, as shown in FIG. 8, the liquid crystal display device 1 according to the first embodiment includes P (P=2M; in the example shown in FIG. 8, P=8) common electrode lines CL. Any one of the first counter electrode 21 and the second counter electrode 22 in each of the unit display area UA corresponding to the mth scanning signal line SLm (in the example shown in FIG. 8, the first counter electrode 21 provided in the reflection area RA) and a pth (p=2m−1) common electrode line CLp are connected. The other counter electrode (in the example shown in FIG. 8, the second counter electrode 22 provided in the transmission area TA) and a (p+1)th common electrode line CLp+1 are connected. In the first embodiment, the unit display areas UA forming adjacent rows are arranged such that the reflection area RA and the transmission area TA are opposed to each other. The schematic structure of the first counter electrode 21 and the second counter electrode 22 is as shown in FIG. 3A.

The first voltage is applied to the first counter electrode 21 via the common electrode line CL connected to the first counter electrode 21. The second voltage is applied to the second counter electrode 22 via the common electrode line CL connected to the second counter electrode 22. Consequently, the common first voltage is applied to the first counter electrodes 21 in the unit display areas UA in the respective rows and the common second voltage is applied to the second counter electrodes 22.

In FIGS. 9 and 10, the left side of the figure shows a timing chart in forming an even number frame and the right side of the figure shows a timing chart in forming an odd number frame. The same holds true for drawings concerning the other embodiments described later.

In FIGS. 9 and 10, Vpx1_1 indicates a voltage at pixel electrodes corresponding to the unit display area UA1_1 (specifically, the first pixel electrode 20A and the second pixel electrode 20B). The same holds true for Vpx2_1 to Vpx4_1. CL1 indicates a voltage at each of common electrode lines CL1. The same holds true for CL2 to CL8 indicate voltages in the same manner and in the drawings concerning the other embodiments described later.

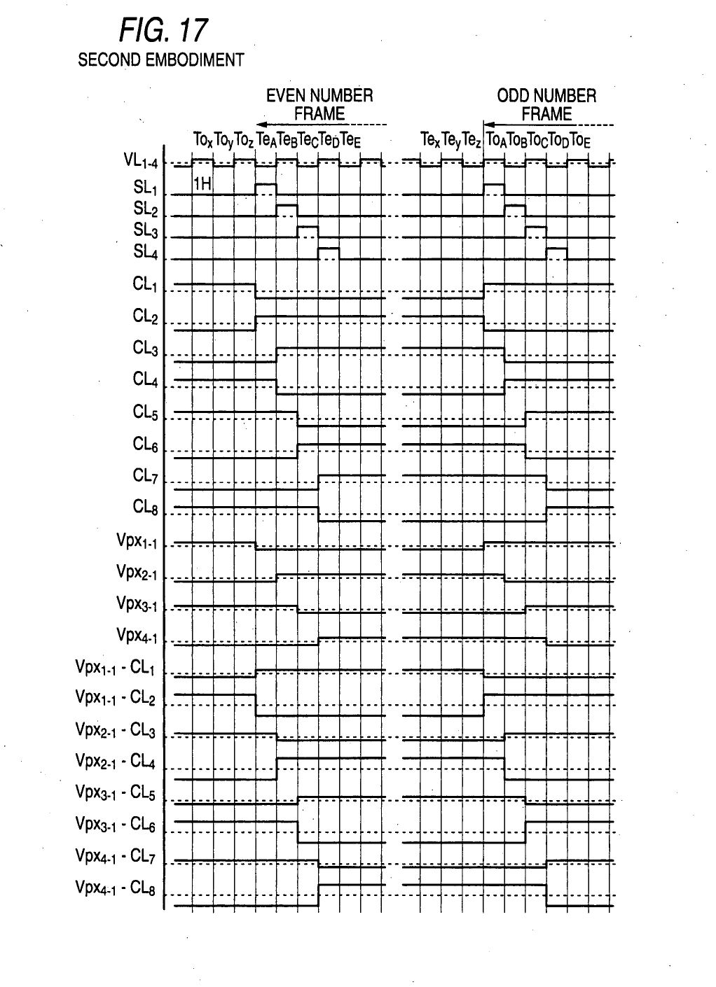

In FIGS. 9 and 10, “Vpx1_1−CL1” corresponds to a potential difference between the first pixel electrode 20A and the first counter electrode 21 corresponding to the unit display area UA1_1. “Vpx1_1−CL2” corresponds to a potential difference between the second pixel electrode 20B and the second counter electrode 22 corresponding to the unit display area UA1_1. The same holds true for “Vpx2_1−CL3” to “Vpx4_1−CL8” and in FIG. 17 in the second embodiment described later.

Specifically, waveforms indicated by “Vpx1_1−CL1” to “Vpx4_1−CL8” represent waveforms of potential differences between pixel electrodes and counter electrodes in a reflection area RA1_1, a transmission area TA1_1, a reflection area RA2_1, a transmission area TA2_1, a reflection area RA3_1, a transmission area TA3_1, a reflection area RA4_1, and a transmission area TA4_1 forming a first unit display area column shown in FIG. 8, respectively. In the example shown in FIGS. 9 and 10, voltages applied to the video signal lines VL1 to VL4 are set to the same value. Thus, the waveforms substantially correspond to a potential difference between the first pixel electrode 20A and the first counter electrode 21 provided in the reflection area RA in the unit display area UA in each of the rows and a potential difference between the second pixel electrode 20B and the second counter electrode 22 provided in the transmission area TA. The same holds true in FIG. 17 in the second embodiment described later.

As shown in FIGS. 9 and 10, scanning pulses are sequentially applied to the scanning signal lines SL1 to SL4 from the scanning signal driving circuit 71. For example, while a scanning pulse of the scanning signal line SL1 is applied, the transistors 14 of the unit display areas UA1_1 to UA1_4 in the first row are turned on and the third voltage is applied to the pixel electrodes of the respective unit display areas UA from the video signal driving circuit 72 as a video signal via the video signal lines VL1 to VL4. After the end of the scanning pulse of the scanning signal line SL1, the transistors 14 of the respective unit display areas UA in the first row are turned off. A potential difference between the first pixel electrode 20A and the first counter electrode 21 in each of the unit display areas UA is stored by the first storage capacitor 24. A potential difference between the second pixel electrode 20B and the second counter electrode 22 is stored by the second storage capacitor 25. The same holds true for the unit display areas UA in the second and subsequent rows. As explained above, the liquid crystal display device 1 according to the first embodiment is line-sequentially driven. The same holds true in the other embodiments described later.

Operations in the white display state are explained below with reference to FIG. 9.

As shown in FIG. 9, formation of an even number frame is started in a period TeA. The length of respective periods shown in FIG. 9 including the period TeA is a so-called horizontal scanning period (1H). A state before the period TeA is a state after formation of a preceding frame (i.e., an immediately preceding odd number frame) ends. Basically, the state is the same as a state after a period ToE when formation of an odd number frame shown in FIG. 9 ends.

Before a period ToZ

In this state, when a voltage of a certain fixed value is represented as V0 (for convenience of explanation, in this embodiment and the other embodiments described later, V0 is treated as 0 volt), a voltage of V0 (=0 volt) is applied to the common electrode lines CL2, CL4, CL6, and CL8 connected to the transmission area TA from the common electrode driving circuit 73. Similarly, a voltage of V0+10 volts (=10 volts) is applied to the common electrode lines CL1 and CL5 and a voltage of V0−10 volts (=−10 volts) is applied to the common electrode lines CL3 and CL7. Values of Vpx1_1 to Vpx4_1 are values of voltages applied via the video signal lines VL1 and stored by the first storage capacitor 24 and the second storage capacitor 25 during formation of an immediately preceding odd number frame. Values of Vpx1_1 and Vpx3_1 are V0+8 volts (=8 volts) and values of Vpx2_1 and Vpx4_1 are V0+8 volts (=−8 volts).

Period TeA

In the period TeA, a voltage of V0−8 volts (=−8 volts) is applied to the video signal lines VL1 to VL4 from the video signal driving circuit 72 and a scanning pulse is applied to the scanning signal line SL1. A voltage of V0−10 volts (=−10 volts) is applied to the common electrode line CL1 from the common electrode driving circuit 73 (i.e., a voltage at the common electrode line CL1 changes from +10 volts to −10 volts).

The voltage at the common electrode line CL1 can also be changed prior to the start of the period TeA. The same holds true for other periods TeB to TeD and ToA to ToD described later. After the voltage at the common electrode line CL is decided, a voltage is applied to the first pixel electrode 20A and the second pixel electrode 20B in the unit display area UA from the video signal line VL. Consequently, a potential difference can be more effectively stored in the first storage capacitor 24 and the second storage capacitor 25. Depending on the structure of the liquid crystal display device, for example, the voltage at the common electrode line CL can be changed earlier by 0 to several H. The same holds true in the other embodiments described later. Before the period ToZ, the transistor 14 in the unit display area UA is off. Therefore, a potential of the pixel electrodes in the unit display areas UA in the first row is decided by the voltage at the common electrode line CL and charge amounts written in the first storage capacitor 24 and the second storage capacitor 25 by scanning of an immediately preceding odd number frame.

Therefore, for example, when a voltage applied to the common electrode line CL1 changes in the period ToZ 1H earlier, before the period ToY and in the period ToZ, a potential of the pixel electrodes in the unit display areas UA in the first row with respect to the common electrode lines CL1 and CL2 changes (a voltage division relation of a voltage changes). Therefore, in the period ToZ, it is likely that luminance change in the unit display areas UA in the first row occurs. However, since the change is a change that occurs in a sufficiently short time compared with time in which one frame is formed, the change can be practically neglected. In the third to fifth embodiment described later, the voltage at the common electrode line CL is changed earlier. For convenience of explanation, timing charts shown in the drawings used for explanation of these embodiments are represented assuming that there is no change in the voltage division relation of a voltage.

In the period TeA, the transistors 14 in the unit display areas UA1_1 to UA1_4 in the first row are turned on by a scanning pulse of the scanning signal line SL1. A voltage of −8 volts is applied to the first pixel electrode 20A and the second pixel electrode 20B in each of the unit display areas UA from the video signal driving circuit 72 via the video signal lines VL1 to VL4. The applied voltage is stored by the first storage capacitor 24 and the second storage capacitor 25 in each of the unit display areas UA even after the scanning pulse of the scanning signal line SL1 ends.

Period TeB

In the period TeB, a voltage of V0+8 volts (=8 volts) is applied to the video signal lines VL1 to VL4 from the video signal driving circuit 72. A scanning pulse is applied to the scanning signal line SL2. A voltage of V0+10 volts (=10 volts) is applied to the common electrode line CL3 from the common electrode driving circuit 73 (i.e., a voltage at the common electrode line CL3 changes from −10 volts to +10 volts).

In the same manner as described above, the transistors 14 in the unit display areas UA2_1 to UA2_4 in the second row are turned on. A voltage of 8 volts is applied to the first pixel electrode 20A and the second pixel electrode 20B in each of the unit display areas UA via the video signal lines VL1 to VL4 from the video signal driving circuit 72. The applied voltage is stored by the first storage capacitor 24 and the second storage capacitor 25 in each of the unit display areas UA even after the scanning pulse of the scanning signal line SL2 ends.

Period TeC

In the period TeC, a voltage of V0−8 volts (=−8 volts) is applied to the video signal lines VL1 to VL4 from the video signal driving circuit 72. A scanning pulse is applied to the scanning signal line SL3. A voltage of V0−10 volts (=−10 volts) is applied to the common electrode line CL5 from the common electrode driving circuit 73 (i.e., a voltage at the common electrode line CL5 changes from +10 volts to −10 volts).

In the same manner as described above, the transistors 14 in the unit display areas UA3_1 to UA3_4 in the third row are turned on. A voltage of −8 volts is applied to the first pixel electrode 20A and the second pixel electrode 20B in each of the unit display areas UA via the video signal lines VL1 to VL4 from the video signal driving circuit 72. The applied voltage is stored by the first storage capacitor 24 and the second storage capacitor 25 in each of the unit display areas UA even after the scanning pulse of the scanning signal line SL3 ends.

Period TeD

In the period TeD, a voltage of V0+8 volts (=8 volts) is applied to the video signal lines VL1 to VL4 from the video signal driving circuit 72. A scanning pulse is applied to the scanning signal line SL4. A voltage of V0+10 volts (=10 volts) is applied to the common electrode line CL7 from the common electrode driving circuit 73 (i.e., a voltage at the common electrode line CL7 changes from −10 volts to 10 volts).

In the same manner as described above, the transistors 14 in the unit display areas UA4_1 to UA4_4 in the fourth row are turned on. A voltage of 8 volts is applied to the first pixel electrode 20A and the second pixel electrode 20B in each of the unit display areas UA via the video signal lines VL1 to VL4 from the video signal driving circuit 72. The applied voltage is stored by the first storage capacitor 24 and the second storage capacitor 25 in each of the unit display areas UA even after the scanning pulse of the scanning signal line SL4 ends.

According to the operations in the periods TeA to TeD explained above, the formation of an even number frame ends. At a point of the period TeE when the formation of an even number frame ends, potential differences in the respective reflection areas and transmission areas are as follows:

a potential difference in the reflection area RA1_1: Vpx1_1−CL1=2 volts

a potential difference in the transmission area TA1_1: Vpx1_1−CL2=−8 volts

a potential difference in the reflection area RA2_1: Vpx2_1−CL3=−2 volts

a potential difference in the transmission area TA2_1: Vpx2_1−CL4=8 volts

a potential difference in the reflection area RA3_1: Vpx3_1−CL5=2 volts

a potential difference in the transmission area TA3_1: Vpx3_1−CL6=−8 volts

a potential difference in the reflection area RA4_1: Vpx4_1−CL7=−2 volts

a potential difference in the transmission area TA4_1: Vpx4_1−CL8=8 volts

Therefore, at the point when the formation of an even number frame ends, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

Formation of an odd number frame is explained. The formation of an odd number frame is started in the period ToA. A state before the period ToA is a state after formation of a preceding frame (i.e., an immediately preceding even number frame) ends. Basically, the state is the same as the state after the period TeE when the formation of an even number frame ends shown in FIG. 9.

Operations in the periods ToA to ToD are basically the same as those explained about the periods TeA to TeD. Since waveforms of voltages applied to the video signal lines VL1 to VL4 and the common electrode lines CL1, CL3, CL5, and CL7 only have to be inverted, explanation of the operations is omitted.

The formation of an odd number frame is finished by the operations in the periods ToA to ToD. At a point of the period ToE when the formation of an odd number frame ends, potential differences in the respective reflection areas and transmission areas are as follows:

a potential difference in the reflection area RA1_1: Vpx1_1−CL1=−2 volts

a potential difference in the transmission area TA1_1: Vpx1_1−CL2=8 volts

a potential difference in the reflection area RA2_1: Vpx2_1−CL3=2 volts

a potential difference in the transmission area TA2_1: Vpx2_1−CL4=−8 volts

a potential difference in the reflection area RA3_1: Vpx3_1−CL5=−2 volts

a potential difference in the transmission area TA3_1: Vpx3_1−CL6=8 volts

a potential difference in the reflection area RA4_1: Vpx4_1−CL7=2 volts

a potential difference in the transmission area TA4_1: Vpx4_1−CL8=−8 volts

Polarities of the voltages are inverted from those in the even number frame. However, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

In the even number frame and the odd number frame, a relation between voltages applied to the first counter electrode 21 and the second counter electrode 22 is as described below. For example, when scanning by the first to Mth scanning signal lines SL for forming an even number frame is completed, in a certain unit display area UA, the first voltage applied to the first counter electrode 21 is represented as V1_evenF and the second voltage applied to the second counter electrode 22 is represented as V2_evenF. When scanning by the first to Mth scanning signal lines SL for forming an odd number frame is completed, in the unit display area UA, the first voltage applied to the first counter electrode 21 is represented as V1_oddF and the second voltage applied to the second counter electrode 22 is represented as V2_oddF. A relation V1_evenF−V2_evenF=−(V1_oddF−V2_oddF) is satisfied. In the liquid crystal display device 1 according to the first embodiment, a direction of an electric field applied to the liquid crystal layer 30 changes for each of frames. It is possible to prevent liquid crystals from being deteriorated when an electric field is applied in one direction for a long time. In FIG. 11A, polarities of voltage at pixel electrodes with respect to counter electrodes in the respective unit display areas UA in an even number frame are shown. In FIG. 11B, polarities of voltages at pixel electrodes with reference to counter electrodes in the respective unit display areas UA in an odd number frame are shown. In FIGS. 11A and 11B, for convenience of illustration, a large number of unit display areas UA are arranged in a matrix shape. The same holds true in FIGS. 16, 24, and 28 referred to later.

In this case, a relation V2_evenF=V2_oddF is satisfied. A voltage V0 (=0 volt) of a certain fixed value is typically applied to the common electrode lines CL2, CL4, CL6, and CL8 connected to the transmission areas TA regardless of whether a frame is an even number frame or an odd number frame. Therefore, it is possible to simplify the structure of the common electrode driving circuit 73 that applies a voltage to the second counter electrode 22.

Attention is paid to a relation at a point when scanning by the first to Mth scanning signal lines SL for forming a certain frame is completed. In each of the unit display areas UA corresponding to the mth (m=1, 2, . . . , M) scanning signal line SLm, the first voltage V1_m is applied to the first counter electrode 21 and the second voltage V2_m is applied to the second counter electrode 22.

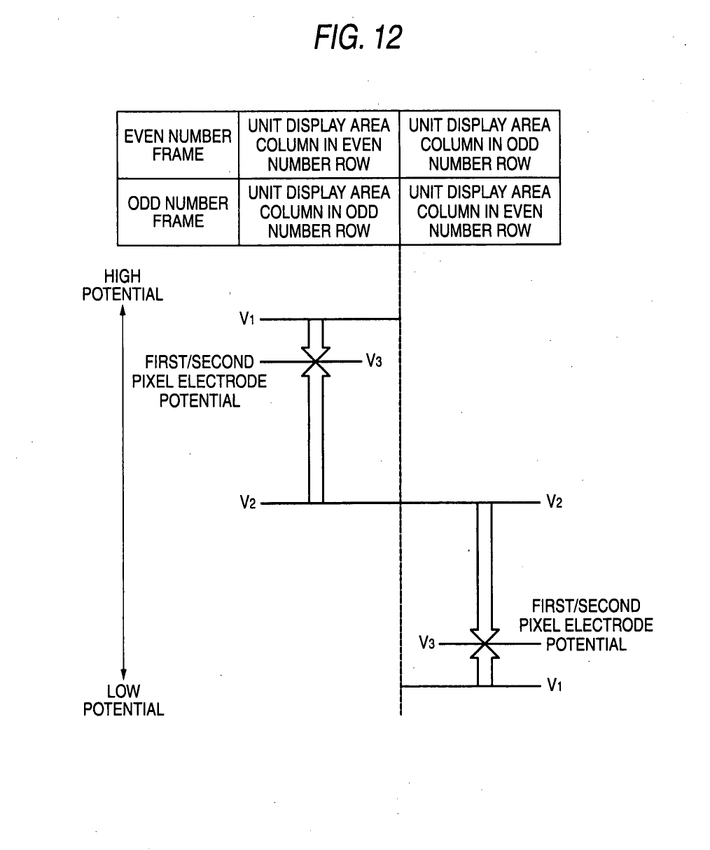

A relation that the voltage V2_m is a fixed value V2_const and the voltage V1_m is a fixed value V1_odd when a value of m is an odd number and is a fixed value V1_even different from V1_odd when a value of m is an even number is satisfied. In addition, a relation V1_odd−V2_const=−(V1_even−V2_const) is satisfied. In the liquid crystal display device 1 according to the first embodiment that satisfies these relations, polarities of applied voltages are inverted in the respective unit display areas UA corresponding to an odd number scanning signal line SL and the respective unit display areas UA corresponding to an even number scanning signal line SL. Consequently, flicker of a display image can be reduced. A relation among the first voltage V1, the second voltage V2, and the third voltage V3 in the respective unit display areas UA in an odd number row and an even number row is schematically shown in FIG. 12.

The operations in the white display state have been explained with reference to FIG. 9. Next, operations in a black display state are explained with reference to FIG. 10.

The operations in the black display state are basically a the same as the operations in the periods TeA to TeD and the periods ToA to ToD in FIG. 9. The operations in the black display state are different only in that values of voltages applied to the video signal lines VL1 to VL4 are changed from 8 volts to 2 volts and from −8 volts to −2 volts. Therefore, explanation in the respective periods is omitted.

Formation of an even number frame is finished by operations in the periods TeA to TeD in FIG. 10. At a point of the period TeE when the formation of an even number frame ends, potential differences in the respective reflection areas and transmission areas are as follows:

a potential difference in the reflection area RA1_1: Vpx1_1−CL1=8 volts

a potential difference in the transmission area TA1_1: Vpx1_1−CL2=−2 volts

a potential difference in the reflection area RA2_1: Vpx2_1−CL3=−8 volts

a potential difference in the transmission area TA2_1: Vpx2_1−CL4=2 volts

a potential difference in the reflection area RA3_1: Vpx3_1−CL5=8 volts

a potential difference in the transmission area TA3_1: Vpx3_1−CL6=−2 volts

a potential difference in the reflection area RA4_1: Vpx4_1−CL7=−8 volts

a potential difference in the transmission area TA4_1: Vpx4_1−CL8=2 volts

Therefore, an absolute value of a potential difference between the first pixel electrode 20A and the first counter electrode 21 in each of the reflection areas RA is 8 volts and an absolute value of a potential difference between the second pixel electrode 20B and the second counter electrode 22 in each of the transmission areas TA is 2 volts. Therefore, a difference in operation modes in the transmission area TA and the reflection area RA is electrically compensated. An image in a black display state slightly brighter than the maximum black display state in design is displayed.

Formation of an odd number frame is finished by operations in the periods ToA to ToD in FIG. 10. At a point of the period TeE when the formation of an odd number frame ends, potential differences in the respective reflection areas and transmission areas are as follows:

a potential difference in the reflection area RA1_1: Vpx1_1−CL1=−8 volts

a potential difference in the transmission area TA1_1: Vpx1_1−CL2=2 volts

a potential difference in the reflection area RA2_1: Vpx2_1−CL3=8 volts

a potential difference in the transmission area TA2_1: Vpx2_1−CL4=−2 volts

a potential difference in the reflection area RA3_1: Vpx3_1−CL5=−8 volts

a potential difference in the transmission area TA3_1: Vpx3_1−CL6=2 volts

a potential difference in the reflection area RA4_1: Vpx4_1−CL7=8 volts

a potential difference in the transmission area TA4_1: Vpx4_1−CL8=−2 volts

Polarities of the voltages are inverted from those in the even number frame. However, an absolute value of a potential difference between the first pixel electrode 20A and the first counter electrode 21 in each of the reflection areas RA is 8 volts and an absolute value of a potential difference between the second pixel electrode 20B and the second counter electrode 22 in each of the transmission areas TA is 2 volts. Therefore, a difference in operation modes in the transmission area TA and the reflection area RA is electrically compensated. An image in a black display state slightly brighter than the maximum black display state in design is displayed.

The operations of the liquid crystal display device 1 according to the first embodiment have been explained. In the explanation, the voltage V0 (=0 volt) of a certain fixed value is typically applied to the common electrode line CL2, CL4, CL6, and CL8 connected to the transmission area TA. However, the application of a voltage is not limited to this. A relation between a voltage applied to the common electrode lines CL2, CL4, CL6, and CL8 and a voltage applied to the common electrode lines CL1, CL3, CL5, and CL7 can be interchanged.

When the relation between a voltage applied to the common electrode lines CL2, CL4, CL6, and CL8 and a voltage applied to the common electrode lines CL1, CL3, CL5, and CL7 can be interchanged, as described above, attention is paid to a relation at a point when scanning by the first to Mth scanning signal lines SL for forming a certain frame is completed. In each of the unit display areas UA corresponding to the mth (m=1, 2, . . . , M) scanning signal line SLm, the first voltage V1_m is applied to the first counter electrode 21 and the second voltage V2_m is applied to the second counter electrode 22.

A relation that the voltage V1_m is a fixed value V1_const and the voltage V2_m is a fixed value V2_odd when a value of m is an odd number and is a fixed value V2_even different from V2_odd when a value of m is an even number is satisfied. In addition, a relation V1_const−V2_odd=−(V1_const−V2_even) is satisfied. In the liquid crystal display device 1 according to the first embodiment that satisfies these relations, polarities of applied voltages are inverted in the respective unit display areas UA corresponding to an odd number scanning signal line SL and the respective unit display areas UA corresponding to an even number scanning signal line SL. Therefore, flicker of a display image can be reduced.

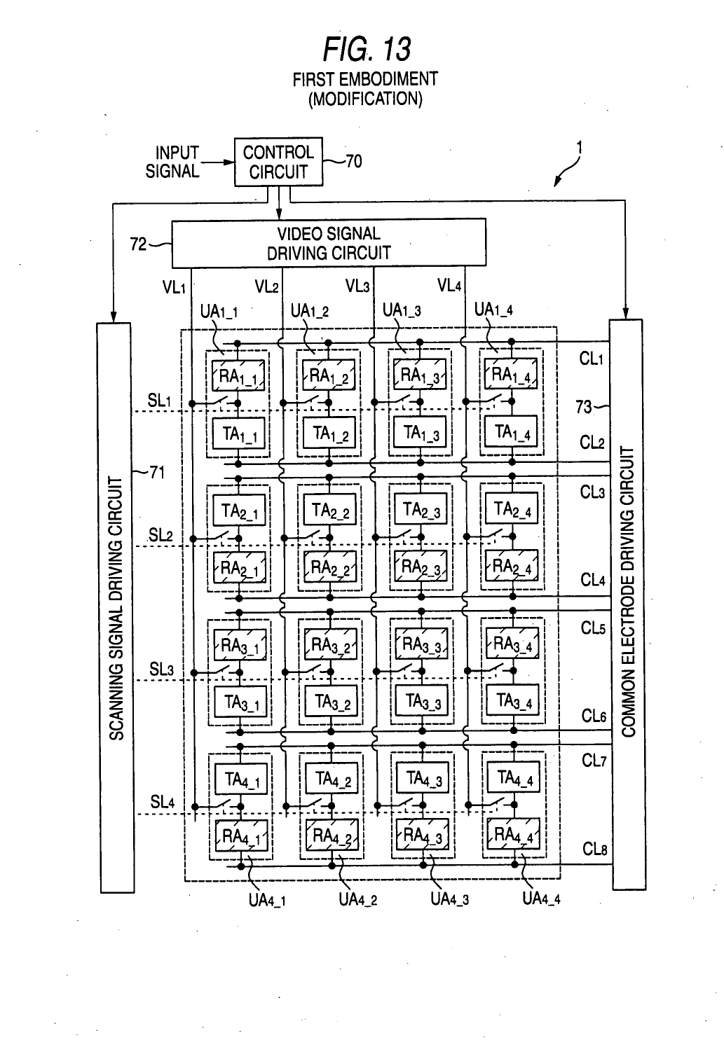

A modification of the first embodiment is briefly explained. FIG. 13 is a schematic diagram of a liquid crystal display device in the modification of the first embodiment.

In FIG. 8, the unit display areas UA forming adjacent rows are arranged such that the reflection area RA and the transmission area TA are opposed to each other. On the other hand, in the modification shown in FIG. 13, the unit display areas UA are arranged such that same kinds of areas are opposed to each other. More specifically, in the modification shown in FIG. 13, the reflection areas RA and the transmission areas TA of the respective unit display areas UA corresponding to the scanning signal lines SL2 and SL4 shown in FIG. 8 are interchanged.

In an area in which the reflection areas RA are opposed to each other, reflectors and the like provided in the reflection areas RA can be continuously formed to extend over a plurality of the unit display areas UA. The same holds true for various components formed in the transmission areas TA. In the structure described above, a dividing process and the like for the reflectors and the like are unnecessary and it is possible to further increase a margin in the structure of the liquid crystal display device.

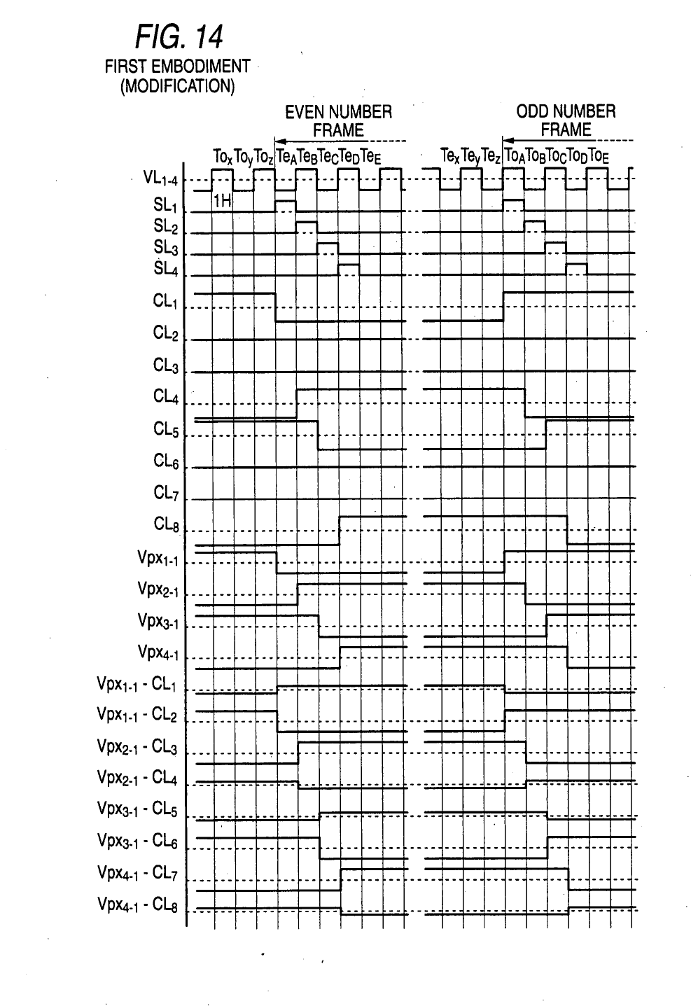

FIG. 14 is a schematic timing chart of operations in the modification in FIG. 13 corresponding to the operations shown in FIG. 9. When the operations corresponding to the operations shown in FIG. 9 are performed, voltages applied to a part of the common electrode lines CL only have to be interchanged. Specifically, in FIG. 9, the waveform of the common electrode line CL3 and the waveform of the common electrode line CL4 only have to be interchanged and the waveform of the common electrode line CL7 and the waveform of the common electrode line CL8 only have to be interchanged (according to the interchange, the waveform of Vpx2_1−CL3 and the waveform of Vpx2_1−CL4 shown in FIG. 9 are interchanged and the waveform of Vpx4_1−CL7 and the waveform of Vpx4_1−CL8 shown in FIG. 9 are interchanged). In the modification, the same holds true when operations same as the operations shown in FIG. 10 are performed.

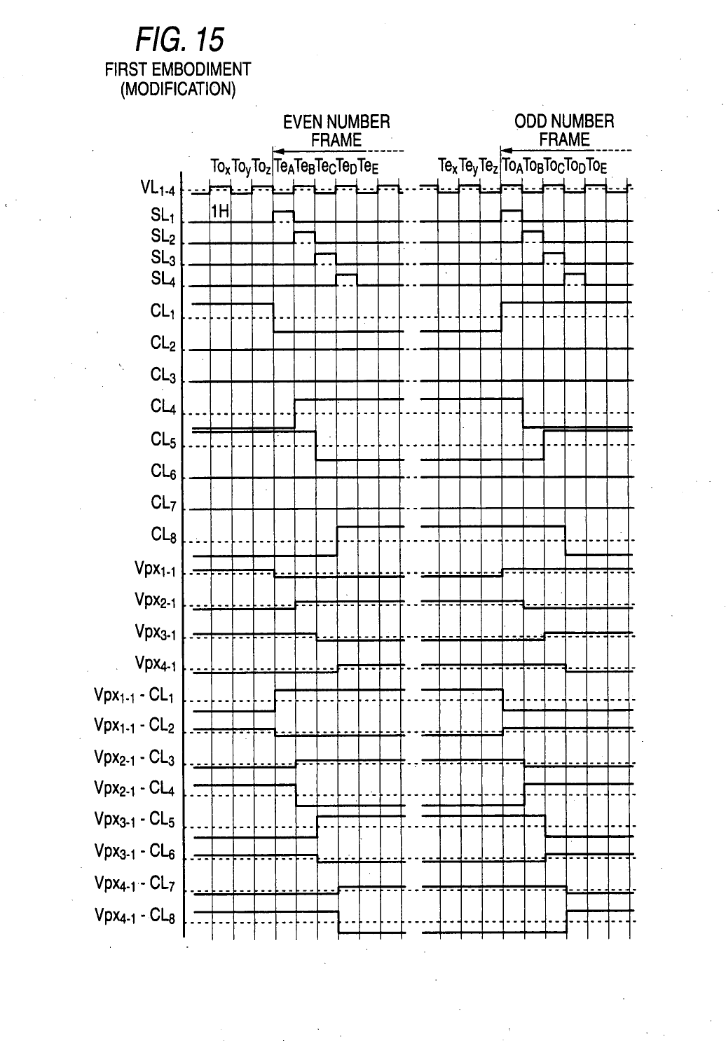

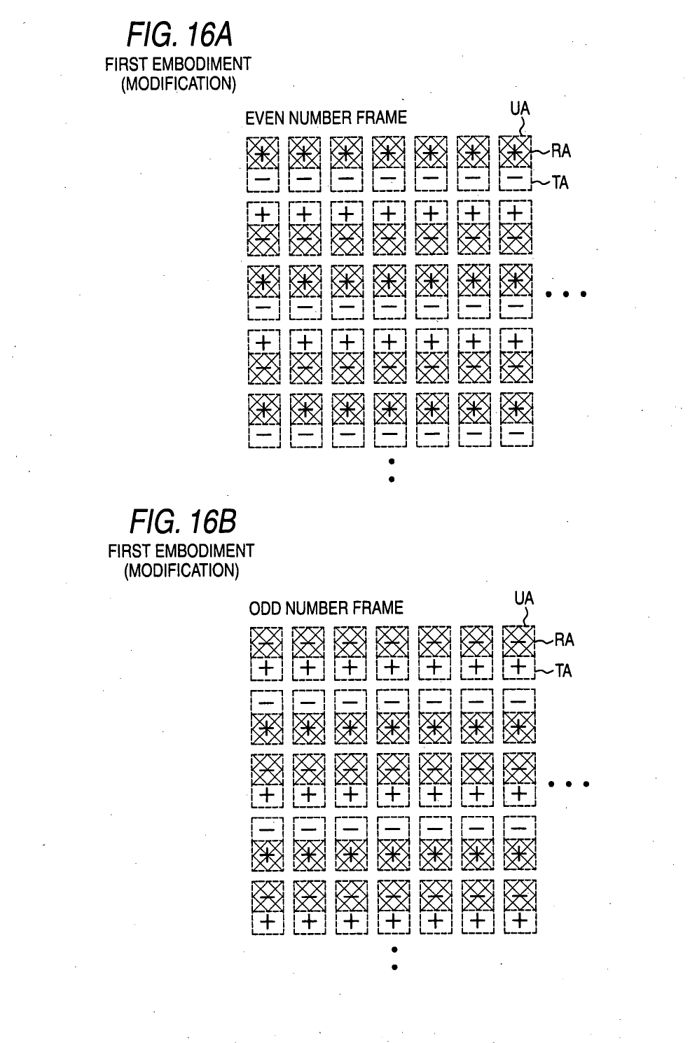

FIG. 15 is a schematic timing chart of operations in the modification shown in FIG. 13 corresponding to the operations shown in FIG. 10. FIG. 16A is a diagram showing polarities of voltages at pixel electrodes with respect to counter electrodes in respective unit display areas in an even number frame in the modification. FIG. 16B is a diagram showing polarities of voltages at pixel electrodes with respect to counter electrodes in respective unit display areas in an odd number frame in the modification.

### Second Embodiment

A second embodiment is a modification of the first embodiment. The second embodiment has a characteristic that absolute values of voltages applied to the video signal line VL and the common electrode line CL can be reduced compared with the first embodiment. The structure itself of a liquid crystal display device 2 according to the second embodiment is the same as that explained in the first embodiment. Only operations of the liquid crystal display device 2 are different from those explained in the first embodiment. Thus, the explanation of the structure of the liquid crystal display device is omitted.

In the second embodiment and embodiments described later, for convenience of explanation, only operations in a white display state are explained. FIG. 17 is a schematic timing chart of operations in a white display state of the liquid crystal display device 2 according to the second embodiment.

As in the FIG. 9 in the first embodiment, in FIG. 17, formation of an even number frame is started in a period TeA. A state before the period TeA is a state after formation of a preceding frame (i.e., an immediately preceding odd number frame) ends. Basically, the state is the same as a state after a period ToE when formation of an odd number frame shown in FIG. 17 ends.

Before a period ToZ

In this state, when a voltage of a certain fixed value is represented as V0, a voltage of V0+5 volts (=5 volt) is applied to the common electrode lines CL1, CL4, CL5, and CL8 and a voltage of V0−5 volts (=−5 volts) is applied to the common electrode lines CL2, CL3, CL6, and CL7 from the common electrode driving circuit 73. Values of Vpx1_1 to Vpx4_1 are values of voltages applied via the video signal lines VL1 and stored by the first storage capacitor 24 and the second storage capacitor 25 during formation of an immediately preceding odd number frame. Values of Vpx1_1 and Vpx3_1 are V0+3 volts (=3 volts) and values of Vpx2_1 and Vpx4_1 are V0−3 volts (=−3 volts).

Period TeA

In the period TeA, a voltage of V0−3 volts (=−3 volts) is applied to the video signal lines VL1 to VL4 from the video signal driving circuit 72 and a scanning pulse is applied to the scanning signal line SL1. A voltage of V0−5 volts (=−5 volts) is applied to the common electrode line CL1 from the common electrode driving circuit 73 (i.e., a voltage at the common electrode line CL1 changes from +5 volts to −5 volts). In the second embodiment, unlike the first embodiment, a voltage applied to the adjacent common electrode line CL2 is also changed. More specifically, a voltage of V0+5 volts (=5 volts) is applied to the common electrode line CL2 from the common electrode driving circuit 73 (i.e., a voltage at the common electrode line CL2 changes from −5 volts to 5 volts).

As explained in the first embodiment, in the period TeA, a voltage of −3 volts is applied to the first pixel electrode 20A and the second pixel electrode 20B in each of the unit display areas UA1_1 to UA1_4 in the first row by the scanning pulse of the scanning signal line SL1. The applied voltage is stored by the first storage capacitor 24 and the second storage capacitor 25 in each of the unit display areas UA even after the scanning pulse of the scanning signal line SL1 ends.

Period TeB

In the period TeB, a voltage of V0+3 volts (=3 volts) is applied to the video signal lines VL1 to VL4 from the video signal driving circuit 72. A scanning pulse is applied to the scanning signal line SL2. A voltage of V0+5 volts (=5 volts) is applied to the common electrode line CL3 from the common electrode driving circuit 73 (i.e., a voltage at the common electrode line CL3 changes from −5 volts to 5 volts). In the second embodiment, unlike the first embodiment, a voltage applied to the common electrode line CL4 is also changed. More specifically, a voltage of V0−5 volts (=−5 volts) is applied to the common electrode line CL4 from the common electrode driving circuit 73 (i.e., a voltage at the common electrode line CL4 changes from 5 volts to −5 volts).

In the same manner as described above, in the period TeB, a voltage of 3 volts is applied to the first pixel electrode 20A and the second pixel electrode 20B in each of the unit display areas UA2_1 to UA2_4 in the second row by the scanning pulse of the scanning signal line SL2. The applied voltage is stored by the first storage capacitor 24 and the second storage capacitor 25 in each of the unit display areas UA even after the scanning pulse of the scanning signal line SL2 ends.

Period TeC

In the period TeC, a voltage of V0−3 volts (=−3 volts) is applied to the video signal lines VL1 to VL4 from the video signal driving circuit 72. A scanning pulse is applied to the scanning signal line SL3. A voltage of V0−5 volts (=−5 volts) is applied to the common electrode line CL5 from the common electrode driving circuit 73 (i.e., a voltage at the common electrode line CL5 changes from +5 volts to −5 volts). In the second embodiment, unlike the first embodiment, a voltage applied to the common electrode line CL6 is also changed. More specifically, a voltage of V0+5 volts (=5 volts) is applied to the common electrode line CL6 from the common electrode driving circuit 73 (i.e., a voltage at the common electrode line CL6 changes from −5 volts to 5 volts).

In the same manner as described above, in the period TeC, a voltage of −3 volts is applied to the first pixel electrode 20A and the second pixel electrode 20B in each of the unit display areas UA3_1 to UA3_4 in the third row by the scanning pulse of the scanning signal line SL3. The applied voltage is stored by the first storage capacitor 24 and the second storage capacitor 25 in each of the unit display areas UA even after the scanning pulse of the scanning signal line SL3 ends.

Period TeD

In the period TeD, a voltage of V0+3 volts (=3 volts) is applied to the video signal lines VL1 to VL4 from the video signal driving circuit 72. A scanning pulse is applied to the scanning signal line SL4. A voltage of V0+5 volts (=5 volts) is applied to the common electrode line CL7 from the common electrode driving circuit 73 (i.e., a voltage at the common electrode line CL7 changes from −5 volts to 5 volts). In the second embodiment, unlike the first embodiment, a voltage applied to the common electrode line CL8 is also changed. More specifically, a voltage of V0−5 volts (=−5 volts) is applied to the common electrode line CL8 from the common electrode driving circuit 73 (i.e., a voltage at the common electrode line CL8 changes from 5 volts to −5 volts).

In the same manner as described above, in the period TeD, a voltage of 3 volts is applied to the first pixel electrode 20A and the second pixel electrode 20B in each of the unit display areas UA4_1 to UA4_4 in the fourth row by the scanning pulse of the scanning signal line SL4. The applied voltage is stored by the first storage capacitor 24 and the second storage capacitor 25 in each of the unit display areas UA even after the scanning pulse of the scanning signal line SL4 ends.

According to the operations in the periods TeA to TeD explained above, the formation of an even number frame ends. As in the formation of an even number frame in the first embodiment shown in FIG. 9, at a point of the period TeE when the formation of an even number frame ends in the second embodiment, potential differences in the respective reflection areas and transmission areas are as follows:

a potential difference in the reflection area RA1_1: Vpx1_1−CL1=2 volts

a potential difference in the transmission area TA1_1: Vpx1_1−CL2=−8 volts

a potential difference in the reflection area RA2_1: Vpx2_1−CL3=−2 volts

a potential difference in the transmission area TA2_1: Vpx2_1−CL4=8 volts

a potential difference in the reflection area RA3_1: Vpx3_1−CL5=2 volts

a potential difference in the transmission area TA3_1: Vpx3_1−CL6=−8 volts

a potential difference in the reflection area RA4_1: Vpx4_1−CL7=−2 volts

a potential difference in the transmission area TA4_1: Vpx4_1−CL8=8 volts

Therefore, at the point when the formation of an even number frame ends, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

Formation of an odd number frame is explained. The formation of an odd number frame is started in the period ToA. A state before the period ToA is a state after formation of a preceding frame (i.e., an immediately preceding even number frame) ends. Basically, the state is the same as the state after the period TeE when the formation of an even number frame ends shown in FIG. 17.

Operations in the periods ToA to ToD are basically the same as those explained about the periods TeA to TeD. Since waveforms of voltages applied to the video signal lines VL1 to VL4 and the common electrode lines CL1 to CL8 only have to be inverted, explanation of the operations is omitted.

The formation of an odd number frame is finished by the operations in the periods ToA to ToD. As in the formation of an odd number frame in FIG. 9 in the first embodiment, at a point of the period ToE when the formation of an odd number frame ends in the second embodiment, potential differences in the respective reflection areas and transmission areas are as follows:

a potential difference in the reflection area RA1_1: Vpx1_1−CL1=−2 volts

a potential difference in the transmission area TA1_1: Vpx1_1−CL2=8 volts

a potential difference in the reflection area RA2_1: Vpx2_1−CL3=2 volts

a potential difference in the transmission area TA2_1: Vpx2_1−CL4=−8 volts

a potential difference in the reflection area RA3_1: Vpx3_1−CL5=−2 volts

a potential difference in the transmission area TA3_1: Vpx3_1−CL6=8 volts

a potential difference in the reflection area RA4_1: Vpx4_1−CL7=2 volts

a potential difference in the transmission area TA4_1: Vpx4_1−CL8=−8 volts

Polarities of the voltages are inverted from those in the even number frame. However, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

In the even number frame and the odd number frame, a relation between voltages applied to the first counter electrode 21 and the second counter electrode 22 is as explained in the first embodiment.

For example, when scanning by the first to Mth scanning signal lines SL for forming an even number frame is completed, in a certain unit display area UA, the first voltage applied to the first counter electrode 21 is represented as V1_evenF and the second voltage applied to the second counter electrode 22 is represented as V2_evenF. When scanning by the first to Mth scanning signal lines SL for forming an odd number frame is completed, in the unit display area UA, the first voltage applied to the first counter electrode 21 is represented as V1_oddF and the second voltage applied to the second counter electrode 22 is represented as V2_oddF. A relation V1_evenF−V2_evenF=−(V1_oddF−V2_oddF) is satisfied. In the liquid crystal display device 2 according to the second embodiment, a direction of an electric field applied to the liquid crystal layer 30 changes for each of frames. It is possible to prevent liquid crystals from being deteriorated when an electric field is applied in one direction for a long time. Polarities of voltage at pixel electrodes with respect to counter electrodes in the respective unit display areas UA are the same as those in FIGS. 11A and 11B in the first embodiment.

In this case, a relation V1_evenF=V2_oddF and V1_oddF=V2_evenF is satisfied. By satisfying this relation, as described later, fluctuation in the first voltage applied to the first counter electrode 21, the second voltage applied to the second counter electrode 22, and the third voltage applied to the first pixel electrode 20A or the second pixel electrode 20B can be reduced. Thus, it is possible to realize a reduction in power consumption of the liquid crystal display device.

Attention is paid to a relation at a point when scanning by the first to Mth scanning signal lines SL for forming a certain frame is completed. As in the first embodiment, in each of the unit display areas UA corresponding to the mth (m=1, 2, . . . , M) scanning signal line SLm, the first voltage V1_m is applied to the first counter electrode 21 and the second voltage V2_m is applied to the second counter electrode 22.

A relation that the voltage V1_m is a fixed value V1_odd when a value of m is an odd number and is a fixed value V1_even different from V1_odd when a value of m is an even number and the voltage V2_m is a fixed value V2_odd when a value of m is an odd number and is a fixed value V2_even different from V2-odd when a value of m is an even number is satisfied. In addition, a relation V1_odd=V2_even and V1_even=V2_odd is satisfied. In the liquid crystal display device 2 according to the second embodiment that satisfies these relations, polarities of applied voltages are inverted in the respective unit display areas UA corresponding to an odd number scanning signal line SL and the respective unit display areas UA corresponding to an even number scanning signal line SL. Consequently, flicker of a display image can be reduced.

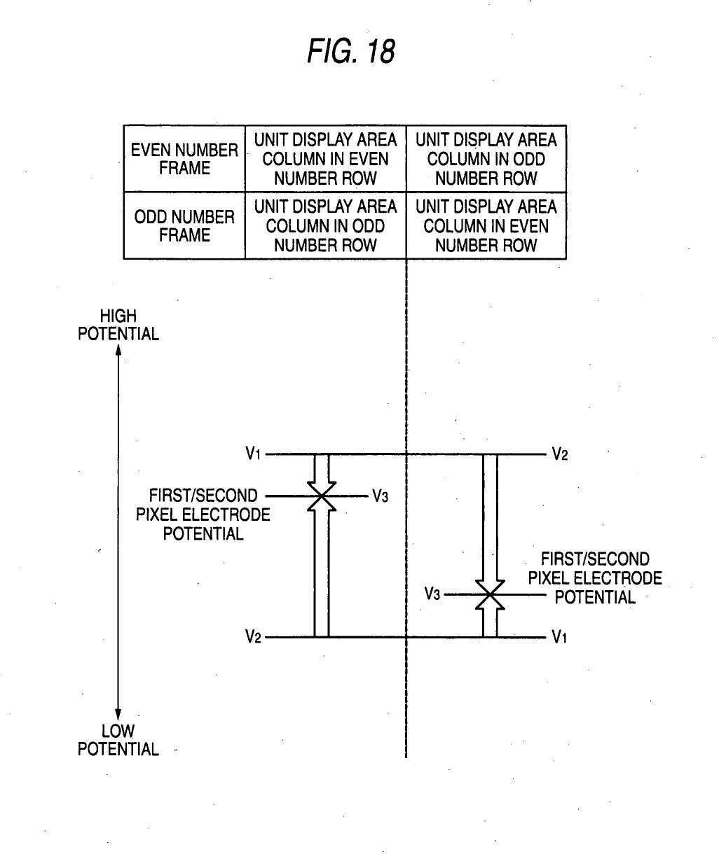

Moreover, in the liquid crystal display device 2 according to the second embodiment that satisfies the relations described above, when the liquid crystal display device is driven in the white display state, a voltage applied to the common electrode line CL is −5 volts/5 volts and a voltage applied to the video signal line VL is −3 volts/3 volts. On the other hand, in the first embodiment, when the liquid crystal display device 1 is driven in the white display state, a voltage applied to the common electrode line CL is −10 volts/10 volts and a voltage applied to the video signal line VL is −8 volts/8 volts. Therefore, in the liquid crystal display device 2 according to the second embodiment, fluctuation in the first voltage applied to the first counter electrode 21, the second voltage applied to the second counter electrode 22, and the third voltage applied to the first pixel electrode 20A or the second pixel electrode 20B can be reduced. Thus, it is possible to realize a reduction in power consumption of the liquid crystal display device. A relation among the first voltage V1, the second voltage V2, and the third voltage V3 in respective unit display areas UA in an odd number row and an even number of row is shown in FIG. 18.

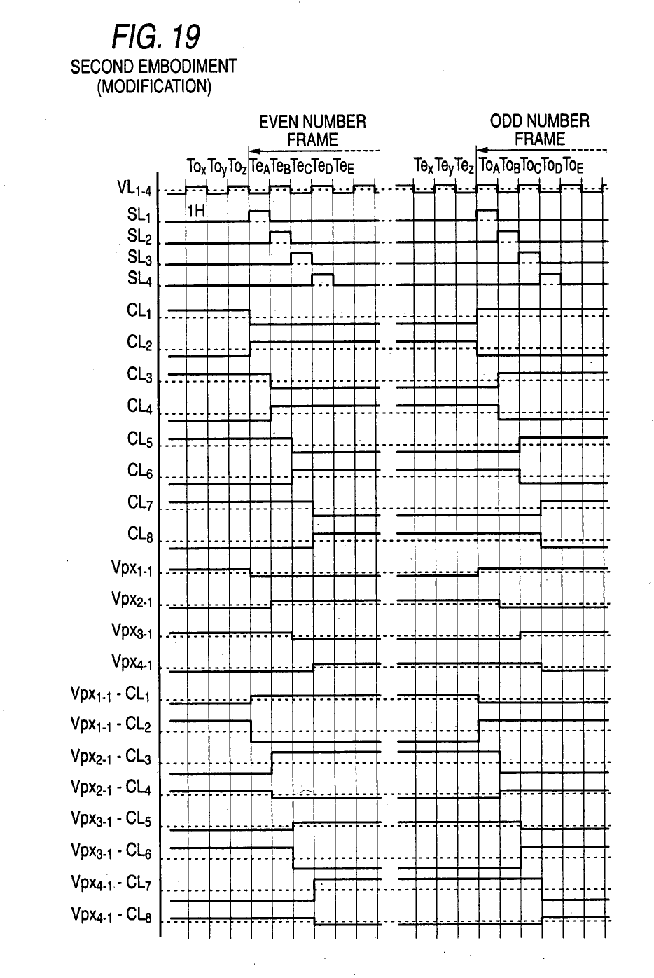

A modification of the second embodiment is briefly explained. In the modification of the second embodiment, operations same as the operations shown in FIG. 17 are performed in the structure in FIG. 13 explained as the modification of the first embodiment. FIG. 19 is a schematic timing chart of operations corresponding to the operations shown in FIG. 17 in the modification shown in FIG. 13. As in the explanation in the first embodiment, in this case, voltages applied to a part of the common electrode lines CL only have to be interchanged. Specifically, in FIG. 17, the waveform of the common electrode line CL3 and the waveform of the common electrode line CL4 only have to be interchanged and the waveform of the common electrode line CL7 and the waveform of the common electrode line CL8 only have to be interchanged (according to the interchange, the waveform of Vpx2_1−CL3 and the waveform of Vpx2_1−CL4 shown in FIG. 17 are interchanged and the waveform of Vpx4_1−CL7 and the waveform of Vpx4_1−CL8 shown in FIG. 17 are interchanged). In the modification, polarities of voltages at pixel electrodes with respect to counter electrodes in the respective unit display areas UA are the same as those in FIGS. 16A and 16B in the modification of the first embodiment.

### Third Embodiment

A third embodiment of the invention is also directed to a liquid crystal display device. The liquid crystal display device 3 according to the third embodiment of the invention is mainly different from the liquid crystal display device 1 according to the first embodiment in that the number of common electrode lines CL is reduced.

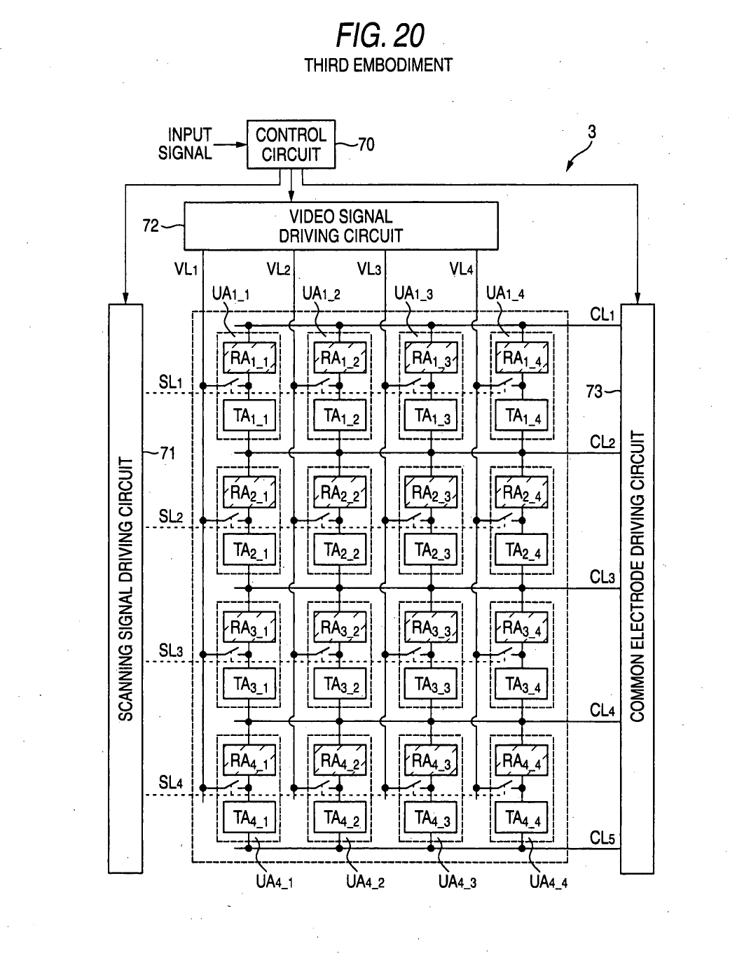

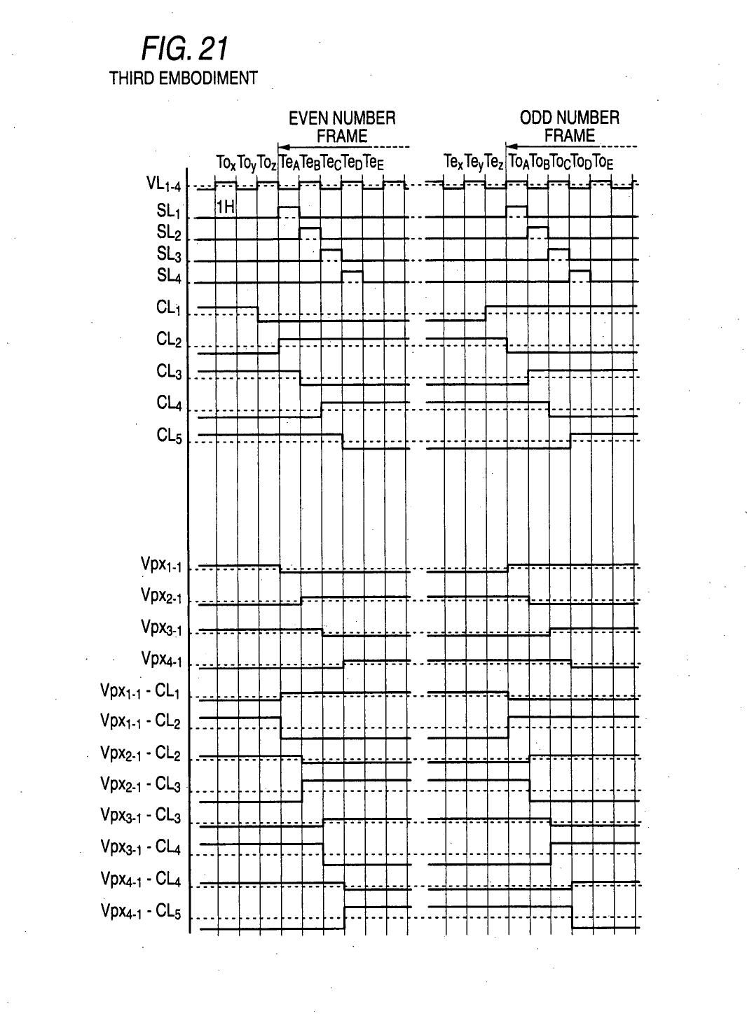

FIG. 20 is a schematic diagram of the liquid crystal display device 3 according to the third embodiment. FIG. 21 is a schematic timing chart of operations in a white display state of the liquid crystal display device 3 according to the third embodiment.

As shown in FIG. 20, the liquid crystal display device 3 according to the third embodiment includes P (P=M+1; in the example shown in FIG. 20, P=5 because M=4) common electrode lines CL. Any one of the first counter electrode 21 and the second counter electrode 22 in each of the unit display areas UA corresponding to an m′th (m′=p−1) scanning signal line SLm′ (in the example shown in FIG. 20, the second counter electrode 22 in the transmission area TA) and the other counter electrode of the first counter electrode 21 and the second counter electrode 22 in each of the unit display areas UA corresponding to an (m′+1)th scanning signal line SLm′+1 (in the example shown in FIG. 20, the first counter electrode 21 in the reflection area RA) are connected to a pth (p is a natural number equal to or larger than 2 and equal to or smaller than M−1) common electrode line CLp.

The electrode not connected to a second common electrode line SL2 of the first counter electrode 21 and the second counter electrode 22 in each of the unit display areas UA corresponding to a first scanning signal line SL1 (in the example shown in FIG. 20, the first counter electrode 21 in the reflection area RA) and a first common electrode line CL1 are connected.

The electrode not connected to a (P−1)th (in the example shown in FIG. 20, P−1=4) common electrode line CLP-1 of the first counter electrode 21 and the second counter electrode 22 in each of the unit display areas UA corresponding to an Mth (in the example shown in FIG. 20, M=4) scanning signal line SLM (in the example shown in FIG. 20, the second counter electrode 22 in the transmission area TA) and a Pth (in the example shown in FIG. 20, P=5) common electrode line CLP are connected. The first voltage is applied to the first counter electrode 21 via the common electrode line CL connected to the first counter electrode 21. The second voltage is applied to the second counter electrode 22 via the common electrode line CL connected to the second counter electrode 22. Consequently, the common first voltage is applied to the first counter electrodes 21 in the unit display areas UA in the respective rows and the common second voltage is applied to the second counter electrodes 22 in the unit display areas UA.

In the liquid crystal display device 3 according to the third embodiment, compared with the liquid crystal display device 1 according to the first embodiment shown in FIG. 8, the number of common electrode lines CL located between the unit display areas UA1_1 to UA1_4 in the first row and the unit display areas UA2_1 to UA2_4 in the second row is reduced by one. The common electrode lines located between the second row and the third row and between the third row and the fourth row are also reduced by one, respectively. Both the first counter electrode 21 and the second counter electrode 22 are connected to the common electrode lines CL2 to CL4 shown in FIG. 20. Therefore, a voltage applied to these common electrode lines CL is the “first voltage” for the first counter electrode 21 and is the “second voltage” for the second counter electrode 22. The same holds true in the other embodiments described later.

In the liquid crystal display device 3 according to the third embodiment, for example, the second counter electrodes 22 provided in the transmission areas TA of the unit display areas UA1_1 to UA1_4 in the first row and the first counter electrodes 21 provided in the reflection areas RA of the unit display areas UA2_1 to US2_4 in the second row are connected to the common electrode line CL2. When a voltage is applied to the unit display areas UA in the first row from the video signal lines VL, voltages at the common electrode lines CL1 and CL2 need to be decided. When a voltage is applied to the unit display areas UA in the second row from the video signal lines VL, voltages at the common electrode lines CL2 and CL3 need to be decided. Therefore, for example, when scanning of the unit display areas UA in the second row is performed after scanning of the unit display areas UA in the first row, it is necessary to switch a voltage applied to the common electrode line CL2 with respect to the scanning of the unit display areas UA in the first row. The same holds true in the common electrode lines CL3 and CL4 and in the other embodiments described later.

In FIG. 21, “Vpx1_1−CL1” corresponds to a potential difference between the first pixel electrode 20A and the first counter electrode 21 corresponding to the unit display area UA1_1. “Vpx1_1−CL2” corresponds to a potential difference between the second pixel electrode 20B and the second counter electrode 22 corresponding to the unit display area UA1_1. The same holds true for “Vpx2_1−CL2” to “Vpx4_1−CL5”.

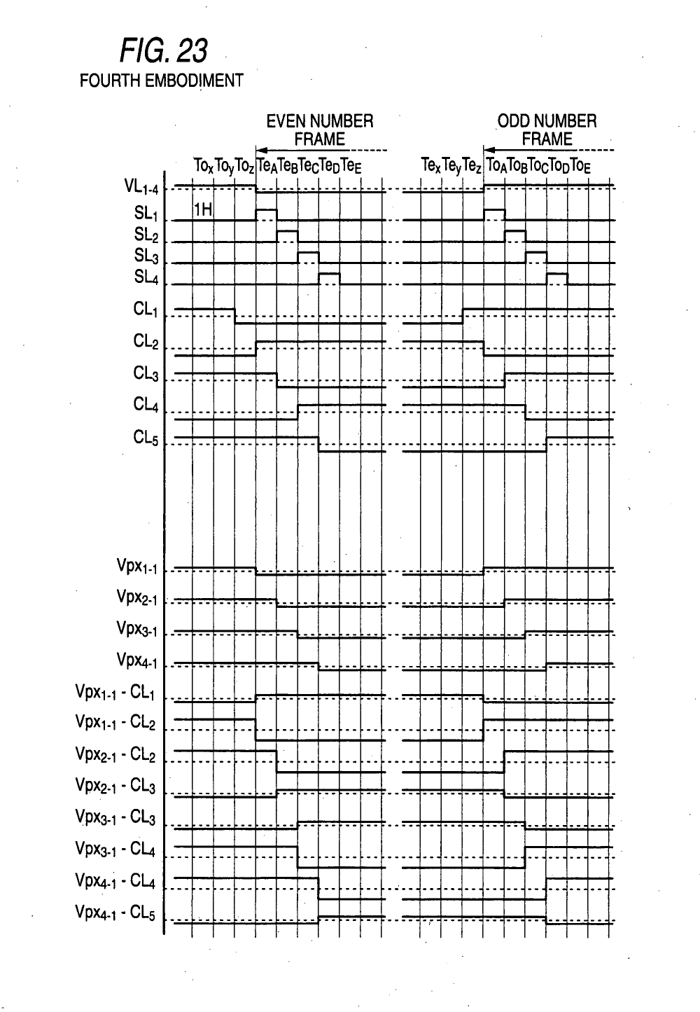

Specifically, waveforms indicated by “Vpx1_1−CL1” to “Vpx4_1−CL5” represent waveforms of potential differences between pixel electrodes and counter electrodes in a reflection area RA1_1, a transmission area TA1_1, a reflection area RA2_1, a transmission area TA2_1, a reflection area RA3_1, a transmission area TA3_1, a reflection area RA4_1, and a transmission area TA4_1 forming a first unit display area column shown in FIG. 20, respectively. In the example shown in FIG. 21, voltages applied to the video signal lines VL1 to VL4 are set to the same value. Thus, the waveforms substantially correspond to a potential difference between the first pixel electrode 20A and the first counter electrode 21 provided in the reflection area RA in the unit display area UA in each of the rows and a potential difference between the second pixel electrode 20B and the second counter electrode 22 provided in the transmission area TA. The same holds true in FIG. 23 in the fourth embodiment described later.

Operations in the white display state of the liquid crystal display device 3 according to the third embodiment are explained with reference to FIG. 21.

As in the other embodiments described above, in FIG. 21, formation of an even number frame is started in a period TeA. A state before the period TeA is a state after formation of a preceding frame (i.e., an immediately preceding odd number frame) ends. Basically, the state is the same as a state after a period ToE when formation of an odd number frame shown in FIG. 21 ends.

Before a Period ToY

In this state, when a voltage of a certain fixed value is represented as V0, a voltage of V0+5 volts (=5 volt) is applied to the common electrode lines CL1, CL3, and CL5 and a voltage of V0−5 volts (=−5 volts) is applied to the common electrode lines CL2 and CL4 from the common electrode driving circuit 73. Values of Vpx1_1 to Vpx4_1 are values of voltages applied via the video signal lines VL1 and stored by the first storage capacitor 24 and the second storage capacitor 25 during formation of an immediately preceding odd number frame. As in FIG. 17 in the second embodiment, values of Vpx1_1 and Vpx3_1 are V0+3 volts (=3 volts) and values of Vpx2_1 and Vpx4_1 are V0−3 volts (=−3 volts).

Period ToZ

In the period ToZ, a voltage of V0−5 volts (=−5 volts) is applied to the common electrode line CL1 from the common electrode driving circuit 73 (i.e., a voltage at the common electrode line CL1 changes from +5 volts to −5 volts). The voltage at the common electrode line CL1 is changed in the period ToZ because voltages at the common electrode lines CL2 to CL5 are changed every 1H in the periods TeA to TeD. The same holds true in the fourth and fifth embodiments described later.

Period TeA

In the period TeA, a voltage of V0−3 volts (=−3 volts) is applied to the video signal lines VL1 to VL4 from the video signal driving circuit 72. A scanning pulse is applied to the scanning signal line SL1. A voltage of V0+5 volts (=5 volts) is applied to the common electrode line CL2 from the common electrode driving circuit 73 (i.e., a voltage at the common electrode line CL2 changes from −5 volts to 5 volts).

As explained in the first embodiment, in the period TeA, a voltage of −3 volts is applied to the first pixel electrode 20A and the second pixel electrode 20B in each of the unit display areas UA1_1 to UA1_4 in the first row by the scanning pulse of the scanning signal line SL1. The applied voltage is stored by the first storage capacitor 24 and the second storage capacitor 25 in each of the unit display areas UA even after the scanning pulse of the scanning signal line SL1 ends.

Period TeB

In the period TeB, a voltage of V0+3 volts (=3 volts) is applied to the video signal lines VL1 to VL4 from the video signal driving circuit 72. A scanning pulse is applied to the scanning signal line SL2. A voltage of V0−5 volts (=−5 volts) is applied to the common electrode line CL3 from the common electrode driving circuit 73 (i.e., a voltage at the common electrode line CL3 changes from 5 volts to −5 volts).

As described above, in the period TeB, a voltage of 3 volts is applied to the first pixel electrode 20A and the second pixel electrode 20B in each of the unit display areas UA2_1 to UA2_4 in the second row by the scanning pulse of the scanning signal line SL2. The applied voltage is stored by the first storage capacitor 24 and the second storage capacitor 25 in each of the unit display areas UA even after the scanning pulse of the scanning signal line SL2 ends.

Period TeC

In the period TeC, a voltage of V0−3 volts (=−3 volts) is applied to the video signal lines VL1 to VL4 from the video signal driving circuit 72. A scanning pulse is applied to the scanning signal line SL3. A voltage of V0+5 volts (=5 volts) is applied to the common electrode line CL4 from the common electrode driving circuit 73 (i.e., a voltage at the common electrode line CL4 changes from −5 volts to +5 volts).

As described above, in the period TeC, a voltage of −3 volts is applied to the first pixel electrode 20A and the second pixel electrode 20B in each of the unit display areas UA3_1 to UA3_4 in the third row by the scanning pulse of the scanning signal line SL3. The applied voltage is stored by the first storage capacitor 24 and the second storage capacitor 25 in each of the unit display areas UA even after the scanning pulse of the scanning signal line SL3 ends.

Period TeD

In the period TeD, a voltage of V0+3 volts (=3 volts) is applied to the video signal lines VL1 to VL4 from the video signal driving circuit 72. A scanning pulse is applied to the scanning signal line SL4. A voltage of V0−5 volts (=−5 volts) is applied to the common electrode line CL5 from the common electrode driving circuit 73 (i.e., a voltage at the common electrode line CL5 changes from 5 volts to −5 volts).

As described above, in the period TeD, a voltage of 3 volts is applied to the first pixel electrode 20A and the second pixel electrode 20B in each of the unit display areas UA4_1 to UA4_4 in the fourth row by the scanning pulse of the scanning signal line SL4. The applied voltage is stored by the first storage capacitor 24 and the second storage capacitor 25 in each of the unit display areas UA even after the scanning pulse of the scanning signal line SL4 ends.

According to the operations in the periods TeA to TeD explained above, the formation of an even number frame ends. As in the formation of an even number frame in the first embodiment shown in FIG. 9, at a point of the period TeE when the formation of an even number frame ends in the third embodiment, potential differences in the respective reflection areas and transmission areas are as follows:

a potential difference in the reflection area RA1_1: Vpx1_1−CL1=2 volts

a potential difference in the transmission area TA1_1: Vpx1_1−CL2=−8 volts

a potential difference in the reflection area RA2_1: Vpx2_1−CL2=−2 volts

a potential difference in the transmission area TA2_1: Vpx2_1−CL3=8 volts

a potential difference in the reflection area RA3_1: Vpx3_1−CL3=2 volts

a potential difference in the transmission area TA3_1: Vpx3_1−CL4=−8 volts

a potential difference in the reflection area RA4_1: Vpx4_1−CL4=−2 volts

a potential difference in the transmission area TA4_1: Vpx4_1−CL5=8 volts

Therefore, at the point when the formation of an even number frame ends, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

Formation of an odd number frame is explained. The formation of an odd number frame is started in the period ToA. A state before the period ToA is a state after formation of a preceding frame (i.e., an immediately preceding even number frame) ends. Basically, the state is the same as the state after the period TeE when the formation of an even number frame ends shown in FIG. 21.

Operations in the periods ToA to ToD are basically the same as those explained about the periods TeA to TeD. Since waveforms of voltages applied to the video signal lines VL1 to VL4 and the common electrode lines CL1 to CL5 only have to be inverted, explanation of the operations is omitted.

The formation of an odd number frame is finished by the operations in the periods ToA to ToD. As in the formation of an odd number frame in FIG. 9 in the first embodiment, at a point of the period ToE when the formation of an odd number frame ends in the third embodiment, potential differences in the respective reflection areas and transmission areas are as follows:

a potential difference in the reflection area RA1_1: Vpx1_1−CL1=−2 volts

a potential difference in the transmission area TA1_1: Vpx1_1−CL2=8 volts

a potential difference in the reflection area RA2_1: Vpx2_1−CL2=2 volts

a potential difference in the transmission area TA2_1: Vpx2_1−CL3=−8 volts

a potential difference in the reflection area RA3_1:

Vpx3_−CL3=−2 volts

a potential difference in the transmission area TA3_1: Vpx3_1−CL4=8 volts

a potential difference in the reflection area RA4_1: Vpx4_1−CL4=2 volts

a potential difference in the transmission area TA4_1: Vpx4_1−CL5=−8 volts

Polarities of the voltages are inverted from those in the even number frame. However, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

In the even number frame and the odd number frame, a relation between voltages applied to the first counter electrode 21 and the second counter electrode 22 is as explained in the first embodiment.

Specifically, in the even number frame and the odd number frame, a relation between voltages applied to the first counter electrode 21 and the second counter electrode 22 is as described below. For example, when scanning by the first to Mth scanning signal lines SL for forming an even number frame is completed, in a certain unit display area UA, the first voltage applied to the first counter electrode 21 is represented as V1_evenF and the second voltage applied to the second counter electrode 22 is represented as V2_evenF. When scanning by the first to Mth scanning signal lines SL for forming an odd number frame is completed, in the unit display area UA, the first voltage applied to the first counter electrode 21 is represented as V1_oddF and the second voltage applied to the second counter electrode 22 is represented as V2_oddF. A relation V1_evenF−V2_evenF=−(V1_oddF−V2_oddF) is satisfied. In the liquid crystal display device 3 according to the third embodiment, a direction of an electric field applied to the liquid crystal layer 30 changes for each of frames. It is possible to prevent liquid crystals from being deteriorated when an electric field is applied in one direction for a long time. Polarities of voltage at pixel electrodes with respect to counter electrodes in the respective unit display areas UA are the same as those in FIGS. 11A and 11B in the first embodiment.

In this case, a relation V1_evenF=V2_oddF and V1_oddF=V2_evenF is satisfied. By satisfying this relation, as in the second embodiment, fluctuation in the first voltage applied to the first counter electrode 21, the second voltage applied to the second counter electrode 22, and the third voltage applied to the first pixel electrode 20A or the second pixel electrode 20B can be reduced. Thus, it is possible to realize a reduction in power consumption of the liquid crystal display device.

Attention is paid to a relation at a point when scanning by the first to Mth scanning signal lines SL for forming a certain frame is completed. As in the first embodiment, in each of the unit display areas UA corresponding to the mth (m=1, 2, . . . , M) scanning signal line SLm, the first voltage V1_m is applied to the first counter electrode 21 and the second voltage V2_m is applied to the second counter electrode 22. As in the second embodiment, a relation that the voltage V1_m is a fixed value V1_odd when a value of m is an odd number and is a fixed value V1_even different from V1_odd when a value of m is an even number and the voltage V2_m is a fixed value V2_odd when a value of m is an odd number and is a fixed value V2_even different from V2_odd when a value of m is an even number is satisfied. In addition, a relation V1_odd=V2_even and V1_even=V2_odd is satisfied. In the liquid crystal display device 3 according to the third embodiment that satisfies these relations, polarities of applied voltages are inverted in the respective unit display areas UA corresponding to an odd number scanning signal line SL and the respective unit display areas UA corresponding to an even number scanning signal line SL. Consequently, flicker of a display image can be reduced. A relation among the first voltage V1, the second voltage V2, and the third voltage V3 in respective unit display areas UA in an odd number row and an even number of row is the same as that shown in FIG. 18 in the second embodiment.

In the liquid crystal display device 3 according to the third embodiment that satisfies the relations described above, when the liquid crystal display device is driven in the white display state, a voltage applied to the common electrode line CL is −5 volts/5 volts and a voltage applied to the video signal line VL is −3 volts/3 volts, as in the second embodiment. Therefore, in the liquid crystal display device 3 according to the third embodiment, fluctuation in the first voltage applied to the first counter electrode 21, the second voltage applied to the second counter electrode 22, and the third voltage applied to the first pixel electrode 20A or the second pixel electrode 20B can be reduced. Moreover, the number of common electrode lines can be reduced.

### Fourth Embodiment

A liquid crystal display device 4 according to a fourth embodiment of the invention is mainly different from the liquid crystal display device 3 according to the third embodiment in that only same kinds of pixel electrodes are connected to respective common electrode lines.

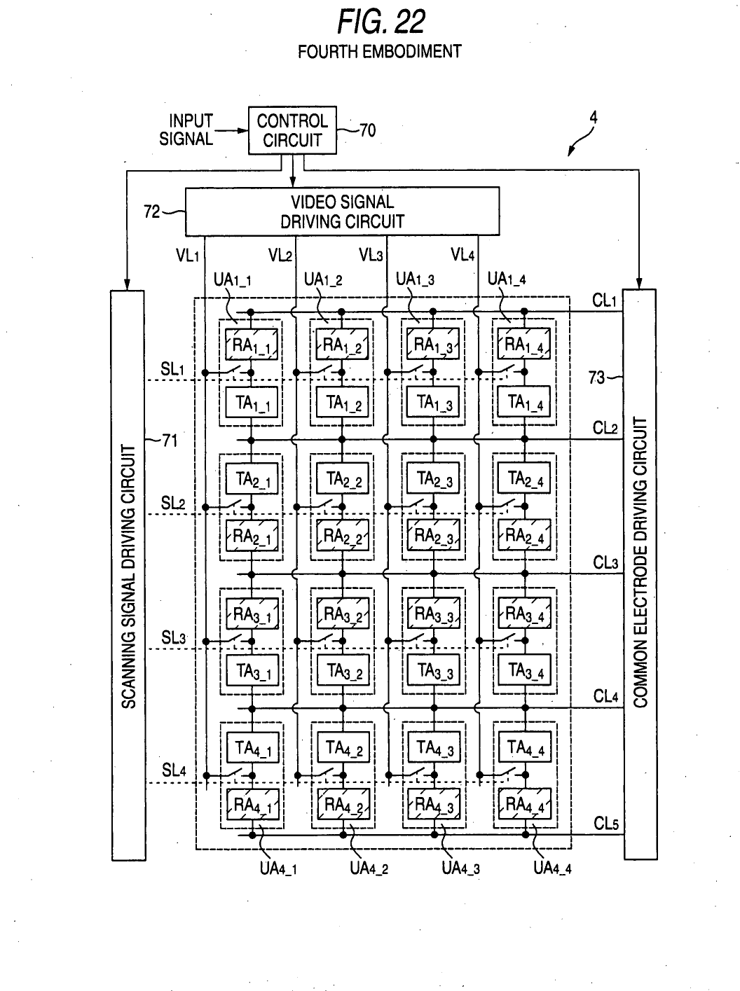

FIG. 22 is a schematic diagram of the liquid crystal display device 4 according to the fourth embodiment. FIG. 23 is a schematic timing chart of operations in a white display state of the liquid crystal display device 4 according to the fourth embodiment.

As shown in FIG. 22, the liquid crystal display device 4 according to the fourth embodiment includes P (P=M+1; in the example shown in FIG. 22, P=5 because M=4) common electrode lines CL. Any one of the first counter electrode 21 and the second counter electrode 22 in each of the unit display areas UA corresponding to m′th (m′=p−1) and (m′+1)th scanning signal lines SLm′ and SLm′+1 are connected to a pth (p is a natural number equal to or larger than 2 and equal to or smaller than M) common electrode line CLp. In the example shown in FIG. 22, the second counter electrode 22 in the transmission area TA is connected to the common electrode line CL2, the first counter electrode 21 in the reflection area RA is connected to the common electrode line CL3, and the second counter electrode 22 in the transmission area TA is connected to the common electrode line CL4.

The electrode not connected to a second common electrode line SL2 of the first counter electrode 21 and the second counter electrode 22 in each of the unit display areas UA corresponding to a first scanning signal line SL1 (in the example shown in FIG. 22, the first counter electrode 21 in the reflection area RA) and a first common electrode line CL1 are connected.

The electrode not connected to a (P−1)th (in the example shown in FIG. 22, P−1=4) common electrode line CLP-1 of the first counter electrode 21 and the second counter electrode 22 in each of the unit display areas UA corresponding to an Mth (in the example shown in FIG. 22, M=4) scanning signal line SLM (in the example shown in FIG. 22, the first counter electrode 21 in the reflection area RA) and a Pth (in the example shown in FIG. 22, P=5) common electrode line CLP are connected.

The first voltage is applied to the first counter electrode 21 via the common electrode line CL connected to the first counter electrode 21. The second voltage is applied to the second counter electrode 22 via the common electrode line CL connected to the second counter electrode 22. Consequently, the common first voltage is applied to the first counter electrodes 21 in the unit display areas UA in the respective rows and the common second voltage is applied to the second counter electrodes 22 in the unit display areas UA.

As shown in FIG. 22, in the liquid crystal display device 4 according to the fourth embodiment, the unit display areas UA are arranged such that the reflection areas RA or the transmission areas TA are opposed to each other across the common electrode line CL.

In FIG. 23, “Vpx1_1−CL1” corresponds to a potential difference between the first pixel electrode 20A and the first counter electrode 21 corresponding to the unit display area UA1_1. “Vpx1_1−CL2” corresponds to a potential difference between the second pixel electrode 20B and the second counter electrode 22 corresponding to the unit display area UA1_1. Similarly, “Vpx2_1−CL2” corresponds to a potential difference between the second pixel electrode 20B and the second counter electrode 22 corresponding to the unit display area UA2_1. “Vpx2_1−CL3” corresponds to a potential difference between the first pixel electrode 20A and the first counter electrode 21 corresponding to the unit display area UA2_1. The same holds true for “Vpx3_−CL3” to “Vpx4_1−CL5”.

Specifically, waveforms indicated by “Vpx1_1−CL1” to “Vpx4_1−CL5” represent waveforms of potential differences between pixel electrodes and counter electrodes in a reflection area RA1_1, a transmission area TA1_1, a transmission area TA2_1, a reflection area RA2_1, a reflection area RA3_1, a transmission area TA3_1, a transmission area TA4_1, and a reflection area RA 4_1 forming a first unit display area column shown in FIG. 22, respectively (note that correspondence among the reflection areas RA and the transmission area TA is partially interchanged compared with those in the first embodiment (excluding the modification), the second embodiment (excluding the modification), and the third embodiment).

Operations in the white display state of the liquid crystal display device 4 according to the fourth embodiment are explained with reference to FIG. 23.

As in the other embodiments described above, in FIG. 23, formation of an even number frame is started in a period TeA. A state before the period TeA is a state after formation of a preceding frame (i.e., an immediately preceding odd number frame) ends. Basically, the state is the same as a state after a period ToE when formation of an odd number frame shown in FIG. 23 ends. In the liquid crystal display device 4 according to the fourth embodiment, a video signal inverted for each of frames is applied to the video signal line VL.

Before a Period ToY

In this state, when a voltage of a certain fixed value is represented as V0, a voltage of V0+5 volts (=5 volt) is applied to the common electrode lines CL1, CL3, and CL5 and a voltage of V0−5 volts (=−5 volts) is applied to the common electrode lines CL2 and CL4 from the common electrode driving circuit 73. Values of Vpx1_1 to Vpx4_1 are values of voltages applied via the video signal lines VL1 and stored by the first storage capacitor 24 and the second storage capacitor 25 during formation of an immediately preceding odd number frame. Values of Vpx1_1, Vpx2_1, Vpx3_1, and Vpx4_1 are V0+3 volts (=3 volts).

Period ToZ

In the period ToZ, a voltage of V0−5 volts (=−5 volts) is applied to the common electrode line CL1 from the common electrode driving circuit 73 (i.e., a voltage at the common electrode line CL1 changes from +5 volts to −5 volts).

Period TeA

In the period TeA, a voltage of V0−3 volts (=−3 volts) is applied to the video signal lines VL1 to VL4 from the video signal driving circuit 72. A scanning pulse is applied to the scanning signal line SL1. A voltage of V0+5 volts (=5 volts) is applied to the common electrode line CL2 from the common electrode driving circuit 73 (i.e., a voltage at the common electrode line CL2 changes from −5 volts to 5 volts).

In the period TeA, a voltage of −3 volts is applied to the first pixel electrode 20A and the second pixel electrode 20B in each of the unit display areas UA1_1 to UA1_4 in the first row by the scanning pulse of the scanning signal line SL1. The applied voltage is stored by the first storage capacitor 24 and the second storage capacitor 25 in each of the unit display areas UA even after the scanning pulse of the scanning signal line SL1 ends.

Period TeB

In the period TeB, a voltage of V0−3 volts (=−3 volts) is applied to the video signal lines VL1 to VL4 from the video signal driving circuit 72. A scanning pulse is applied to the scanning signal line SL2. A voltage of V0−5 volts (=−5 volts) is applied to the common electrode line CL3 from the common electrode driving circuit 73 (i.e., a voltage at the common electrode line CL3 changes from 5 volts to −5 volts).

In the period TeB, a voltage of −3 volts is applied to the first pixel electrode 20A and the second pixel electrode 20B in each of the unit display areas UA2_1 to UA2_4 in the second row by the scanning pulse of the scanning signal line SL2. The applied voltage is stored by the first storage capacitor 24 and the second storage capacitor 25 in each of the unit display areas UA even after the scanning pulse of the scanning signal line SL2 ends.

Period TeC

In the period TeC, a voltage of V0−3 volts (=−3 volts) is applied to the video signal lines VL1 to VL4 from the video signal driving circuit 72. A scanning pulse is applied to the scanning signal line SL3. A voltage of V0+5 volts (=5 volts) is applied to the common electrode line CL4 from the common electrode driving circuit 73 (i.e., a voltage at the common electrode line CL4 changes from −5 volts to +5 volts).

As described above, in the period TeC, a voltage of −3 volts is applied to the first pixel electrode 20A and the second pixel electrode 20B in each of the unit display areas UA3_1 to UA3_4 in the third row by the scanning pulse of the scanning signal line SL3. The applied voltage is stored by the first storage capacitor 24 and the second storage capacitor 25 in each of the unit display areas UA even after the scanning pulse of the scanning signal line SL3 ends.

Period TeD

In the period TeD, a voltage of V0−3 volts (=−3 volts) is applied to the video signal lines VL1 to VL4 from the video signal driving circuit 72. A scanning pulse is applied to the scanning signal line SL4. A voltage of V0−5 volts (=−5 volts) is applied to the common electrode line CL5 from the common electrode driving circuit 73 (i.e., a voltage at the common electrode line CL5 changes from 5 volts to −5 volts).

In the period TeD, a voltage of −3 volts is applied to the first pixel electrode 20A and the second pixel electrode 20B in each of the unit display areas UA4_1 to UA4_4 in the fourth row by the scanning pulse of the scanning signal line SL4. The applied voltage is stored by the first storage capacitor 24 and the second storage capacitor 25 in each of the unit display areas UA even after the scanning pulse of the scanning signal line SL4 ends.

According to the operations in the periods TeA to TeD explained above, the formation of an even number frame ends. At a point of the period TeE when the formation of an even number frame ends, potential differences in the respective reflection areas and transmission areas are as follows:

a potential difference in the reflection area RA1_1: Vpx1_−CL1=2 volts

a potential difference in the transmission area TA1_1: Vpx1_−CL2=−8 volts

a potential difference in the reflection area RA2_1: Vpx2_−CL2=−8 volts

a potential difference in the transmission area TA2_1: Vpx2_1−CL3=2 volts

a potential difference in the reflection area RA3_1: Vpx3_1−CL3=2 volts

a potential difference in the transmission area TA3_1: Vpx3_1−CL4=−8 volts

a potential difference in the reflection area RA4_1: Vpx4_1−CL4=−8 volts

a potential difference in the transmission area TA4_1: Vpx4_1−CL5=2 volts

Therefore, at the point when the formation of an even number frame ends, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

Formation of an odd number frame is explained. The formation of an odd number frame is started in the period ToA. A state before the period ToA is a state after formation of a preceding frame (i.e., an immediately preceding even number frame) ends. Basically, the state is the same as the state after the period TeE when the formation of an even number frame ends shown in FIG. 23.

Operations in the periods ToA to ToD are basically the same as those explained about the periods TeA to TeD. Since waveforms of voltages applied to the video signal lines VL1 to VL4 and the common electrode lines CL1 to CL5 only have to be inverted, explanation of the operations is omitted.

The formation of an odd number frame is finished by the operations in the periods ToA to ToD. At a point of the period ToE when the formation of an odd number frame ends, potential differences in the respective reflection areas and transmission areas are as follows:

a potential difference in the reflection area RA1_1: Vpx1_1−CL1=−2 volts

a potential difference in the transmission area TA1_1: Vpx1_−CL2=8 volts

a potential difference in the reflection area RA2_1: Vpx2_−CL2=8 volts

a potential difference in the transmission area TA2_1: Vpx2_1−CL3=−2 volts

a potential difference in the reflection area RA3_1: Vpx3_1−CL3=−2 volts

a potential difference in the transmission area TA3_1: Vpx3_−CL4=8 volts

a potential difference in the reflection area RA4_1: Vpx4_−CL4=8 volts

a potential difference in the transmission area TA4_1: Vpx4_1−CL5=−2 volts

Polarities of the voltages are inverted from those in the even number frame. However, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

In the even number frame and the odd number frame, a relation between voltages applied to the first counter electrode 21 and the second counter electrode 22 is as explained in the first embodiment.

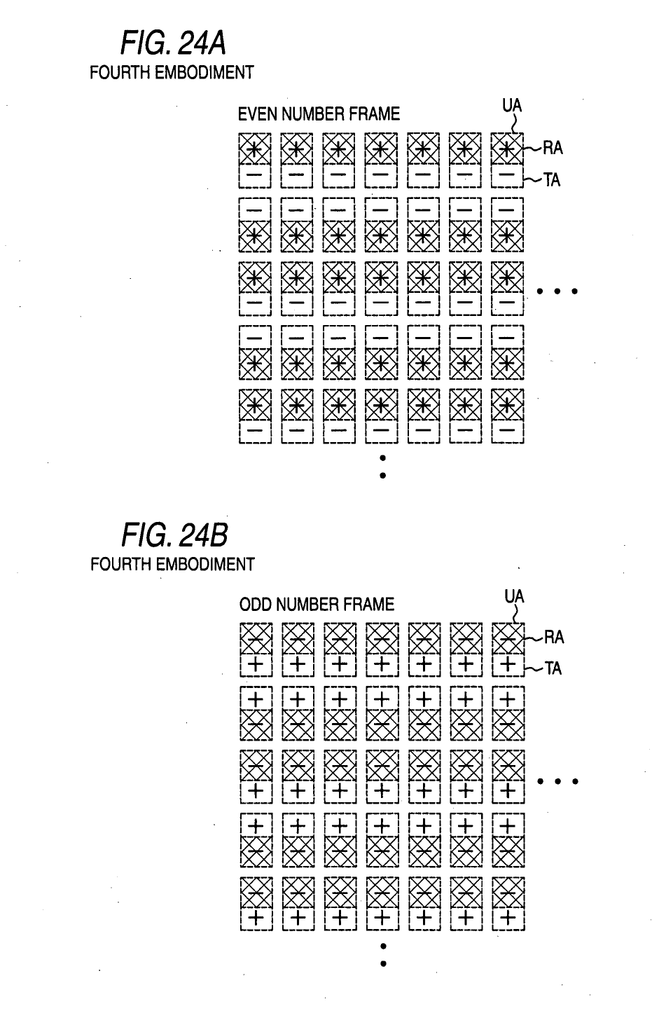

Specifically, in the even number frame and the odd number frame, a relation between voltages applied to the first counter electrode 21 and the second counter electrode 22 is as described below. For example, when scanning by the first to Mth scanning signal lines SL for forming an even number frame is completed, in a certain unit display area UA, the first voltage applied to the first counter electrode 21 is represented as V1_evenF and the second voltage applied to the second counter electrode 22 is represented as V2_evenF. When scanning by the first to Mth scanning signal lines SL for forming an odd number frame is completed, in the unit display area UA, the first voltage applied to the first counter electrode 21 is represented as V1_oddF and the second voltage applied to the second counter electrode 22 is represented as V2_oddF. A relation V1_evenF−V2_evenF=−(V1_oddF−V2_oddF) is satisfied. In the liquid crystal display device 4 according to the fourth embodiment, as in the embodiments described above, a direction of an electric field applied to the liquid crystal layer 30 changes for each of frames. It is possible to prevent liquid crystals from being deteriorated when an electric field is applied in one direction for a long time. Polarities of voltages at pixel electrodes with respect to counter electrodes in the respective unit display areas UA in an even number of frame are shown in FIG. 24A. Polarities of voltages at pixel electrodes with respect to counter electrodes in the respective unit display areas UA in an odd number frame is shown in FIG. 24B.

In this case, a relation V1_evenF=V2_oddF and V1_oddF=V2_evenF is satisfied. By satisfying this relation, as described later, fluctuation in the first voltage applied to the first counter electrode 21, the second voltage applied to the second counter electrode 22, and the third voltage applied to the first pixel electrode 20A or the second pixel electrode 20B can be reduced. Thus, it is possible to realize a reduction in power consumption of the liquid crystal display device.

Attention is paid to a relation at a point when scanning by the first to Mth scanning signal lines SL for forming a certain frame is completed. As in the first embodiment, in each of the unit display areas UA corresponding to the mth (m=1, 2, . . . , M) scanning signal line SLm, the first voltage V1_m is applied to the first counter electrode 21 and the second voltage V2_m is applied to the second counter electrode 22. A relation that the voltage V2_m is a fixed value V2_const and the voltage V1_m is a fixed value V1_const different from V2_const is satisfied. Therefore, polarities of voltages applied to the respective unit display areas UA are inverted for each of frames and flicker of a display image can be reduced.

In the liquid crystal display device 4 according to the fourth embodiment that satisfies the relations described above, as in the second or third embodiment, when the liquid crystal display device is driven in the white display state, a voltage applied to the common electrode line CL is −5 volts/5 volts and a voltage applied to the video signal line VL is −3 volts/3 volts.

Therefore, in the liquid crystal display device 4 according to the fourth embodiment, fluctuation in the first voltage applied to the first counter electrode 21, the second voltage applied to the second counter electrode 22, and the third voltage applied to the first pixel electrode 20A or the second pixel electrode 20B can be reduced. Moreover, the number of common electrode lines can be reduced. In an area in which the reflection areas RA are opposed to each other, as explained in the modification of the first embodiment, reflectors and the like provided in the reflection areas RA can be continuously formed to extend over a plurality of the unit display areas UA. The same holds true for various components formed in the transmission areas. Therefore, a dividing process and the like for the reflectors and the like are unnecessary and it is possible to further increase a margin in the structure of the liquid crystal display device.

### Fifth Embodiment

A liquid crystal display device 5 according to a fifth embodiment of the invention is mainly different from the liquid crystal display device 3 according to the third embodiment in that the respective common electrode lines CL are connected in a zigzag shape.

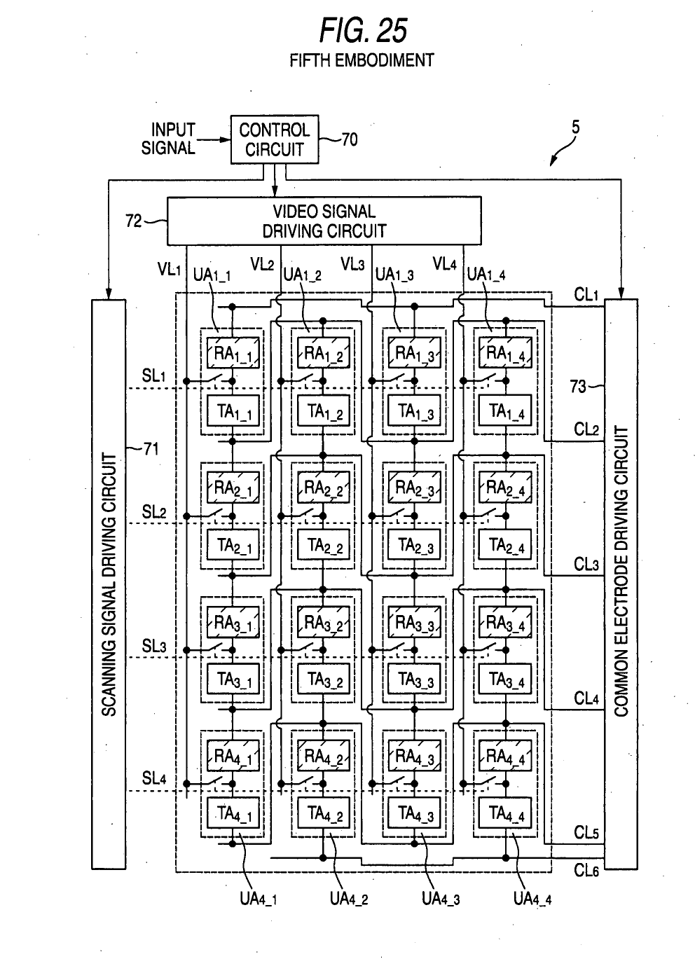

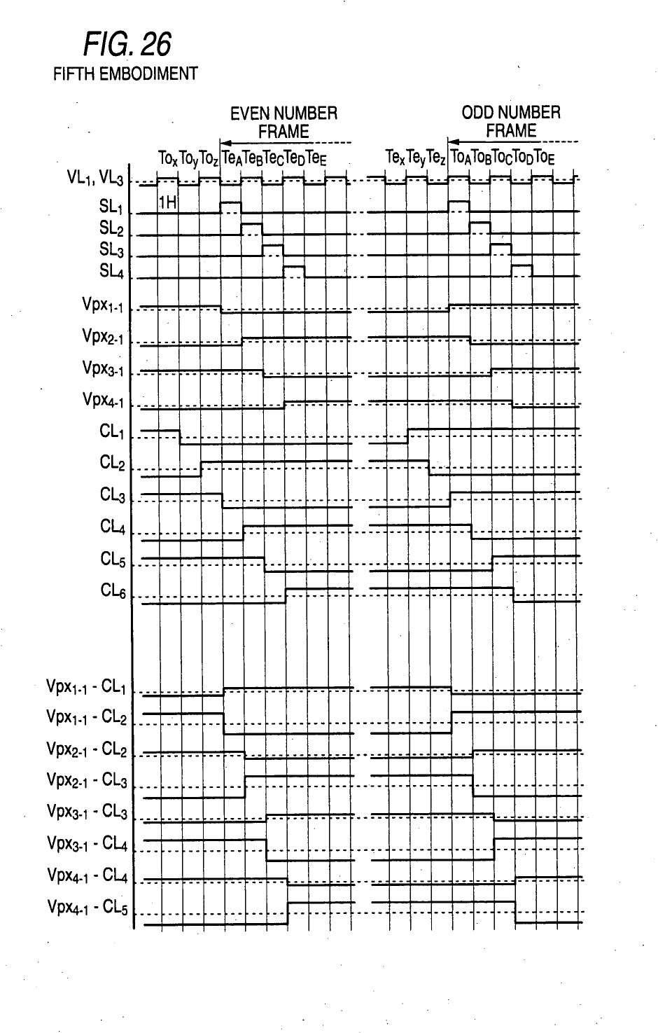

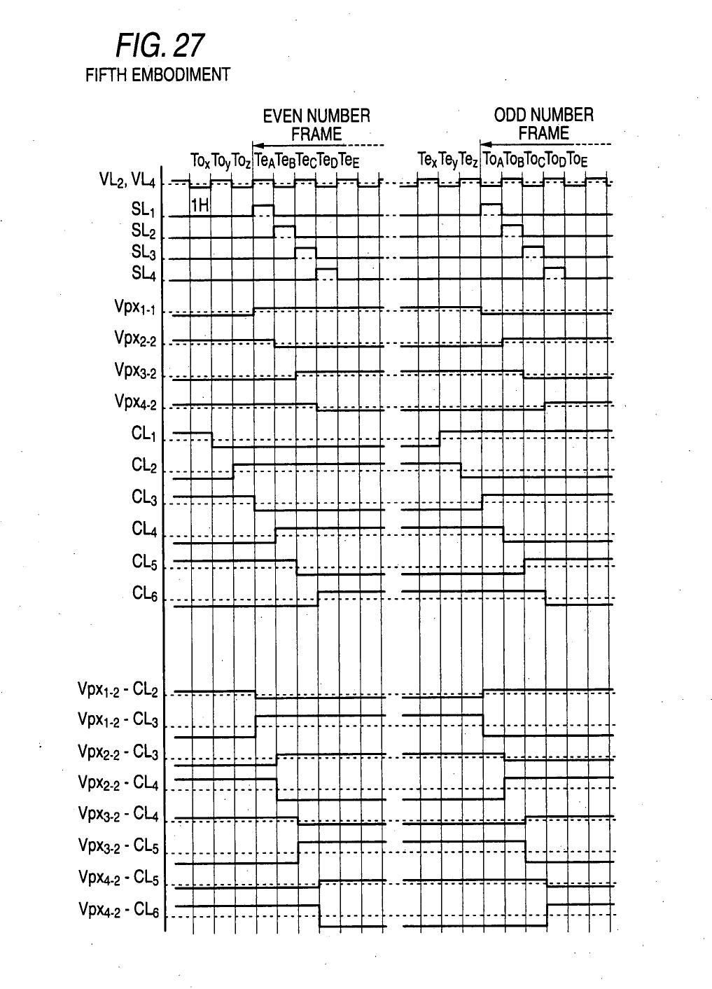

FIG. 25 is a schematic diagram of the liquid crystal display device 5 according to the fifth embodiment. FIGS. 26 and 27 are schematic timing charts of operations in a white display state of the liquid crystal display device 5 according to the fifth embodiment.

As shown in FIG. 25, the liquid crystal display device according to the fifth embodiment includes P (P=M+2; in the example shown in FIG. 25, P=6 because M=4) common electrode lines CL. Any one of the first counter electrode 21 and the second counter electrode 22 in each of the unit display areas UA corresponding to m′th (m′ is a natural number equal to or smaller than M) scanning signal line SLm′ and corresponding to an odd number video signal line VL and the other electrode of the first counter electrode 21 and the second counter electrode 22 in the unit display area UA corresponding to an even number video signal line VL are connected to a pth (p=m′+1) common electrode line CLp.

Any one of a (p−1)th common electrode line CLp−1 and a (p+1)th common electrode line CLp+1 and the electrode not connected to the pth common electrode line CLp of the first counter electrode 21 and the second counter electrode 22 in the unit display area UA corresponding to the odd number video signal line VL are connected.

Moreover, the other of the (p−1) th common electrode line CLp−1 and the (p+1)th common electrode line CLp+1 and the electrode not connected to the pth common electrode line CLp of the first counter electrode 21 and the second counter electrode 22 in the unit display area UA corresponding to the even number video signal line VL are connected.

The first voltage is applied to the first counter electrode 21 via the common electrode line CL connected to the first counter electrode 21. The second voltage is applied to the second counter electrode 22 via the common electrode line CL connected to the second counter electrode 22. Consequently, the common first voltage is applied to the first counter electrodes 21 in the unit display areas UA in the respective rows and the common second voltage is applied to the second counter electrodes 22 in the unit display areas UA.

In the liquid crystal device 5 according to the fifth embodiment, a first group including first and third unit display area columns UA1_1 to UA4_1 and UA1_3 to UA4_3 and a second group including second and fourth unit display area columns UA1_2 to UA4_2 and UA1_4 to UA4_4 shown in FIG. 25 can be explained as performing operations same as those explained in the third embodiment at different timings. Thus, detailed explanation of the operations is omitted. In the liquid crystal display device 5 according to the fifth embodiment, a video signal applied to an odd number video signal line VL and a video signal applied to an even number video signal line VL need to be inverted from each other. This is a difference from the third embodiment. FIG. 26 is a timing chart concerning the first group and FIG. 27 is a timing chart concerning the second group.

In FIG. 26, “Vpx1_1−CL1” corresponds to a potential difference between the first pixel electrode 20A and the first counter electrode 21 corresponding to the unit display area UA1_1. “Vpx1_−CL2” corresponds to a potential difference between the second pixel electrode 20B and the second counter electrode 22 corresponding to the unit display area UA1_1. The same holds true for “Vpx2_1−CL2” to “Vpx4_1−CL5”.

Specifically, as in the third embodiment, waveforms indicated by “Vpx1_1−CL1” to “Vpx4_1−CL5” represent waveforms of potential differences between pixel electrodes and counter electrodes in a reflection area RA1_1, a transmission area TA1_1, a reflection area RA2_1, a transmission area TA2_1, a reflection area RA3_1, a transmission area TA3_1, a reflection area RA 4_1, and a transmission area TA4_1 forming a first unit display area column shown in FIG. 25, respectively.

On the other hand, in FIG. 27, “Vpx1_{—}2−CL2” corresponds to a potential difference between the first pixel electrode 20A and the first counter electrode 21 corresponding to the unit display area UA1_2. “Vpx1_{—}2−CL3” corresponds to a potential difference between the second pixel electrode 20B and the second counter electrode 22 corresponding to the unit display area UA1_2. The same holds true for “Vpx2_{—}2−CL3” to “Vpx4_{—}2−CL6”.

Specifically, as in the third embodiment, waveforms indicated by “Vpx1_{—}2−CL2” to “Vpx4_{—}2−CL6” represent waveforms of potential differences between pixel electrodes and counter electrodes in a reflection area RA1_2, a transmission area TA1_2, a reflection area RA2_2, a transmission area TA2_2, a reflection area RA3_2, a transmission area TA3_2, a reflection area RA 4_2, and a transmission area TA4_2 forming a second unit display area column shown in FIG. 25, respectively.

Since operations shown in FIGS. 26 and 27 are basically the same as the operations explained in the third embodiment, explanation of the operations is omitted. In the fifth embodiment, as in the embodiments described above, formation of an even frame is finished by operations in the periods TeA to TeD shown in FIGS. 26 and 27.

At a point of the period TeE when the formation of an even number frame ends, as shown in FIG. 26, potential differences in the respective reflection areas and transmission areas are as follows:

a potential difference in the reflection area RA1_1: Vpx1_1−CL1=2 volts

a potential difference in the transmission area TA1_1: Vpx1_1−CL2=−8 volts

a potential difference in the reflection area RA2_1: Vpx2_1−CL2=−2 volts

a potential difference in the transmission area TA2_1: Vpx2_1−CL3=8 volts

a potential difference in the reflection area RA3_1: Vpx3_−CL3=2 volts

a potential difference in the transmission area TA3_1: Vpx3_−CL4=−8 volts

a potential difference in the reflection area RA4_1: Vpx4_−CL4=−2 volts

a potential difference in the transmission area TA4_1: Vpx4_1−CL5=8 volts

As shown in FIG. 27, potential differences in the respective reflection areas and transmission areas are as follows:

a potential difference in the reflection area RA1_2: Vpx1_{—}2−CL2=−2 volts

a potential difference in the transmission area TA1_2: Vpx1_{—}2−CL3=8 volts

a potential difference in the reflection area RA2_2: Vpx2_{—}2−CL3=2 volts

a potential difference in the transmission area TA2_2: Vpx2_{—}2−CL4=−8 volts

a potential difference in the reflection area RA3_2: Vpx3_{—}3−CL4=−2 volts

a potential difference in the transmission area TA3_2: Vpx3_{—}3−CL5=8 volts

a potential difference in the reflection area RA4_2: Vpx4_{—}4−CL5=2 volts

a potential difference in the transmission area TA4_2: Vpx4_{—}4−CL6=−8 volts

At the point when the formation of an even number frame ends, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed.

Formation of an odd number frame is finished by operations in the period ToA to ToD. At a point of the period TeE when the formation of an odd number frame ends, as shown in FIG. 26, potential differences in the respective reflection areas and transmission areas are as follows:

a potential difference in the reflection area RA1_1: Vpx1_−CL1=−2 volts

a potential difference in the transmission area TA1_1: Vpx1_−CL2=8 volts

a potential difference in the reflection area RA2_1: Vpx2_1−CL2=2 volts

a potential difference in the transmission area TA2_1: Vpx2_−CL3=−8 volts

a potential difference in the reflection area RA3_1: Vpx3_1−CL3=−2 volts

a potential difference in the transmission area TA3_1: Vpx3_−CL4=8 volts

a potential difference in the reflection area RA4_1: Vpx4_1−CL4=2 volts

a potential difference in the transmission area TA4_1: Vpx4_1−CL5=−8 volts

As shown in FIG. 27, potential differences in the respective reflection areas and transmission areas are as follows:

a potential difference in the reflection area RA1_2: Vpx1_{—}2−CL2=2 volts

a potential difference in the transmission area TA1_2: Vpx1_{—}2−CL3=−8 volts

a potential difference in the reflection area RA2_2: Vpx2_{—}2−CL3=−2 volts

a potential difference in the transmission area TA2_2: Vpx2_{—}2−CL4=8 volts

a potential difference in the reflection area RA3_2: Vpx3_{—}3−CL4=2 volts

a potential difference in the transmission area TA3_2: Vpx3_{—}3−CL5=−8 volts

a potential difference in the reflection area RA4_2: Vpx4_{—}4−CL5=−2 volts

a potential difference in the transmission area TA4_2: Vpx4_{—}4−CL6=8 volts

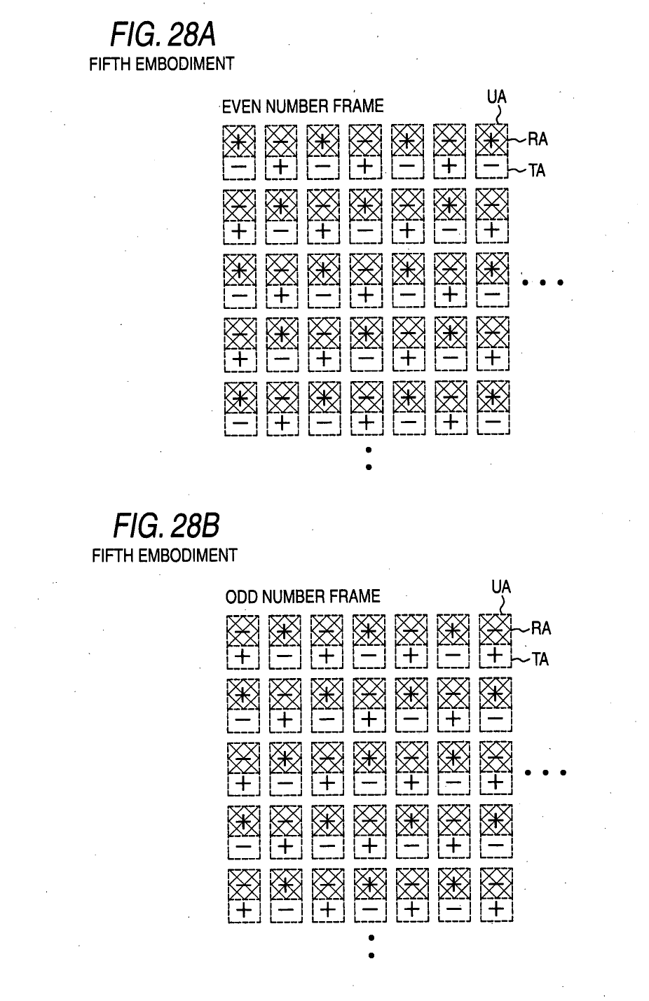

Polarities of the voltages are inverted from those in the even number frame. However, an absolute value of a potential difference between the first pixel electrode 20A and the first counter electrode 21 in each of the reflection areas RA is 2 volts and an absolute value of a potential difference between the second pixel electrode 20B and the second counter electrode 22 in each of the transmission areas TA is 8 volts. Therefore, a difference in operation modes in the transmission area TA and the reflection area RA is electrically compensated. An image in a white display state slightly darker than the maximum white display state in design is displayed. Polarities of voltages at pixel electrodes with respect to counter electrodes in the respective unit display areas UA in the even number frame are shown in FIG. 28A. Polarities of voltages at pixel electrodes with respect to counter electrodes in the respective unit display areas UA in the odd number frame are shown in FIG. 28B.

In the even number frame and the odd number frame, a relation between voltages applied to the first counter electrode 21 and the second counter electrode 22 is as explained in the first embodiment.

Specifically, in the even number frame and the odd number frame, a relation between voltages applied to the first counter electrode 21 and the second counter electrode 22 is as described below. For example, when scanning by the first to Mth scanning signal lines SL for forming an even number frame is completed, in a certain unit display area UA, the first voltage applied to the first counter electrode 21 is represented as V1_evenF and the second voltage applied to the second counter electrode 22 is represented as V2_evenF. When scanning by the first to Mth scanning signal lines SL for forming an odd number frame is completed, in the unit display area UA, the first voltage applied to the first counter electrode 21 is represented as V1_oddF and the second voltage applied to the second counter electrode 22 is represented as V2_oddF. A relation V1_evenF−V2_evenF=−(V1_oddF−V2_oddF) is satisfied. In the liquid crystal display device 5 according to the fifth embodiment, as in the embodiments described above, a direction of an electric field applied to the liquid crystal layer 30 changes for each of frames. It is possible to prevent liquid crystals from being deteriorated when an electric field is applied in one direction for a long time. In addition, in the liquid crystal display device according to the fifth embodiment, as shown in FIGS. 28A and 28B, polarities are inverted in a checkered shape. Consequently, flicker is reduced and a suitable display image can be formed.

The invention has been explained on the basis of the exemplary embodiments. However, the invention is not limited to these embodiments. The constitutions and the structures of the liquid crystal display devices explained in the embodiments are examples and can be appropriately changed. For example, in the third to fifth embodiment, the common electrode lines on one side can be typically set to a fixed voltage as in the first embodiment.

In the liquid crystal display devices according to the respective embodiments are explained as the liquid crystal display devices of the in-plane switching mode of the IPS system. However, the liquid crystal display devices may be liquid crystal display devices of other in-plane switching modes. For example, the Fringe Field Switching system described in a reference document S. H. Lee and H. Y. Kim, Appl. Phys. Lett, 73, 2881 (1998) and the like may be adopted.

The semi-transmission liquid crystal display device according to the embodiments of the invention can be applied to displays of electronic devices in all fields that have a flat panel shape and display video signals inputted to the electronic devices or generated in the electronic devices as images or videos. The electronic devices include a digital camera, a notebook personal computer, a cellular phone, and a video camera. Examples of the electronic devices to which the semi-transmission liquid crystal display device is applied are described below.

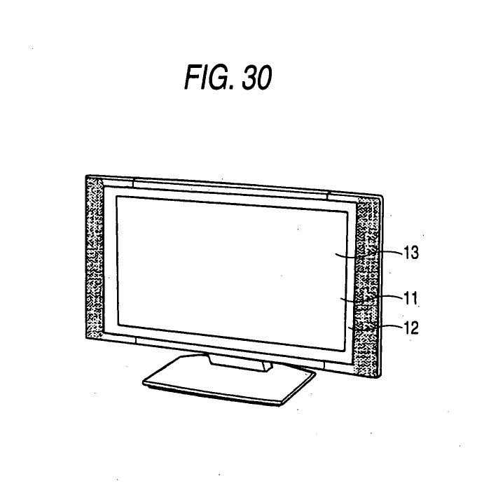

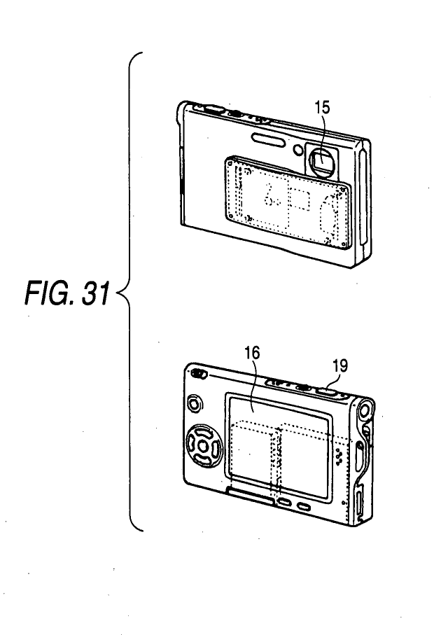

FIG. 30 is a perspective view showing a television set including a semi-transmission liquid crystal display device according to an embodiment of the invention. The television set includes a video display screen 11 including a front panel 12 and a filter glass 13. The semi-transmission liquid crystal display device is used in the video display screen 11.

FIG. 31 is a perspective view showing a digital still camera including the semi-transmission liquid crystal display device according to the embodiment. A front view thereof is shown in an upper part and a rear view thereof is shown in a lower part of the figure. The digital still camera includes a photographing lens, a light-emitting section 15 for flash, a display section 16, a control switch, a menu switch, and a shutter 19. The semi-transmission liquid crystal display device is used in the display section 16.

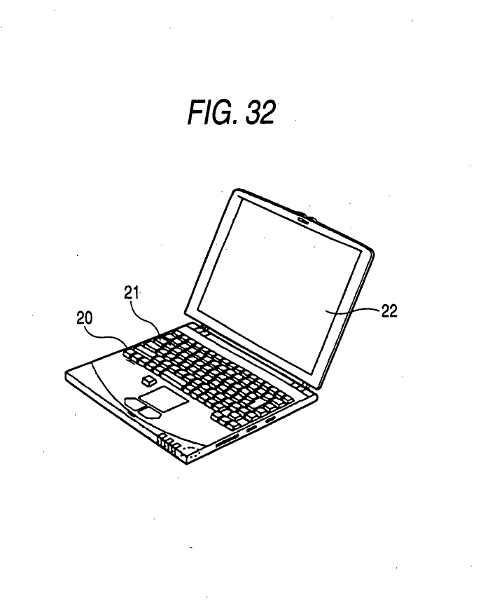

FIG. 32 is a perspective view showing a notebook personal computer including the semi-transmission liquid crystal display device according to the embodiment. A keyboard 21 that is operated to input characters and the like is included in a main body 20 of the notebook personal computer. A display section 22 that displays an image is included in a main body cover of the notebook personal computer. The semi-transmission liquid crystal display is used in the display unit 22.

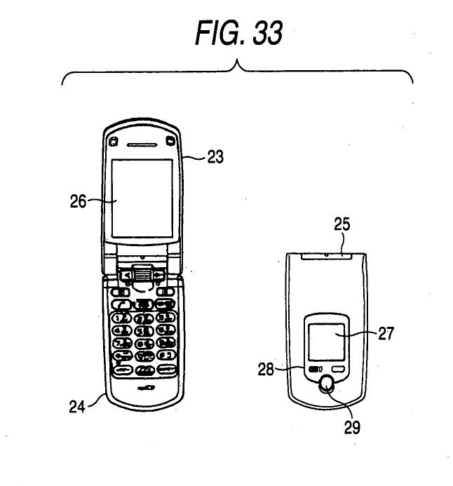

FIG. 33 is a schematic diagram showing a portable terminal apparatus including the semi-transmission liquid crystal display device according to the embodiment. An open state is shown on the left and a closed state is shown on the right. The portable terminal apparatus includes an upper housing 23, a lower housing 24, a coupling section (a hinge section) 25, a display 26, a sub-display 27, a picture light 28, and a camera 29. The semi-transmission liquid crystal display device is used in the display 26 and the sub-display 27.

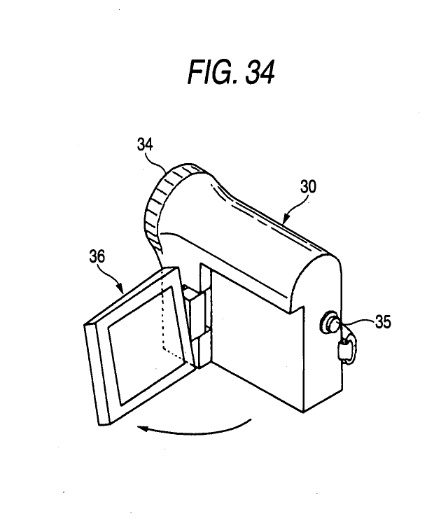

FIG. 34 is a perspective view showing a video camera including the semi-transmission liquid crystal display device according to the embodiment. The video camera includes a main body unit 30, a lens 34 for object photographing provided on a front side, a start/stop switch 35 operated during photographing, and a monitor 36. The semi-transmission liquid crystal display device is used in the monitor 36.

It should be understood by those skilled in the art that various modifications, combinations, sub-combinations, and alterations may occur depending on design requirements and other factors insofar as they are within the scope of the appended claims or the equivalents thereof.

What is claimed is:

1. A semi-transmission liquid crystal display device of an in-plane switching mode comprising:
M scanning signal lines that extend in a first direction and one ends of which are connected to a scanning signal driving circuit;
N video signal lines that extend in a second direction and one ends of which are connected to a video signal driving circuit;
switching elements that are arranged in crossing portions of the scanning signal lines and the video signal lines and operate according to scanning signals of the scanning signal lines; and
a unit display area that is provided in association with each of the switching elements and has a reflection display area and a transmission display area, wherein
the unit display area includes:
a first pixel electrode and a first counter electrode that form the reflection display area;
a first storage capacitor for storing a potential difference between the first pixel electrode and the first counter electrode;
a second pixel electrode and a second counter electrode that form the transmission display area; and
a second storage capacitor for storing a potential difference between the second pixel electrode and the second counter electrode,
a first voltage is applied to the first counter electrode,
a second voltage different from the first voltage is applied to the second counter electrode, and
when the first voltage is represented as V1, the second voltage is represented as V2, a higher one of the voltages V1 and V2 is represented as Hi(V1,V2), and a lower one of the voltages V1 and V2 is represented as Low(V1,V2), a third voltage equal to or lower than Hi(V1,V2) and equal to or higher than Low(V1,V2) is applied to the first pixel electrode and the second pixel electrode from the video signal driving circuit via the video signal lines on the basis of an operation of the switching elements corresponding to a scanning signal of the scanning signal lines.

2. A semi-transmission liquid crystal display device according to claim 1, wherein, when, in a certain unit display area, the first voltage applied to the first counter electrode is represented as V1_evenF and the second voltage applied to the second counter electrode is represented as V2_evenF when scanning by first to Mth scanning signal lines for forming even number frames is completed and, in the unit display area, the first voltage applied to the first counter electrode is represented as V1_oddF and the second voltage applied to the second counter electrode is represented as V2_oddF when scanning by first to Mth scanning signal lines for forming odd number frames is completed, V1_evenF−V2_evenF=−(V1_oddF−V2_oddF).

3. A semi-transmission liquid crystal display device according to claim 2, wherein any one of the following conditions is satisfied:
V1_evenF=V1_oddF;
V2_evenF=V2_oddF; and
V1_evenF=V2_oddF and V1_oddF=V2_evenF.

4. A semi-transmission liquid crystal display device according to claim 1, wherein, when scanning by first to Mth scanning signal lines for forming certain one frame is completed, in each of the unit display areas corresponding to an mth (m=1, 2, . . . , M) scanning signal line, a first voltage V1_m is applied to the first counter electrode and a second voltage V2_m is applied to the second counter electrode.

5. A semi-transmission liquid crystal display device according to claim 4, further comprising P (P=2M) common electrode lines, wherein
any one of the first counter electrode and the second counter electrode in each of the unit display areas corresponding to the mth scanning signal line and a pth (p=2m−1) common electrode line are connected and the other counter electrode and a (p+1)th common electrode line are connected,
the first voltage is applied to the first counter electrode via the common electrode line connected to the first counter electrode, and
the second voltage is applied to the second counter electrode via the common electrode line connected to the second counter electrode.

6. A semi-transmission liquid crystal display device according to claim 5, wherein
the voltage V2_m is a fixed value V2_const, and the voltage V1_m is a fixed value V1_odd when a value of m is an odd number and is a fixed value V1_even different from V1_odd when a value of m is an even number.

7. A semi-transmission liquid crystal display device according to claim 6, wherein V1_odd−V2_const=−(V1_even−V2_const).

8. A semi-transmission liquid crystal display device according to claim 5, wherein
the voltage V1_m is a fixed value V1_const, and
the voltage V2_m is a fixed value V2_odd when a value of m is an odd number and is a fixed value V2_even different from V2_odd when a value of m is an even number.

9. A semi-transmission liquid crystal display device according to claim 8, wherein V1_const−V2_odd=−(V1_const−V2_even).

10. A semi-transmission liquid crystal display device according to claim 5, wherein
the voltage V1_m is a fixed value V1_odd when a value of m is an odd number and is a fixed value V1_even different from V1-odd when a value of m is an even number, and
the voltage V2_m is a fixed value V2_odd when a value of m is an odd number and is a fixed value V2_even different from V2_odd when a value of m is an even number.

11. A semi-transmission liquid crystal display device according to claim 10, wherein V1_odd=V2_even and V1_even=V2_odd.

12. A semi-transmission liquid crystal display device according to claim 4, further comprising P (P=M+1) common electrode lines, wherein
any one of the first counter electrode and the second counter electrode in each of the unit display areas corresponding to an m′ th (m′=p−1) scanning signal line and the other of the first counter electrode and the second counter electrode in each of the unit display areas corresponding to an (m′+1)th scanning signal line are connected to a pth (p is a natural number equal to or larger than 2 and equal to or smaller than M−1) common electrode line,
the electrode not connected to a second common electrode line of the first counter electrode and the second counter electrode in each of the unit display areas corresponding to a first scanning signal line and a first common electrode line are connected,
the electrode not connected to a (P−1)th common electrode line of the first counter electrode and the second counter electrode in each of the unit display areas corresponding to an Mth scanning signal line and a Pth common electrode line are connected,
the first voltage is applied to the first counter electrode via the common electrode line connected to the first counter electrode, and
the second voltage is applied to the second counter electrode via the common electrode line connected to the second counter electrode.

13. A semi-transmission liquid crystal display device according to claim 12, wherein
the voltage V1_m is a fixed value V1_odd when a value of m is an odd number and is a fixed value V1_even different from V1_odd when a value of m is an even number,
the voltage V2_m is a fixed value V2_odd when a value of m is an odd number and is a fixed value V2_even different from V2_odd when a value of m is an even number.

14. A semi-transmission liquid crystal display device according to claim 13, wherein V1_odd=V2_even and V1_even=V2_odd.

15. A semi-transmission liquid crystal display device according to claim 4, further comprising P (P=M+1) common electrode lines, wherein
any one of the first counter electrode and the second counter electrode in each of the unit display areas corresponding to an m′th (m′=p−1) and an (m′+1)th scanning signal lines is connected to a pth (p is a natural number equal to or larger than 2 and equal to or smaller than M) common electrode line,
the electrode not connected to a second common electrode line of the first counter electrode and the second counter electrode in each of the unit display areas corresponding to a first scanning signal line and a first common electrode line are connected,
the electrode not connected to a (P−1)th common electrode line of the first counter electrode and the second counter electrode in each of the unit display areas corresponding to an Mth scanning signal line and a Pth common electrode line are connected,
the first voltage is applied to the first counter electrode via the common electrode line connected to the first counter electrode, and
the second voltage is applied to the second counter electrode via the common electrode line connected to the second counter electrode.

16. A semi-transmission liquid crystal display device according to claim 15, wherein
the voltage V2_m is a fixed value V2_const, and
the voltage V1_m is a fixed value V1_const different from V2_const.

17. A semi-transmission liquid crystal display device according to claim 1, further comprising P (P=M+2) common electrode lines, wherein
in each of the unit display areas corresponding to an m′th (m′ is a natural number equal to or smaller than M) scanning signal line,
one of the first counter electrode and the second counter electrode in a unit display area corresponding to an odd number video signal line and the other of the first counter electrode and the second counter electrode in a unit display area corresponding to an even number video signal line are connected to a pth (p=m′+1) common electrode line,
one of a (p−1)th common electrode line and a (p+1)th common electrode line and the electrode not connected to the pth common electrode line of the first counter electrode and the second counter electrode in the unit display area corresponding to the odd number video signal line are connected,
the other of the (p−1)th common electrode line and the (p+1)th common electrode line and the electrode not connected to the pth common electrode line of the first counter electrode and the second counter electrode in the unit display area corresponding to the even number video signal line are connected,
the first voltage is applied to the first counter electrode via the common electrode line connected to the first counter electrode, and
the second voltage is applied to the second counter electrode via the common electrode line connected to the second counter electrode.

18. An electronic apparatus comprising a semi-transmission liquid crystal display device according to claim 1.
